(19) United States
(12) Patent Application Publication
(10) Pub. No.: US 2026/0240156 A1
(43) Pub. Date: Aug. 20, 2026

(54) OIL-BASED DISPERSION COMPOSITIONS OF SOLID PARTICULATE HYGROSCOPIC OR WATER-SOLUBLE PESTICIDES

(71) Applicant: ADAMA MAKHTESHIM LTD., Beer Sheva (IL)

(72) Inventor: Yogev DAHAN, Tene Omarim (IL)

(73) Assignee: ADAMA MAKHTESHIM LTD., Beer Sheva (IL)

(21) Appl. No.: 19/164,953

(22) PCT Filed: Mar. 14, 2024
(86) PCT No.: PCT/IB2024/052508

§ 371 Date: Sep. 12, 2025

Related U.S. Application Data
(60) Provisional application No. 63/452,142, filed on Mar. 14, 2023.

(51) Int. Cl. A01N 43/707; A01N 25/04; A01N 25/30; A01N 43/40; A01P 7/04

(52) U.S. Cl. CPC A01N 43/707; A01N 25/04; A01N 25/30; A01N 43/40; A01P 7/04

(57) ABSTRACT

The present invention relates to non-aqueous suspension compositions such as oil-based dispersion compositions of solid water-soluble and/or hygroscopic or solvent-absorbing pesticidal compounds in solid particulate form, most notably Oil-Based Pymetrozine Dispersion Compositions. The present invention especially relates to methods for optimizing the characteristics, ease of manufacture, and physical stability of Oil-Based Pymetrozine Dispersion concentrated compositions which maintain their dispersibility in water over periods of storage. The present invention provides guidance as to the individual improvements achievable by using specific disclosed classes of non-pesticidally active, formulation aids and the collective enhanced optimization achievable by inclusion of combinations the classes of formulation aids disclosed. The present invention also relates to optimizing the processes for the preparation of Oil-Based Pymetrozine Dispersion Compositions comprising the steps of adding, stirring, milling, collecting, homogenizing and typically, packaging.

This application claims the benefit of U.S. Provisional Application No. 63/452,142, filed Mar. 14, 2023, the contents of which are hereby incorporated by reference.

### FIELD OF INVENTION

The present invention relates to non-aqueous suspension compositions typified by oil-based dispersion compositions of solid water-soluble and/or hygroscopic or solvent-absorbing pesticidal compounds in solid particulate form, most notably, Oil-Based Pymetrozine Dispersion (OBPD), Compositions. In particular the present invention relates to Oil-Based Pymetrozine Dispersion Compositions with improved characteristics, ease of manufacture and stability, that can be easily dispersed in water for end-use application for example as a tank or spray mix, even after storage.

### BACKGROUND OF INVENTION

Pymetrozine (CGA 215944) is an insecticide, active and specific against sucking insect pests. Pymetrozine is a representative of the pyridine azomethines, a relatively new class of insecticides. Based on various reports, the mode of action of Pymetrozine in insects may involve effects on neuroregulation or nerve-muscle interaction. Physiologically, it appears to act by preventing these insects from inserting their stylus into the plant tissue.

The chemical name of Pymetrozine is 6-methyl-4-[(E)-(pyridin-3ylmethylene)amino]-4,5-dihydro-2H-[1,2,4]-triazin-3-one. Pymetrozine is a water soluble and hygroscopic compound that is reported to also absorb certain solvents. Pymetrozine has a chemical formula of C₁₀H₁₁N₅O and a molecular mass of 217.23 g/mol. It has the structural formula (A):

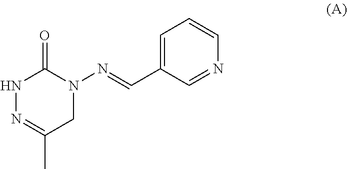 [SMILES: CC1=NNC(=O)N(/N=C/c2cccnc2)C1]

In many embodiments of the invention, Oil-Based Pymetrozine Dispersion compositions are non-aqueous suspension concentrates, such as oil-based dispersion concentrates (OD). The characteristic features of the inventive concentrated composition embodiments typically include the inclusion of specific inventive ingredients or components as herein detailed, and often, a restriction in the amount of specifically identified solvents or absence of the specifically identified solvents as components of the composition. The Oil-Based Pymetrozine Dispersion concentrate compositions being typically substantially, or almost totally, non-aqueous formulations or compositions wherein substantially, or almost totally, non-aqueous refers to a percentage content between greater than 0% and less than or equal to 5% w/w, water other than any water associated with pre-hydrated Pymetrozine, if present. The Oil-Based Pymetrozine Dispersion concentrate compositions of the invention usually being characterized as having highly efficient dispersibility during compounding, high physical and chemical stability as herein defined. The compositions are characterized by improved dispersibility in aqueous media such as water.

When preparing diluted end-use compositions for application from the oily dispersion concentrate composition, the concentrated inventive composition embodiments are characterized by their forming homogenous suspensions in water promptly, without lumps, and maintaining the above dispersibility characteristics even after periods of storage of the oily dispersions over time at temperatures exceeding 25° C. or “Room Temperature”. As alluded to above, the compositions may comprise pre-hydrated pymetrozine although, a noted advantage of the inventive compositions is that they enable oil-based pymetrozine dispersion (concentrated), compositions to be advantageously manufactured so that they comprise non-hydrated pymetrozine particles especially when predominantly vegetable-based oil-based carriers are used as the liquid carrier.

In several embodiments substantially, or almost totally, non-aqueous is understood to be a water content greater than zero, though not more than 5% by weight of the complete dispersion concentrate, other than any water associated with pre-hydrated Pymetrozine if present. The water content being referred to is generally (though not exclusively), the water that may accompany commercially available grades or brands of the specific inventive ingredients or components as referred to above.

Agglomeration solidification, and particle size growth are several of the quality challenges to be overcome for both the stability and the efficacy of pesticide suspensions, and particularly, suspension concentrates (including oil-based dispersions concentrates), during the production and over periods of storage. Stability of the dispersibility of the compositions after storage, is an on-going challenge.

The above-mentioned challenges are compounded when the pesticide suspension concentrate/oil-dispersion, includes a hygroscopic pesticidally active ingredient or component. An additional challenge to formulating or preparing acceptable oil-based dispersion of hygroscopic water-soluble pesticides is that an apparently acceptable prior art oil dispersion concentrate which disperses readily in water at the time of compounding was often in the past, found to not be as able to disperse as readily in water after it had been stored for a period of time especially if stored at temperatures above exceeding 25° C. or “Room Temperature”. Coalescence, flocculation, and aggregation would previously tend to appear in the preparation of non-aqueous Pymetrozine suspension concentrate (Oil Dispersion Concentrates), reducing its stability and efficacy. Moreover, these phenomena are even more pronounced after periods of storage and notably when the dispersion concentrate had been stored for more than a week above 25° C. (room temperature), such as storage at 54° C. for two weeks or more and/or storage for at least one month at 40° C./75% RH.

Prior art references relate to different compositions of Pymetrozine. None of the prior art references disclose composition containing Pymetrozine with specific combination of excipients used in the present invention coupled with the avoidance of specific deleterious classes of components including specific solvents, while carefully controlling water content, to achieve the desired characteristics.

It has been previously reported that it can be difficult to prepare suspension concentrate formulations that are storage stable, e.g., with respect to thickening, unacceptably increased viscosity, and particle agglomeration, especially for active ingredients having high water solubility such as Pymetrozine.

There are several on-going challenges facing a formulator wishing to compound hygroscopic water-soluble pesticides as liquid compositions. Pymetrozine liquid compositions especially suspension compositions and particularly Oil-based Dispersion Pymetrozine compositions are particularly challenging to prepare, and this is especially the case when those Oil-based Dispersion Pymetrozine compositions are required to be characterized by acceptable physical and stability attributes exemplified by the standards generally accepted in the field of agrochemical pesticidal preparations.

Pymetrozine can absorb large amounts of liquids notably water and solvents. Often researchers have used a so-called “Pre-Hydration” step to ensure no further change in the Pymetrozine during compounding, however the large amounts of water usually employed results in very little “room” left for the Oil and further active and non-active ingredients which should be the basis of the Oil-Based suspension and a very high load having less than favorable characteristics. Additionally, phenomenon such as solidification often previously occurs during compounding and storage especially at elevated temperatures. The previous reports of attempts to formulate Oil-Based Pymetrozine dispersion concentrates displayed issues of unacceptable appearance and paste formation. Further, when previous Oil-Based Pymetrozine dispersion concentrates were diluted with water to prepare the final end-use, Tank-mix or ready spray products, these older, previous concentrates were found to be difficult if not impossible to disperse in the water, and this challenge was intensified after these prior art Oil-Based Pymetrozine dispersion concentrates had been stored for a period before dilution. Often previous Pymetrozine dispersion products displayed a disagreeable yellowing of color. Unacceptably high viscosities during manufacture and storage were also reported.

As seen in the “Manual on the development and use of FAO and WHO specifications for chemical pesticides”, found at https://www.fao.org/3/cb8401en/cb8401en.pdf “OD, like SC formulations, do not disperse as spontaneously as EC formulations upon dilution in water. Therefore, the spray solution has to be stirred in order to obtain a homogeneous dispersion before application. The parameters which best describe the performance characteristics are: —Pourability (to ensure that the OD can be poured from its container); —Dispersion stability, wet sieve, and persistent foam tests (to ensure the sprayability and stability of the diluted suspension); —Storage at elevated temperature (to ensure the absence of crystal growth upon storage)”.

Inventors herein disclose inventive compositions and methods for preparing Oil-Based Pymetrozine dispersion concentrates that overcome the aforementioned compounding challenges and have achieved compositions that are stable and both easy to disperse and having desirable product qualities and appearance. The inventive Oil-Based Pymetrozine dispersion concentrates embodiments are capable of high load concentrations of Pymetrozine while maintaining stability, both in terms of dispersibility and product quality stability.

The inventors of the present invention provide inventive insecticidal oil-based dispersion compositions comprising Pymetrozine, and auxiliary components selected from, dispersing agents, rheology modifiers, emulsifiers and oil-based adjuvants and combinations thereof. The present invention also provides Pymetrozine oil-based dispersions produced using inventive processes and components of the present invention having advantageous physical characteristics, improved dispersibility in water for end-use applications, and improved chemical and physical stability. The invention provides and facilitates industrially and economically feasible process for compounding Pymetrozine oily dispersions.

### OBJECTIVE OF INVENTION

An objective of the present invention is to provide Oil-Based liquid dispersion compositions of solid particulate hygroscopic and/or water-soluble pesticides, in particular, Oil-Based Pymetrozine Dispersion (OBPD), liquid compositions, having any and/or all of, less complicated compounding, lower viscosity, both during preparation, and that lower viscosity is maintained during storage, greater ease in preparing diluted end-use suspensions in water as well as improved physical characteristics including reduced discoloration, e.g., yellowing, as compared to oil dispersions of Pymetrozine previously encountered. In many embodiments the compositions are OD concentrates adapted for eventual dilution and dispersion in water for end-use application.

Another objective of the present invention is to provide compositions of insecticidal oil-based dispersion comprising Pymetrozine wherein the Pymetrozine active ingredient (tech), does not require pre-treatment, such as, pre-hydration, prior to commencing compounding.

An additional aspect of the present invention is to provide composition of insecticidal oil-based dispersion comprising Pymetrozine, one or more dispersing agents, one or more emulsifiers, one or more rheology modifiers and one or more oil adjuvants with advantageously minimized content or the absence of, significant amounts of specific solvents selected from solvents which are exemplified by any of methanol, ethanol, propanol, isopropanol, butanol, isobutanol, t-butanol, cyclohexanol, tetrahydrofurfuryl alcohol, ethylene glycol, glycerol, methyl acetate, ethyl acetate, ethyl lactate, butyrolactone, gamma butyrolactone, ethylene carbonate, propylene carbonate, acetonitrile, dimethyl sulphoxide, dimethylformamide, dimethylacetamide, N-methyl-2-pyrrolidone, N-octyl-2-pyrrolidone, N-decyl-2-pyrrolidone, acetone, butanone, methyl isobutyl ketone, methylpropyl ketone, acetophenone, cyclohexanone, methylene chloride, trichloromethane, trichloroethane, tetrahydrofuran, diethylether, 1,2-dimethoxyethane, dioxane, methyl-tert.-butylether, ethanolamine, pyridine, chlorobenzene, toluene, xylene or tetramethyl urea.

The term minimized content or significant amounts of, the aforementioned solvents, typically herein refers to, a content of less than 5% w/w of the composition, however, inventors also provide directions for the addition of specified additives that can ameliorate the unwanted effects of higher percentages of solvents content as later herein described.

By choosing vegetable oil-based carriers such as methyl soyate rather than paraffin or mineral oil, as carriers, inventors were able to prepare Oil-Based Pymetrozine Dispersion compositions without needing to pre-hydrate the pymetrozine active ingredient before preparing the compositions.

Without being bound to any theory, inventors have deduced the chemical structures that are believed to be responsible for some of the unwanted characteristics of Pymetrozine compositions that contain certain solvents, and thus in several embodiments, the inventive Oil Dispersion concentrate compositions, (and/or diluted dispersions thereof), are sometimes usefully characterised by minimized content or the lack of, the following structures labelled (B),

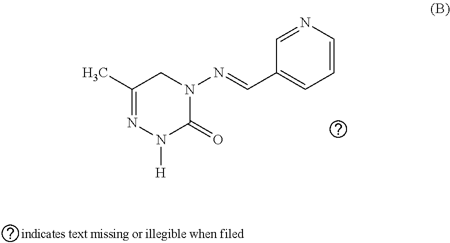

wherein,
r and s are each independently, between 0 and 12 though typically, between greater than 0 and 12, and
L is one or more of methanol, ethanol, propanol, isopropanol, butanol, isobutanol, t-butanol, cyclohexanol, 2-Ethyl Hexanol, alkylbenzene, tetrahydrofurfuryl alcohol, ethylene glycol, glycerol, methyl acetate, ethyl acetate, ethyl lactate, butyrolactone, ethylene carbonate, propylene carbonate, acetonitrile, dimethyl sulphoxide, dimethylformamide, dimethylacetamide, N-methyl-2-pyrrolidone, N-octyl-2-pyrrolidone, N-decyl-2-pyrrolidone, acetone, butanone, methyl isobutyl ketone, methylpropyl ketone, acetophenone, cyclohexanone, methylene chloride, trichloromethane, trichloroethane, tetrahydrofuran, diethylether, 1,2-dimethoxyethane, dioxane, methyl-tert.-butylether, ethanolamine, pyridine, chlorobenzene, toluene, xylene or tetramethyl urea.

Generally, herein the term “minimized content” of the above disclosed structures is understood to be an amount such that L comprises equal or less than 5% w/w of the composition.

However, inventors stress that, the ability to detect or quantify the percentage content, presence, or absence of any of these disclosed structures is not to be used alone, as being the sole defining factor or even indicative as to whether a particular Oil Based Pymetrozine dispersion composition is within or outside the scope of the invention, as it is the inclusion or absence of the inventive non-pesticidally active formulation aids in the composition as elsewhere herein defined that will determine, although, it may be useful as a guide.

Thus, some embodiments of the invention can be characterised as a non-aqueous pesticidal suspension concentrate composition comprising, a compound of structural formula (A) in solid particulate form

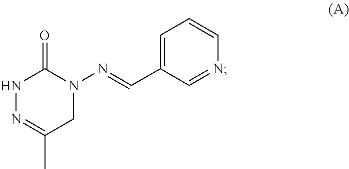 [SMILES: CC1=NNC(=O)N(/N=C/c2cccnc2)C1]

a compound of structural formula (B)

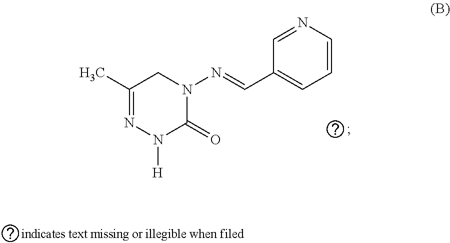 [SMILES: CC1=NNC(=O)N(/N=C/c2cccnc2)C1]

an aqueous solution of alkylpolysaccharide surfactant comprising, alkyl polyglycoside, alkyl polyglucoside or mixtures thereof; alkoxylated adjuvant; anionic surfactant selected from, phosphate or phosphonate-based surfactant, sulphate or sulphonate-based surfactant, and a combination of phosphate or phosphonate-based surfactant and sulphate or sulphonate-based surfactants; triethylamine; methyl soyate, and optionally additional pesticidally active compound, such as flonicamid, wherein, r and s are each independently, between greater than 0 and 12, and L is one or more of methanol, ethanol, propanol, isopropanol, butanol, isobutanol, t-butanol, cyclohexanol, 2-Ethyl Hexanol, alkylbenzene, tetrahydrofurfuryl alcohol, ethylene glycol, glycerol, methyl acetate, ethyl acetate, ethyl lactate, butyrolactone, ethylene carbonate, propylene carbonate, acetonitrile, dimethyl sulphoxide, dimethylformamide, dimethylacetamide, N-methyl-2-pyrrolidone, N-octyl-2-pyrrolidone, N-decyl-2-pyrrolidone, acetone, butanone, methyl isobutyl ketone, methylpropyl ketone, acetophenone, cyclohexanone, methylene chloride, trichloromethane, trichloroethane, tetrahydrofuran, diethylether, 1,2-dimethoxyethane, dioxane, methyl-tert-butyl ether, ethanolamine, pyridine, chlorobenzene, toluene, xylene or tetramethyl urea, and the content of L comprises equal or less than 5% w/w of the composition and wherein the amount of water comprising the aqueous solution of alkylpolysaccharide surfactant is between greater than 0% w/w, and equal or less than 5% w/w based on the weight of the non-aqueous pesticidal suspension concentrate composition.

In some noted embodiments, advantages are realized by inclusion in the compositions of non-insecticidal formulation aids which are alkoxylated adjuvants such as alkoxylated/ethoxylated carboxylic acid esters, ethoxylated carboxylic acids, ethoxylated primary or secondary linear or branched alcohols, alkoxylated fatty alcohols, ethoxylated fatty alcohols, coconut fatty alcohol ethoxylates, C_{12/C14} fatty alcohol ethoxylates, cetyl/oleyl alcohol ethoxylates, C_{16/C18} fatty alcohol ethoxylates, C_{12/C18} fatty alcohol ethoxylates, C_{8/C1} fatty alcohol ethoxylates, C_{13/C15} fatty alcohol ethoxylates, C_{11/C15} fatty alcohol ethoxylates, tributyl phenol ethoxylates, ethoxylated (linear or branched), alkyl aryls such as ethoxylated alkyl phenols, nonylphenol ethoxylates and ethoxylated acetylenic diols, alkoxylated fatty alcohols/ethoxylated fatty alcohols, such as CAS No. 69011-36-5 (e.g. Imbentin® U/050), ethoxylated isotridecyl alcohol, (CAS. 9043-30-5), a co-polymer PEG poly-iso-butenyl anhydride-tall oil fatty acid CAS. 173717-47-0 (e.g., Atlox® 4914). Noted are also ABA block copolymers having a hydrophilic portion of polyethylene oxide (PEG) and a hydrophobic portion of 12-hydroxystearic acid. A noted example is the commercial surfactant Atlox™ 4912 (trademark of Uniqema), having an average molecular weight of about 5,000. Another example of such a polymeric surfactant is the commercial surfactant Termul™ 2510 (trademark of Huntsman)

In some embodiments, advantages are realized by inclusion of non-insecticidal (pesticidal), formulation aids which are anionic surfactants, such as phosphate esters (mixtures of mono, and di-ester, free alcohol and phosphoric acid), alkyl phosphonic acids, phosphate esters of fatty alcohols, phosphate esters of ethoxylated fatty alcohols alkoxylated/ethoxylated phosphate esters, alkyl phosphonic acids, anionic phosphate esters/ethoxylated phosphate esters. Such formulation aids useful in the invention can be exemplified by Hostaphat® 1306 a phosphate ester based on iso-tridecanol ethoxylate alkyl, and olefin sulfonates comprising hydrophobic alkyl chain and an anionic sulfonic acid group, sulfate esters from sulfonation of fatty alcohols and alcohol ethoxylates.

It should be noted that while various solvents as mentioned above, can often be deleterious in binary combinations with Pymetrozine, by incorporating the disclosed Oily carriers together with the herein disclosed compounding aids (formulation aids or excipients), the optimized Oil-Based Pymetrozine Dispersions of the invention are able to withstand amounts of these same solvents that would ordinarily cause compounding problems if combined with Pymetrozine in the absence of the excipients. Thus, surprisingly it was found that although excipients such as the NINATE™ series of alkyl (C₁₀₋₁₆) Benzenesulfonic acid, Calcium Salt, can contain up to about 40% of solvents including, Isobutyl Alcohol, 2-Ethyl Hexanol, 1-hexanol, or 1-butanol, the previously encountered negative effects on the character of the concentrate are no longer apparent in the Oil-Based Pymetrozine Dispersion compositions of the invention, due to the incorporation of the inventive ingredients.

In some concentrated composition embodiments of the inventive Pymetrozine Oil-Based dispersion compositions, inclusion of compounds exemplified by triethylamine (TEA) combined with alkyl polyglucosides/alkyl polyglycosides, such as, Glucopon® 650 EC, Multitrope® 1620, ATLOX™AL2575/A12579, Agnique® PG 8107/Agnique® PG 8105, Tensoper APG 810 etc., improved, both the quality and dispersibility of the concentrate in water when preparing dilute end-use liquids. Inventors have additionally found that surprisingly, including compounds exemplified by triethylamine (TEA) achieves, improvements in the color stability of the inventive Pymetrozine Oil-Based dispersion concentrate composition embodiments during periods of storage, displaying reduced yellowing compared to compositions absent the TEA.

Alkyl polyglucosides and alkyl polyglycosides are sometimes also referred to as alkyl polysaccharides, terms which have been used interchangeably.

The inclusion of triethylamine, even in the absence of the alkyl polyglucosides etc., was found advantageous as regards dispersibility of the concentrate, however, as disclosed, some further advantages were realized by the inclusion of the alkyl polyglucosides in the concentrate compositions, together with TEA in the composition.

It was found that inclusion of Alkyl polyglycosides/Alkyl Polyglucosides (APG)/alkyl polysaccharides had further surprising effect. Generally, inclusion of even small amounts of water in Oil-based Pymetrozine Dispersion concentrated compositions can have unwanted effects sometimes even causing “solidification” of the dispersion. Compositions including APG were found to be forgiving as regard to small amounts of water. As a non-limiting demonstration, it was found that grades of APG that were used as ~50% aqueous solutions when introduced during compounding, actually greatly improved the compositions despite the presence of the included water.

Inventors have encountered the increased and/or synergistic, formulation quality and/or stability advantages of combining the different non-insecticidal formulation aids, over and above the advantages realized by inclusion of only one, two or three of the identified and disclosed useful non-insecticidal formulation aids in the absence of the others.

In some inventive embodiments, optimized Oil-Based Pymetrozine dispersion compositions included, in addition to between greater than 0% w/w and equal or less than 40% w/w insecticidal compounds comprising pymetrozine and optionally additional pesticides, all of the following non-insecticidal ingredients,
a) alkyl polyglycosides and/or alkyl polyglucosides and/or alkyl polysaccharides (that encompasses both),
b) anionic surfactants, such as phosphonate, phosphate esters, sulfonates, sulfate esters (branched, or linear) etc.
c) alkoxylated adjuvant(s) such as alkoxylated/ethoxylated carboxylic acid esters, ethoxylated carboxylic acids, ethoxylated primary or secondary linear or branched alcohols, alkoxylated fatty alcohols, ethoxylated fatty alcohols etc.
d) triethylamine (end-use dispersibility stabilizer/compatibilizer), and
e) vegetable oil, or alkylated vegetable oil, such as methyl soyate palm methyl ester oil, methyl oleate, methyl linoleate, methyl linolenate, methyl stearate, methyl palmitate etc.

In some inventive embodiments, optimized Oil-Based Pymetrozine dispersion compositions included in addition to between greater than 0% w/w and equal or less than 40% w/w of Insecticidal compounds, all of the following non-Insecticidal ingredients,
a) alkyl polyglycosides and/or alkyl polyglucosides and/or alkyl polysaccharides,
b) anionic surfactants, such as phosphonate, phosphate esters sulfonates sulfate esters etc.
c) alkoxylated adjuvant such as alkoxylated/ethoxylated carboxylic acid esters, ethoxylated carboxylic acids, ethoxylated primary or secondary linear or branched alcohols, alkoxylated fatty alcohols, ethoxylated fatty alcohols etc.,
d) vegetable oil, or derivative thereof exemplified by alkylated vegetable oil, such as methyl soyate palm methyl ester oil, methyl oleate, methyl linoleate, methyl linolenate, methyl stearate, methyl palmitate etc. and,
e) end-use dispersibility stabilizer/compatibilizer such as, tertiary amine, alkyl amine such as, triethylamine, triethanolamine, N,N-di-isopropyl ethylamine, butylamine, etc.

In several embodiments, the “non-aqueous” Pymetrozine Oil-Based Dispersions of the invention advantageously contain up to about 5% water so long as that water is accompanied by alkyl polysaccharide (APG), as an ingredient of the composition. The water is often typically introduced into the inventive compositions as carrier for one or more of the non-insecticidally active components of the Oil-Based Pymetrozine dispersions, particularly the alkyl polysaccharide such as APG obtained as an aqueous solution, surprisingly this water carrier is not disadvantageous compared to when the same amount of water is introduced into the composition in the absence of e.g., the APG.

In identified embodiments, the concentrated Oily Dispersions of the invention before dilution, contain amounts of specified solvents selected from the group of, less than 4%; less than 3%; less than 2%; less than 1%; less than 0.9%; less than 0.8%; less than 0.7%; less than 0.6%; less than 0.5%; less than 0.4%; less than 0.3%; less than 0.2%; less than 0.1%; less than 0.05% by weight; or entirely devoid of, solvents selected from the group of, methanol, ethanol, propanol, isopropanol, butanol, isobutanol, t-butanol, cyclohexanol, 2-Ethyl Hexanol, alkylbenzene, tetrahydrofurfuryl alcohol, ethylene glycol, glycerol, methyl acetate, ethyl acetate, ethyl lactate, butyrolactone, gamma butyrolactone, ethylene carbonate, propylene carbonate, acetonitrile, dimethyl sulfoxide, dimethylformamide, dimethylacetamide, N-methyl-2-pyrrolidone, N-octyl-2-pyrrolidone, N-decyl-2-pyrrolidone, acetone, butanone, methyl isobutyl ketone, methylpropyl ketone, acetophenone, cyclohexanone, methylene chloride, trichloromethane, trichloroethane, tetrahydrofuran, diethyl ether, 1,2-dimethoxyethane, dioxane, methyl-tert.-butylether, ethanolamine, pyridine, chlorobenzene, toluene, xylene or tetramethyl urea.

However, despite the above, inventors envisage that careful selection of the combination of non-insecticidal formulation aids based in these disclosed guidelines and principles, may compensate for an even greater percentage w/w content of the above solvents, and fully expect that such compositions will be possible without noticeable disadvantages so long as these directions are followed.

Inventors thus advise that, when choosing the non-insecticidal ingredients for the inventive Pymetrozine Oily Dispersion composition, care must be taken to examine and assess not only the chemical identity of the ingredient but also the solvent in which it is supplied. This is because, in some cases a particular ingredient found to be beneficial to the compositions when it is supplied as pure compound might behave sub-optimally when used (included, incorporated), as a mixture or solution in one of the generally unfavorable solvents as identified in this disclosure. Alternatively, that while one solvent carrier for the chosen excipient renders the excipient less useful, that same excipient introduced in another solvent will display superior advantages. Inventors thus note that if a particularly identified advantageous excipient is included in a composition with resultant disappointing levels of added advantages, it may not be necessary to discard that non-insecticidal formulation aid as an option, but rather to choose a different commercially available grade or version that is provided in a different solvent or even as a compound devoid of carrier solvent.

As an illustrative example inventors note three different grades of alkyl (C₁₀-₁₆) benzenesulfonic acid, calcium salt (Alkyl Benzene Sulfonates) which is a favored non-pesticidal formulation aid, namely NINATE™ 60B-E; NINATE™ 60L and NINATE 60 EPG all supplied by the Stepan Company, 22 West Frontage Road, Northfield, IL 6009. Although all these commercial products contains alkyl (C₁₀-₁₆) benzenesulfonic acid, calcium salt, they differ in the solvents in which they are supplied:

| | | |
|---|---|---|
| NINATE ™ 60B-E | NINATE ™ 60L | NINATE ™ 60 EPG |

Alkyl (C₁₀-₁₆) Benzenesulfonic Acid, Calcium Salt

| | | |
|---|---|---|
| Alkyl Benzene | Alkyl Benzene | Alkyl Benzene |
| Sulfonates | Sulfonates | Sulfonates |
| 60-<70% | 60-70% | 50-<60% |
| Isobutyl Alcohol | Solvent Naphtha | 2-Ethyl Hexanol |
| 30-<40% | 20-30% petroleum, | 30-<40% |
| | Heavy Aromatic | |
| | 1-hexanol | 1-butanol |
| | 7-10% | 1-<3% |
| | Alkylbenzene (C₁₀-₁₆) | Triethanolamine |
| | 1-<3% | 1-<3% |
| | Naphthalene | Other components below |
| | 1-<38 | reportable levels |

Clearly, based on the findings herein disclosed, that certain solvents are less advantageous to the quality, stability, and/or ease of preparation of Pymetrozine Oil-Based dispersions than others, the choice as to which grade of Alkyl Benzene Sulfonates (if selected as anionic surfactant), is included, may well influence the degree by which the quality and both physical and dispersibility stability of the concentrated Oil-Based Pymetrozine dispersion composition is improved, even though all three are Alkyl Benzene Sulfonates.

As mentioned, anionic surfactants such as phosphonate, phosphate esters, sulfonates, sulfate esters etc. (branched or linear), are one of the types of inventive non-Insecticidal formulation aids usefully included in the inventive concentrated Oil-Based Pymetrozine Dispersion (OBPD), compositions of the invention. Typical examples of generally useful anionic surfactants include sulfonate, alkyl benzenesulfonates, alkanesulfonates, olefin sulfonates, alkyl-ether sulfonates, glycerol ether sulfonates, α-methyl ester sulfonates, sulfo-fatty acids, alkyl sulfates, fatty alcohol ether sulfates, glycerol ether sulfates, fatty acid ether sulfates, hydroxy mixed ether sulfates, monoglyceride (ether) sulfates, fatty acid amide (ether) sulfates, mono- and dialkyl sulfosuccinates, mono- and dialkyl sulfo-succinamates, sulfo-triglycerides, amide soaps, ether carboxylic acids and salts thereof, fatty acid isethionates, fatty acid sarcosinates, fatty acid taurides, alkyl oligo-glucoside sulfates. Alkyl ether sulfates are quite available.

In some embodiments, branched alkyl benzene sulfonates are found to be preferred over linear varieties of these anionic surfactant compound and advantageously are combined with anionic surfactants such as Isotridecyl polyoxethyl phosphoric acid mono/diester (acid form) in the composition.

Alkyl ether sulfates (“ether sulfates”) are anionic surfactants which can be produced by e.g., sulfation of fatty alcohol or oxo alcohol polyglycol ethers and subsequent neutralization. Some examples are the sulfates of addition products with an average of 1 to 10 and in particular 2 to 5 moles of ethylene oxide with caprine alcohol, caprylic alcohol, 2-ethylhexyl alcohol, capric alcohol, lauryl alcohol, isotridecyl alcohol, myristyl alcohol, cetyl alcohol, palmoleyl alcohol, stearyl alcohol, isost Oleyl alcohol, elaidyl alcohol, petroselinyl alcohol, arachyl alcohol, gadoleyl alcohol, behenyl alcohol, erucyl alcohol and brasidyl alcohol and their technical mixtures in the form of their sodium and/or magnesium salts. The ether sulfates can have both a conventional and a narrow homolog distribution.

There are ether sulfates based on adducts of several moles of ethylene oxide with technical C_{12/14} or C_{12/18} coconut fatty alcohol fractions in the form of their sodium and/or magnesium salts. sodium dodecyl ethoxy sulfate, fatty acid sulfates (FAS) and fatty alcohol ether sulphates (FAES), linear alkylbenzene sulfonate (LAS) secondary alkane sulphonate (SAS), etc. There are of course ether sulfates (and alkyl phosphate ethers), based on adducts of one or more moles of ethylene oxide.

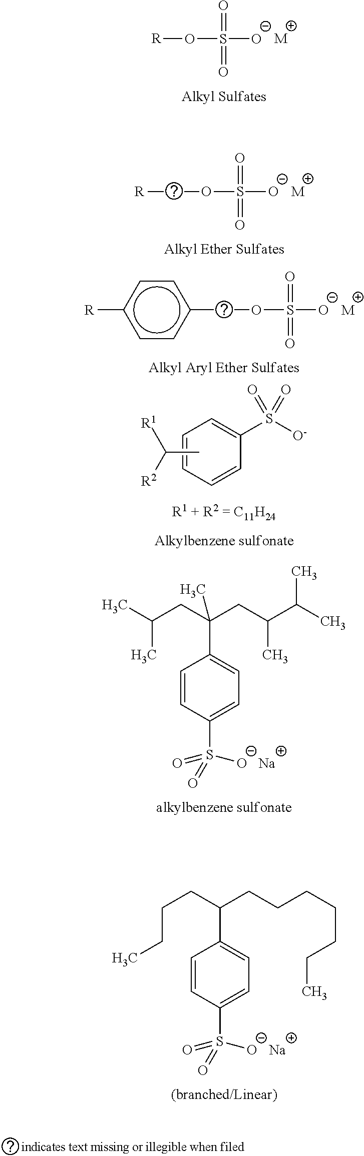

Noted are, salts of alkyl naphthalene sulphonic acids, salts of naphthalene sulphonic acid formaldehyde condensation products, salts of condensation products of naphthalene sulphonic acid, phenol sulphonic acid and formaldehyde, alkali metal salts of alkyl naphthalene sulphonic acids, salts of naphthalene sulphonic acid-formaldehyde condensation products; mono- and diesters of sulfosuccinate metal salts with branched or linear alcohols; sodium dioctyl sulfosuccinate; alkyl Succinate sulphate and any and all combinations thereof.

Inventors also note the commercial sulphate/sulphonate NIFAs, Emulsogen APS 100 Allyl polyoxyalkylene sulfate with 4 PO and 10 EO, ammonium salt Emulsogen® EPA 073 Alkyl polyethylene glycol ether sulfate with 7 EO, sodium salt Emulsogen® EPA 078 Alkyl polyethylene glycol ether sulfate with 7 EO, sodium salt Emulsogen® EPA 1954 C12/C14 alkyl sulfate, sodium salt Emulsogen® LA 033 C12/C14 alkyl polyethylene glycol ether sulfate with 3 EO, ammonium salt Emulsogen® LA 083 C12/C14 alkyl polyethylene glycol ether sulfate with 8 EO, ammonium salt Emulsogen® LCA 213 Alcohol polyethylene glycol ether sulfate, ammonium salt with 21 moles EO Emulsogen® PF 20 S Polyalkylene glycol ethersulfate, ammonium salt Genapol® LRO Liquid C12/C14 alkyl polyethylene glycol ether ether sulfate with 2 EO, sodium salt Genapol® LRO Paste C12/C14 alkyl polyethylene glycol ethersulfate with 2 EO, sodium salt Hostapal® BV Conc. Tributyl phenol polyethylene glycol ethersulfate with 7 EO, sodium salt Hostapal® BV Liquid Tributyl phenol polyethylene glycol ether sulfate with 7 EO, sodium salt Zeliquid® LP 2 Lauryl polyethylene glycol ether sulfate with 3 EO, ammonium salt Emulsogen® SF 8 Di-iso octyl sulfosuccinate, sodium salt.

A further objective of the present invention is to provide process(es) for the preparation of concentrated Pymetrozine oil-based dispersion composition comprising the steps of adding, stirring, milling, collecting, homogenizing, and packaging, without the need for a pre-hydration and/or pre-solvating step for processing the Pymetrozine active ingredient prior to compounding, particularly, this is achieved when limiting the Oil-Based carrier to vegetable oil or their derivatives, exemplified herein by methyl soyate.

Yet another objective of the present invention is to provide concentrated Pymetrozine oil-based dispersion compositions as insecticide for application to crop plants or where required, in the vicinity or locus of the crop plants, often once the concentrated compositions have been diluted and/or dispersed into large volumes of water prior to application.

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter belongs.

As used herein, the term “effective” when used to describe a method for controlling undesired pest means that the method provides a good or subjectively acceptable level of control of the undesired pest without significantly interfering with the normal growth and development of the crop plant.

As used herein, the term “effective amount” refers to an amount of a pesticide, mixture, or composition that, when ingested, contacted with or sensed, is sufficient to achieve a good or acceptable level of control.

As used herein, the term “agriculturally acceptable carrier” means carriers which are known and accepted in the art for the formation of compositions for agricultural or horticultural use.

As used herein, the term “adjuvant” is broadly understood to be any substance that itself is not an active ingredient, but which enhances or is intended to enhance the effectiveness or physical behavior of the pesticide with which it is used. Adjuvants may be understood to include, but not be limited to, spreading agents, penetrants, compatibility agents, and drift retardants.

As used herein, the term “agriculturally acceptable inert additives” (which may include adjuvants, excipients etc.,), is typically understood to any substance that itself is not an active ingredient but is added to the composition, such as sticking agents, surfactants, synergists, anti-oxidation agent, defoaming agents and thickeners so long as they are acceptable for agricultural use.

As used herein, the term “additive” is defined as any substance that itself is not a pesticide but is added to the composition such as sticking agents, surfactants, synergists, buffers, acidifiers, defoaming agents and thickeners.

As used herein, the term “tank mixed” when referring to combinations of pesticides, means that two or more pesticides or compositions of pesticides are mixed in the spray tank at the time of (prior to), spray application or in a suitable holding tank generally in diluted form and often with other non-pesticidal ingredients.

As used herein, the term “plant” includes reference to the whole plant, plant organ (e.g., leaves, stems, twigs, roots, trunks, limbs, shoots, fruits etc.), or plant cells and propagation material.

As used herein, the term “plant” when referring to crops includes reference to agricultural crops including field crops (soybean, maize, wheat, rice, etc.), vegetable crops (potatoes, cabbages, etc.) and fruits (peach, etc.) nuts etc.

As used herein, the term “propagation material” is to be understood to denote all the generative parts of the plant such as seeds and spores, vegetative structures such as bulbs, corms, tubers, rhizomes, roots stems, basal shoots, stolons, and buds.

As used herein, the term “biological activity” includes reference to pesticidal, herbicidal, insecticidal and/or nematicide activity, growth promoting activity, and enhancement of plant growth rates and yield.

As used herein, the term “locus” includes not only areas where pest may already be growing, but also areas where pest have yet to emerge, and also to areas under cultivation. Pests include, but is not limited to, phytopathogenic fungi and unwanted insects or pathogens introduced by insects etc.

As used herein, the term “ha” refers to hectare.

As used herein, the term “mixture” or “combination” refers, but is not limited to, a combination in any physical form, e.g., blend, solution, suspension, dispersion, emulsion, alloy, or the like.

In general, unless otherwise defined, as used herein, the term “substantially free of” e.g., “solvent or adjuvant” or “essentially free of” e.g., “solvent or an adjuvant” generally means that the composition is absent or contains an amount that does not significantly affect the activity or quality of the inventive pesticide compositions. Unless specified or dictated by the context, the term “free of” should be understood as being “substantially free of” or “essentially free of”, this is to account for the possibility of inadvertent inclusion of minuscule amounts, for example, that might accompany commercial ingredients whose labeling may not reveal minor ingredient content.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of.”

Unless otherwise defined or the context demands otherwise, numerical values, numbers ranges herein, are generally understood to be qualified or preceded by the term “about” (interchangeable with approximately). The term “about” as used herein specifically includes ±10% from the indicated values such as in a range, unless the context demands otherwise. In addition to the general rules of rounding, the endpoints of all ranges directed to the same component or property herein are inclusive of the endpoints, are independently combinable, and include all intermediate points and ranges. It is understood that where a parameter range is provided, all integers within that range, and tenths thereof, are also provided by the invention as if individually disclosed. For example, “10-50%” specifically includes 9.5%, 9.6%, 9.7%, 9.8%, 9.9%, 10%, 10.1%, 10.2%, etc. up to 50.44% as though each had been individually disclosed.

### SUMMARY OF INVENTION

The invention provides, non-aqueous pesticidal suspension compositions comprising, pesticide compound in solid particulate form, alkylpolysaccharide surfactant, non-pesticidally active formulation aid(s), and oil-based carrier, wherein the pesticide compound is a hygroscopic, water-soluble and/or solvent absorbing compound and wherein the non-aqueous pesticidal suspension composition optionally comprises a further pesticide compound.

A particular embodiment of the invention provides, pourable, storage stable concentrated Pymetrozine oil-based dispersion compositions which in addition to pymetrozine comprises alkylpolysaccharide (APG) exemplified by Glucopon® 650; triethylamine; Isotridecyl polyoxethyl phosphoric acid mono/diester (Hostaphat® 1306); branched alkylbenzene (C₁₁₋₁₃) sulfonate, calcium salt (Ninate® 401A); Atlox® 4912 (copolymers having a hydrophilic portion of polyethylene oxide (PEG) and a hydrophobic portion of 12-hydroxystearic acid) or Atlox 4914 (PEG poly iso butenyl anhydride tall oil fatty acid copolymer; organic derivative of a hectorite clay, (or fumed silica), and vegetable-based oil (e.g., Methyl Soyate) as a carrier.

In particular embodiments the composition comprises additional pesticide exemplified by flonicamid.

In particular, the invention provides, pourable, storage stable concentrated Pymetrozine oil-based dispersion compositions, adapted for end-use dispersion in an excess of an aqueous media after storage (dilution), characterized by low viscosity, physical quality, and stability and particularly water dispersibility stability as herein defined or by recognized compounding standards, having the following composition percentage content by mass (weight), of concentrate: Pymetrozine, and optionally additional pesticidal compound, between greater than 0% and equal or less than 40%, sometimes 10-35% w/w and including non-insecticidal formulation aids between 0.2% and equal or less than 30% w/w, wherein said non-insecticidal formulation aids are selected from the group of,
a. emulsifier/surfactant between greater than 1% to about 10% exemplified by Hostaphat® 1306 a phosphate ester based on iso-tridecanol ethoxylate alkyl, Ninate® 401A branched alkylbenzene (C₁₁₋₁₃) sulfonate salt, and advantageously both;
b. dispersant, greater than 1% to about 10% exemplified by Atlox® 4914, PEG poly iso-butenyl anhydride—tall oil fatty acid copolymer and/or Atlox® 4912 block copolymers having a hydrophilic portion of polyethylene oxide (PEG) and a hydrophobic portion of 12-hydroxystearic acid;
c. thickener and/or rheological additive, 0.1-3% such as one or more of magnesium aluminium silicate, organic bentonite, organic derivative of a hectorite clay, silicon dioxide, fumed or colloidal silica;
d. end-use dispersibility stabilizer/compatibilizer regulator greater than 0 to about 20% typically comprising components selected from, 1% to about 10% alkyl poly saccharide (alkylpolyglycoside) such as Glucopon® 650; from about 1% to about 7% phosphate ester such as Hostaphat® 1306, from about 0.1%-1% triethylamine, and preferably combinations of two or more thereofthereof; and
e. any and all combinations of two or more of a.-d;
   with oil-based liquid carrier added up to 100%. In many embodiments the content of water in the concentrated Pymetrozine oil-based dispersion is less than or equal to 5% by weight of the complete dispersion concentrate, typically from greater than 0% to less than or equal to 5%, not including any water which is associated with the pre-hydration of the pymetrozine (if such is present).

Accordingly, in several embodiments, the present invention provides a composition of insecticidal oil dispersion (OD) comprising Pymetrozine and vegetable oil and/or derivatives thereof exemplified by methyl Soyate, Methylated Seed Oil etc., in the absence of solvents which adversely affect the utility of the compositions (as defined herein), both in terms of ease of manufacture including aspects of, solidification, dispersibility and/or solidification of Pymetrozine and/or increases in viscosity, physical stability, including aspects of viscosity and yellowing and dispersibility of the compounded composition when diluting in water when forming the end-use liquid for application.

In several embodiments the present invention provides a composition of insecticidal oil dispersion (OD) comprising Pymetrozine and vegetable oil and/or derivatives thereof exemplified by methyl Soyate and Methylated Seed Oil, that can be prepared without the need to pre-treat, or pre-hydrate the Pymetrozine active ingredient (a.i.) prior to compounding.

Inventors have noted the results achieved wherein the carrier in the Pymetrozine Oil Dispersion is a vegetable-based oil exemplified by an alkylated vegetable oil e.g., methyl Soyate rather than, carriers such as mineral oil and paraffin oil.

In notable embodiments, the present invention provides a composition of insecticidal oil dispersion comprising Pymetrozine and other agrochemical auxiliaries in the absence of destabilizing and degrading amounts of damaging solvents as previously detailed, or with minimal content thereof when compensated for by choice of non-insecticidal formulation aids as agrochemical auxiliaries as herein disclosed.

In several embodiments the present invention provides a composition of insecticidal oil dispersion comprising Pymetrozine and other agrochemical auxiliaries in the absence (or essentially absent), of specific destabilizing and degrading anti-freeze agents exemplified by glycol ether compounds, notably propylene glycol. Inventors note however that several commercially available non-pesticidal agricultural ingredients may be supplied with undisclosed minimal amounts of carriers such as propylene glycol, these minimal amounts inadvertently included do not bring the compositions which contain them outside the scope of the invention so long as the advantages of the composition are not lost.

In general, it should be mentioned that inadvertent (or even deliberate), addition or inclusion of minuscule amounts of an ingredient directed herein as being “absent”, in amounts so small so as to have no deleterious or even noticeable effect on the composition are not to be considered as outside the scope of invention, for example where a particular grade of a commercial additive is obtained unknowingly having the unfavored ingredient as a minor component. This is especially the case where such miniscule amounts of an unwanted ingredient are added in attempt to design around while taking advantage of the invention. These insignificant amounts are considered “essentially absent” which as alluded to is defined as encompassing content amounts so small so as to have no visible deleterious or even noticeable effect on the composition, or totally absent.

In some embodiments the present invention is generally, directed to concentrated compositions of insecticidal oil-based dispersions comprising Pymetrozine which contain up to 5% water by weight, (preferably less), in addition to any water that is associated with Pymetrozine active ingredient due to pre-hydration prior to introduction into the formulation, etc. if present. The restriction of water content can thereby improve the ease of compounding, the physical and/or chemical stability and quality of the oil-based concentrated dispersion and also improves the ease with which the oil-based dispersion can later be diluted in water to form an homogeneous end-use insecticide spray mix for application, even after periods of storage. However, as herein detailed, it is the inventive non-Insecticidal formulation aids that enables the ability to safely include small amounts of water (and disadvantageous solvents as previously defined) into the inventive Oil-Based Pymetrozine Dispersion compositions without compromising the physical attributes, stability, or ease of manufacture of the OBPD. In other words, the disclosed inventive additives can compensate to some degree for the “harm” that otherwise might have ensued by the inclusion of less favored components.

Many embodiments of the present invention specifically relate to Oil-Based Pymetrozine Dispersion (OBPD), compositions comprising Pymetrozine and specific agrochemical auxiliaries that avoid compounding and stability challenges, the compositions being characterized by reduced content, or being free of, specified solvents. As defined above, “being free of” often includes being essentially free of or “substantially free of”.

In some concentrated embodiments, the present invention specifically relates to Oil-Based Pymetrozine Dispersion (OBPD), compositions comprising no more than 5% water (other than any water associated with Pymetrozine through pre-hydration if present), thereby improving the quality of the dispersion and the ease with which it can later be diluted and dispersed in water to form the end-use pesticide for application.

In many embodiments, the inventive Oil-Based Pymetrozine Dispersion (OBPD), compositions are intended to be diluted with water prior to their pesticidal application, and those diluted end-use liquids prepared by adding the inventive compositions to water, are clearly within the scope of the invention. Thus, the limits on water content mentioned above are directed to the water content of the inventive stable concentrate embodiments (other than any water associated with Pymetrozine active ingredient), and not to the diluted ready-to-apply liquids, which are prepared immediately prior to their application as pesticides and have no need to be storage stable, for more than e.g., several hours.

In a notable number of embodiments, the present invention more specifically relates to Oil-Based Pymetrozine Dispersion (OBPD), compositions comprising Pymetrozine, one or more dispersing agents, one or more emulsifiers/surfactants, one or more rheology modifiers and one or more oil adjuvants, the OBPD compositions being characterized by ease of compounding and/or improved stability. The inventive Pymetrozine Oil-Based dispersion compositions allow for high loading content of Pymetrozine in the concentrate embodiments of the invention and marked improvements in stability and ease of dispersion in water.

In a some typical embodiments, the present invention more specifically relates to packaged Oil-Based Pymetrozine Dispersion (OBPD), compositions comprising Pymetrozine, one or more dispersing agents, one or more emulsifiers/surfactants, one or more rheology modifiers and one or more oil adjuvants, the OBPD compositions being characterized by ease of compounding and/or improved stability, contained in packaging, exemplified by containers that do not negatively affect the stability of their contents. The packaging containers for the compositions must be equipped with closure systems and be made of material such that when the compositions are packed therein to not allow for the composition contained within to be adversely affected, for example by the ingress of water or water vapor during storage beyond the limits as herein defined.

The present invention also relates to process for the preparation of Oil-Based Pymetrozine Dispersion (OBPD) compositions comprising the steps of adding, stirring, milling, collecting, homogenizing, and packaging, typically into containers that do not negatively affect the stability of their contents as described below.

It has been reported that the photodegradation of Pymetrozine is significantly faster in water compared to non-aqueous systems. See,

Ximei Liang, et al., “Pivotal role of water molecules in the photodegradation of Pymetrozine: New insights for developing green pesticides”, Journal of Hazardous Materials, (2021): https://doi.org/10.1016/j.jhazmat.2021.127197. Clearly, in addition to the inventive improved, ease of manufacture, quality, dispersibility stability and physical attributes of the inventive Oil-Based Pymetrozine Dispersion (OBPD) compositions herein disclosed, additional advantages are predicted to be realized, when or if, the OBPD compositions are exposed to light, especially sunlight, particularly during storage by restricting the water content. Thus, it is envisaged that further chemical stability during storage under sunlit conditions can be attained when the packaging containers within which the compositions are contained (packaged), are made of light excluding materials (opaque), or contained within outer opaque containers (e.g., boxes) such that when the compositions are packed therein, they do not allow for the composition contained within to be exposed to photodegradative levels of light (especially sunlight). Similarly, it is envisioned that after having been applied pesticidally in field conditions, a greater proportion of the Pymetrozine will remain undegraded for greater periods as compared to compositions having a higher water content than defined herein.

Additionally, in several concentrate embodiments, the stability of the Oil-Based Pymetrozine Dispersion compositions, and the stability of the end-use dispersibility of the concentrate in water after storage is vulnerable to being compromised by the presence of more than small amounts of water.

As alluded to above, it is often important that the container into which these Oil-Based Pymetrozine Dispersion (OBPD) compositions are packaged, is sufficiently impermeable to moisture, sunlight, and often both, such that the quality of the dispersion is maintained during storage and the dispersibility is not affected by storage at elevated temperatures.

In general, a suitable container for many of the embodiments of the inventive Oil-based Pymetrozine Dispersion concentrated compositions will be formed from materials which provide a barrier to moisture and/or to light with wavelengths between 250 to 400 nm, such as sunlight. These containers are constructed and sealed so as to preserve the stability of the Oil-based Pymetrozine Dispersion compositions contained therein, by closures that do not impair the level of impermeability to moisture and/or light afforded by the materials from which they are formed.

Typically, a container will be considered suitable for use in packaging OBPD) compositions if the percentage water content of the contained OBPD does not increase to more than 5% w/w after a period of storage at temperatures and humidity, exemplified by 54° C. and/or 40° C./75% RH.

In some noted embodiments a container used to package the OBPD compositions will be impermeable to moisture, such that the % water content of the contained OBPD does not increase by more than 1% w/w after periods of storage in the container at temperatures and humidities in excess of 25° C. for more than a week, exemplified by two weeks at 54° C. and a month at 40° C. and 75% relative humidity (RH).

For a significant number of embodiments, a container suitable for packaging the Oil-Based Pymetrozine Dispersion concentrates of the invention should be sufficiently impermeable to light such that the Pymetrozine content is not degraded by more than 5% w/w as compared to the pymetrozine content at the initiation of the storage period, when stored exposed to sunlight or artificial light with wavelengths between 250 to 400 nm over the storage period.

In a number of noted embodiments, once the Oil-Based Pymetrozine Dispersion concentrate compositions are compounded they are packaged in containers that ensure that during storage at temperatures above room temperatures (above 25° C. or above ambient) and relative humidity the percentage moisture (water content) of the Oil-Based Pymetrozine dispersion composition, remains at substantially the level at the time of completion of compounding, and/or at the time of initiation of storage, and the content of Pymetrozine does not degrade significantly (understood to be greater than 5%), due to photodegradation, during the period of storage.

At a minimum, the packaging container is constructed so as to be impermeable to moisture and light (e.g., sunlight), such that the packaging ensures that both: the percentage water content of the contained OBPD does not increase by more than 5% w/w as compared to the time at which it was compounded, and/or at the time of initiation of storage, after a period of storage in the container at temperatures and humidity, exemplified by two weeks at 54° C. and/or at least one month at 40° C./75% RH, as well as being impermeable to light such that the Pymetrozine content is not photodegraded by more than 5% w/w as compared to the time of initiation of storage, when stored exposed to sunlight or artificial light with wavelengths between 250 to 400 nm.

It is clear that when compounding of the Oil-Based Pymetrozine Dispersion (OBPD) composition is complete, it is advantageous that the OBPD is packaged in a container which is impermeable to moisture and light (e.g., sunlight), such that the packaging ensures that both, the % water content of the contained OBPD does not increase by more than 1% w/w as compared to the time at which it was compounded, and/or at the time of initiation of storage, over the intended storage period exemplified above, as well as the container being impermeable to light such that the Pymetrozine content is not photodegraded by more than 5% w/w when stored exposed to sunlight or artificial light with wavelengths between 250 to 400 nm.

A number of embodiments of the present invention also relate to Oil-Based Pymetrozine Dispersion (OBPD), compositions which have minimized content or are free of, (substantially or essentially free of), solvents exemplified by any of methanol, ethanol, propanol, isopropanol, butanol, isobutanol, t-butanol, cyclohexanol, 2-Ethyl Hexanol, alkylbenzene, tetrahydrofurfuryl alcohol, ethylene glycol, glycerol, methyl acetate, ethyl acetate, ethyl lactate, butyrolactone, gamma butyrolactone, ethylene carbonate, propylene carbonate, acetonitrile, dimethyl sulphoxide, dimethylformamide, dimethylacetamide, N-methyl-2-pyrrolidone, N-octyl-2-pyrrolidone, N-decyl-2-pyrrolidone, acetone, butanone, methyl isobutyl ketone, methylpropyl ketone, acetophenone, cyclohexanone, methylene chloride, trichloromethane, trichloroethane, tetrahydrofuran, diethylether, 1,2-dimethoxyethane, dioxane, methyl-tert.-butylether, ethanolamine, pyridine, chlorobenzene, toluene, xylene or tetramethylurea.

In some embodiments the present invention also relates to Oil-Based Pymetrozine dispersion compositions that include at least one, though typically a combination, of alkoxylated adjuvants alkyl polyglucosides/alkyl polyglycosides/alkyl polysaccharides, triethylamine, phosphates/ethoxylated phosphate esters sulphate/sulphonate based surface-active agents, and up to no more than about 5% water (other than water associated with Pymetrozine from pre-hydration, if present)

Several optimized embodiments of the present invention also relate to Oil-Based Pymetrozine Dispersion (OBPD), compositions wherein the oily carrier is chosen from the group of vegetable oil-based carriers, exemplified by, though not limited to, methyl soyate.

A number of embodiments of the present invention provides Oil-Based Pymetrozine Dispersion (OBPD)compositions comprising Pymetrozine, and agriculturally acceptable non-insecticidal components selected from ingredients such as dispersing agents emulsifiers/surface active agents, rheology modifiers and vegetable oil adjuvants or derivatives thereof, and the like.

Noted embodiments of the invention are characterized by minimal content or the total absence of solvents exemplified by, methanol, ethanol, propanol, isopropanol, butanol, isobutanol, t-butanol, cyclohexanol, 2-Ethyl Hexanol, alkylbenzene, tetrahydrofurfuryl alcohol, ethylene glycol, glycerol, methyl acetate, ethyl acetate, ethyl lactate, butyrolactone, gamma butyrolactone, ethylene carbonate, propylene carbonate, acetonitrile, dimethyl sulphoxide, dimethylformamide, dimethylacetamide, N-methyl-2-pyrrolidone, N-octyl-2-pyrrolidone, N-decyl-2-pyrrolidone, acetone, butanone, methyl isobutyl ketone, methylpropyl ketone, acetophenone, cyclohexanone, methylene chloride, trichloromethane, trichloroethane, tetrahydrofuran, diethylether, 1,2-dimethoxyethane, dioxane, methyl-tert.-butylether, ethanolamine, pyridine, chlorobenzene, toluene, xylene or tetramethylurea. However, these solvents are sometimes the carriers within which the inventive non-insecticidal formulation aids are provided, generally these small amounts of solvent will not be damaging, although as previously mentioned, further advantages maybe achievable by judicious selection of the carrier/solvent within which these ingredients are obtained.

Worthy of mention are those OBPD embodiments that comprise one, some, or all of,
alkyl polyglucosides and/or alkyl polyglycosides;
alkoxylated acids/alcohols, such as alkoxylated/ethoxylated carboxylic acid esters, ethoxylated carboxylic acids, ethoxylated primary or secondary linear or branched alcohols, alkoxylated fatty alcohols, ethoxylated fatty alcohols;
end-use dispersibility stabilizer/compatibilizer tertiary amine such as triethylamine or triethanolamine; and
anionic surfactants, alkyl (alkyl aryl) phosphates/sulfates/ethoxylated phosphate, and/or ethoxylated sulphate (sulfonate), esters; in addition to Pymetrozine and other components of the Oil-based Pymetrozine dispersion concentrates.

Vegetable oil derivatives such as methyl soyate are much preferred as compared to hydrocarbon (paraffin), oil-based carriers in the inventive Oil-Based Pymetrozine Dispersion concentrates, not least because as the inventors surprisingly discovered, the pymetrozine has no need to be pre-hydrated in order to be readily compounded when vegetable oil derivatives are chosen.

The Oil-based pymetrozine dispersion concentrates will in some embodiments, further comprise additional pesticidal (insecticidal), ingredients herein exemplified by flonicamid.

In some embodiments the concentrated Oil-Based Pymetrozine Dispersion compositions contain the following inactive component and non-insecticidal formulation aids and carrier.

| TYPE | Exemplified By | % w/w |
|---|---|---|
| alkoxylated/ethoxylated | Atlox ® 4914 | 1-7 |
| carboxylic acid esters | Atlox ® 4912 | |
| ethoxylated carboxylic acids | Imbentin ® U/050 | |
| ethoxylated primary or | Imbentin ® T080 | |
| secondary linear or branched | | |
| alcohols | | |
| alkoxylated fatty alcohols | | |
| ethoxylated fatty Acids | | |
| anionic phosphate or sulphate | Hostaphat ® 1306 | 1-7 |
| esters | SERVOXYL ® 3/100 | |
| anionic phosphonate/phosphate/ | Rhodafac ® RS 610 | |
| sulfonates/sulfate esters | Alkylbenzene | 0.5-4 |
| | Sulfonate salt | |
| | (linear or branched) | |
| | Calcium Alkylbenzene | |
| | Sulfonate (Branched) | |
| | NINATER 401A | |
| | NINATE ® 411 | |
| | NANSA ® EVM 62/H | |
| | NANSA ® EVM 40/2ND | |
| | NANSA ® EVM 50/ND | |
| End-use dispersibility stabilizer/ | Triethylamine | 0.01-1 |
| compatibilizer | Tri ethanol Amine | |
| Alkyl Polyglucosides | Agnique PG 8107-BL | 1-7 |
| | Triton CG-50 | |
| | Glucopon 650 EC | |
| | Atlox 2575 | |

Several notable embodiments of the inventive concentrated Oil-Based Pymetrozine dispersion compositions wherein the pymetrozine is in solid particulate non-hydrated form, beneficially use vegetable oil-based carriers or their derivatives instead of mineral oil or aromatic, paraffin oils. In particular, inventors find that when vegetable oil-based carriers or their derivatives such as methyl soyate are used instead of mineral oil or aromatic, paraffin oils, the compositions can be easily formulated without the necessity to pre-hydrate the pymetrozine before compounding the Oil-based dispersion. This surprising discovery thus allows for inclusion of greater percentage content of active pesticide compound(s) that would otherwise be water content. This advantage gained by used of carriers such as methyl soyate allows for both higher pymetrozine loading and/or the inclusion of additional pesticidal compounds, exemplified herein by (though not limited to), flonicamid.

Exemplified non-insecticidal ingredients useful in the inventive Pymetrozine Oil-Based Dispersion (OD) compositions include (though definitely not limited to), alkoxylated adjuvants containing one or more C₁-C₄ alkoxy groups, for example one or more propoxy or ethoxy groups or a mixture thereof. Alkoxylated non-insecticidal ingredients can contain from 3 to 50 alkoxy groups such as from 6 to 50 alkoxy groups, for example from 7 to 20 alkoxy groups. Suitable alkoxylated non-ionic adjuvants may include ethoxylated primary or secondary linear or branched alcohols often containing an average of from 8 to 22 carbon atoms in the (linear or branched) alkyl moiety, ethoxylated carboxylic acids often containing an average of from 8 to 22 carbon atoms in the (linear or branched) alkyl moiety, ethoxylated alkyl aryls such as ethoxylated alkyl phenols wherein the (linear or branched) alkyl group frequently contains an average of from 5 to 20 carbon atoms, ethoxylated acetylenic diols typically containing from 8 to 22 carbon atoms in the (linear or branched) alkyl moiety, and the propoxylated or ethoxylated and propoxylated analogues of all the aforesaid ethoxylated non-ionic adjuvants. As used herein, the term “alkoxylated adjuvant” includes block copolymers containing alkoxy groups, such as block copolymers of ethylene oxide and propylene oxide and block copolymers obtained by polycondensation of ethylene oxide and propylene oxide on ethylenediamine. Block copolymers are known to contain from 30% by weight to 80% by weight of ethylene oxide.

The alkoxylated non-ionic adjuvant may be a water miscible or water immiscible liquid or a water-soluble or water-insoluble solid. often the alkoxylated non-ionic adjuvant is a liquid.

A number of suitable ethoxylated alcohols are commercially available including for example the SYNPERONIC® PE or A series having a range of ethylene oxide contents (indicated by the number after the PE or “A”) and based on a C₁₃-C₁₅ alcohol containing about 50% by weight linear alcohol, the remainder being mainly mono-branched; BRIJ 96 and 98 based on an unsaturated C₁₈ linear alcohol and having a mean ethylene oxide content of 10 and 20 respectively; MERGITAL® LM 11 based on C₈-C₁₄ alcohol having a mean ethylene oxide content of 11; MERGITAL® LM 17 based on C₁₀-C₁₄ alcohol having a mean ethylene oxide content of 17 and RHODASURF® TR/15 based on a branched C₁₃ alcohol having a mean degree of ethoxylation of 15. An example of a suitable secondary alcohol ethoxylate is Tergitol® 15-S-9, based on a mixture of C₁₁-C₁₅ linear secondary alcohols having a mean ethylene oxide content of 9. An example of a suitable ethoxylated carboxylic acid is Cithrol 6ML which is ethoxylated laurate with a mean ethylene oxide content of 12. An example of a suitable ethoxylated alkyl phenol is Synperonic® NP13 based on nonyl phenol with a mean ethylene oxide content of 13. An example of a suitable ethoxylated acetylenic diol is Surfynol® 465 which is based on tetramethyldecynediol with a mean ethylene oxide content of 10. Examples of suitable block copolymers of ethylene oxide and propylene oxide are Synperonic® PE L44 and Synperonic® PE P85. Synperonic® PE L44 has a molecular weight of 2200 and contains 40 weight % ethylene oxide; Synperonic PE P85 has a molecular weight of 4650 and contains 50 weight % ethylene oxide.

Imbentin® U/050 127036-24-2 Polyoxyethylenated (POE) (5) iso-undecanol, Alkoxylated fatty alcohols/Ethoxylated fatty alcohols CAS 69011-36-5 Isotridecylalcohol, ethoxylated (CAS 9043-30-5).

Imbentin®-T/080, branched oxoalcohols C₁₃, ethoxylated with 8 mol EO (Trideceth-8).

Exemplified herein is “Atlox® 4914” (ICI/CRODA) being a polymeric surfactant of agricultural use in which the hydrophilic portion is PEG and the hydrophobic portion is alkyd resin.

Reportedly (see EP 2326169), Atlox® 4914, (CRODA, Uniquema) is CAS No. 173717-47-0 and has been identified as being a co-polymer PEG poly-iso-butenyl anhydride-tall oil fatty acid.

Mention may be made, for example, of the polyethylene glycol/polypropylene glycol/polyethylene glycol triblock poly-condensates sold under the names “Synperonic” by the company CRODA (previously Uniqema), such as the ethylene oxide, propylene oxide and ethylene oxide condensate (13 OE/30 OP/13 OE) (MW: 2900) sold under the name Synperonic® PE/L 64 (Poloxamer 184) which is classed as an Ethoxylated Fatty Alcohol, and specifically an ethylene oxide/propylene oxide block copolymer

### Some Non-Limiting Examples

Imbentin®-U/050 comprises of branched oxoalcohols C₁₁, ethoxylated with 5 mol EO (Undeceth-5) Alcohol C₁₁, ethoxylated CAS 127036-24-2,
Imbentin® T/300 70% branched oxoalcohol C₁₃ with 30 mol EO, Alcohol C₁₃-iso, ethoxylated (Isotridecanol,ethoxylated) (Trideceth-30) CAS 69011-36-5, 9043-30-5,
Imbentin® E/100/060 Alcohol C₁₀ with 6 mol EO (Deceth-6) CAS 78330-20-8,
Imbentin® T/060 branched oxoalcohols C₁₃, ethoxylated with 6 mol EO (Trideceth-6)
CAS 9043-30-5,
Imbentin® T/030 branched oxoalcohols C₁₃, ethoxylated with 3 mol EO (Trideceth-3)
CAS 9043-30-5
Imbentin® E/100/050 alcohols C₁₀, ethoxylated with 5 mol EO (Isodeceth-5)
CAS 78330-20-8
Imbentin® U/060 branched oxoalcohols C₁₁, ethoxylated with 6 mol EO (Undeceth-6)
CAS 127036-24-2
Imbentin® T/090 branched oxoalcohols C₁₃, ethoxylated with 9 mol EO (Trideceth-9)
CAS 9043-30-5
Imbentin® T/080 branched oxoalcohols C₁₃, ethoxylated with 8 mol EO (Trideceth-8) CAS 9043-30-5
Imbentin®-E/100/070 C₁₀ oxoalcohol+7EO
Imbentin®-G/100/080 2-propyl-2-heptanol+8EO. Liquid at room temperature. HLB 15
Imbentin®-C/91/060 C₉-C₁₁ oxoalcohol+6EO. Liquid at room temperature. HLB Value 12.5
Imbentin®-E/100/090 C₁₀ oxoalcohol+9EO. Liquid (pasty) at room temperature. HLB 15.5

Also, alkyl-polyoxyethylene alkanoates, where alkyl is C₁₂-C₁₈, and rosin acid ethoxylates, as abietic acid ethoxylates (products “Scurol C” and “Soprophor 64/C” of Rhodia) are of note.

Exemplified here is Hostapha™ 1306 lsotridecyl polyoxethyl (6 EO) phosphoric acid mono/diester, acid form; About 96% liquid Emulsifier which is a model for various phosphoric acid related compounds, particularly anionic phosphate esters/ethoxylated phosphate esters, useful in the invention. Hostapha™ 1306 is a phosphate ester based on iso-tridecanol ethoxylate and is used as anionic emulsifier and dispersing agent.

Some other non-insecticidal formulation aid products are,
Hostaphat® CC 100 Cetyl phosphoric acid ester, acid form, mono/diester ~98%
Hostaphat® CK 100 Cetyl phosphoric acid ester, potassium salt, mono/diester ~98% Hostaphat® MDAH Mono-/di-2-ethylhexyl phosphoric acid ester, acid form ~98
Hostaphat® 145 Oleyl polyoxethyl (5EO) phosphoric acid mono/diester, acid form ~98%
Hostaphat® 1306 Isotridecyl polyoxethyl (6EO) phosphoric acid mono/diester acid form-96%
Hostaphat® KL 340 D Lauryl polyethoxy (4EO) phosphoric acid ester, sodium salt,mono/di/tri-ester ~90
Hostaphat® KW 340 D Stearyl polyethoxy (4 EO) phosphoric acid ester, sodium salt, mono/di/tri-ester ~t 90%
Hostaphat® MIT 080 Tridecyl polyethylene glycol ether phosphoric acid ester (8 EO), acid form, about 80% mono ester ~98%
Hostaphat® OPS 30 Octane phosphonic acid dissolved in water ~30%
Hostaphat® OPS 75 E n-Octane phosphonic acid+ethanol/water ~75%
Hostaphat® OPS 100 n-Octane phosphonic acid ~100%

Some non-insecticidal formulation aid commercially available ingredients include (though not limited to) phosphate Esters, e.g., organic phosphate esters are derived from ethoxylated alcohols, alkyl phenols or phenols and are composed of mixtures of mono- and diesters. Most of these surfactants are supplied as free acids that can be converted to salts by the addition of bases.

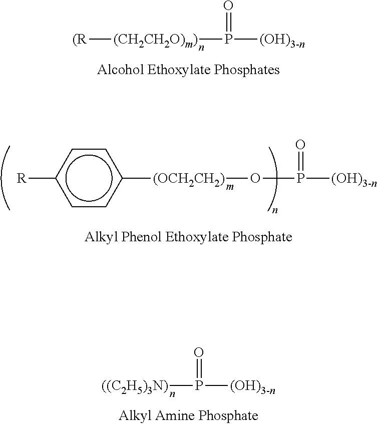

SERVOXYL VPDZ 3/100 tridecyl polyglycol ether (3EO) phosphate
SERVOXYL VPDZ 6/100 tridecyl polyglycol ether (6EO) phosphate
SERVOXYL VPDZ 20/100 tridecyl polyglycol ether (20EO) phosphate
SERVOXYL VPEZ 100 iso-butyl phosphate
SERVOXYL VPFZ 5/100 oleyl polyglycol ether (5EO) phosphate
SERVOXYL VPFZ 7/100 oleyl polyglycol ether (7EO) phosphate
SERVOXYL VPGZ 6/100 phenol polyglycol ether (6EO) phosphate
SERVOXYL VPHZ 100 n-octyl phosphale
SERVOXYL VPI 55 n-butyl phosphate, Na-salt
SERVOXYL VPIZ 100 n-butyl phosphate
SERVOXYL VPIZ 4/100 n-butyl polyglycol ether (4EO) phosphate
SERVOXYL VPKZ 100 oleyl phosphate
SERVOXYL VPKZ 5/100 nonylphenyl poly glycol ether (5EO) phosphate
SERVOXYL VPNZ 6/100 nonyl phenol polyglycol ether (6EO) phosphate
SERVOXYL VPNZ 7/100 nonylphenol polyglycol ether (7EO) phosphate
SERVOXYL VPNZ 9/100 nonyl phenol polyglycol ether (9EO) phosphate
SERVOXYL VPNZ 14/100 nonyl phenol polyglycol ether (14EO) phosphate
SERVOXYL VPNZ 20/100 nonyl phenol polyglycol ether (20EO) phosphate
SERVOXYL VPPZ 100 isopropyl phosphate
SERVOXYL VPRZ 100 cetyl/stearyl phosphate
SERVOXYL VPRZ 6/100 cetyl/stearyl pclyglycol ether (6EO) phosphate
SERVOXYL VPRZ 11/100 cetyl/stearyl pclyglycol ether (11EO) phosphate
PROTE-PON P-TD-06-Z alkyl ether phosphoric acid
PROTE-PON P-TD-09-Z alkyl ether phosphoric acid
PROTE-PON P-TD-12-Z alkyl ether phosphoric acid
PROTE-PON TD-09-K30 alkyl ether potassium phosphate
LUBRHOPHOS LP 700 phosphate ester with aromatic base
RHODAFAC BG 510 phosphate ester with aliphatic base
RHODAFAC PA 15 phosphate ester with aliphatic base
RHODAFAC PA/17 alkylphenoxypolyethyl ester of phosphoric acid
RHODAFAC PA/19 alkylphenoxypolyethyl ester of phosphoric acid
RHODAFAC PE/610 alkylphenoxypolyethyl ester of phosphonc acid
RHODAFAC PE/960 alkylphenoxypolyethyl ester of phosphoric acid
RHODAFAC RA 600 phosphate ester with aliphatic base
DERMALIX C alkyl phosphate in aqu./organic medium
ELFUGiN AKT 300% phosphate ester in aq. soln.
SANDOCLEAN SKBB alkyl phosphate esters
SANDOCORIN 8160 phosphate esters
SANDOCORIN LF10 phosphate esters in aq. soln.
SANDOCORIN LF20 phosphate esters and triazoles in aq. soln.
SANDOCORIN LF30 phosphate esters, triazoles and sequestering agents
SANDOPAN BFN mixture of phosphate esters
SANDOPAN SF phosphate ester
SANDOZIN EH phosphate ester in aq-organic soln.
SERVOXYL VPAZ 100 lauryl phosphate
SERVOXYL VPAZ 3/100 lauryl polyglycol ether (3EO) phosphate
SERVOXYL VPBZ 5/100 C₁₂-C₁₈ fatty alcohol (5EO) phosphate
SERVOXYL VPDZ 100 tridecyl phosphate
PROTE-PON P-TD-06-Z alkyl ether phosphoric acid
PROTE-PON P-TD-09-Z alkyl ether phosphoric acid
PROTE-PON P-TD-12-Z alkyl ether phosphoric acid
PROTE-PON TD-09-K30 alkyl ether potassium phosphate
LUBRHOPHOS LP 700 phosphate ester with aromatic base
RHODAFAC BC 510 phosphate ester with aliphatic base
RHODAFAC PA 15 phosphate ester with aliphatic base
RHODAFAC PA/17 alkylphenoxy polyethyl ester of
phosphoric acid
RHODAFAC PA/19 alkylphenoxypolyethyl ester of
phosphonc acid
RHODAFAC PE/610 alkylphenoxypolyethyl ester of
phosphonc acid
RHODAFAC PE 960 alkylphenoxypolyethyl ester of
phosphonic acid
RHODAFAC RA 600 phosphate ester with aliphatic base
DERMALIX C alkyl phosphate in aq/organic medium
ELFUGiN AKT 300% phosphate ester in aq soln.
SANDOCLEAN SKBB alkyl phosphate esters
SANDOCORIN 8160 phosphate esters
SANDOCORIN LF10 phosphate esters in aq soln.
SANDOCORIN LF 20 phosphate esters and triazoles in aq. soln.
SANDOCORIN LF 30 phosphate esters, triazoles and sequestering agents
SANDOPAN BFN mixture of phosphate esters
SANDOPAN SF phosphate ester
SANDOZiN EH phosphate ester in aq-organic soln.
SERVOXYL VPAZ 100 lauryl phosphate
SERVOXYL VPAZ 3/100 lauryl polyglycol ether (3EO) phosphate
SERVOXYL VPBZ 5/100 C₁₂-C₁₈,. fatty alcohol (5EO) phosphate
SERVOXYL VPDZ 100 tridecyl phosphate
PAE 147 phosphated alcohol ethoxylate
PAE 1780 phosphated alcohol ethoxylate
PPE 156 phosphated phenol ethoxylate
PPE 159 phosphated phenol ethoxylate
PPE 604 phosphated phenol ethoxylate
LIBRAPHOS AD sodium salt of Libraphos EP 120
LIBRAPHOS EP 120 ethoxy alkyl aryl phosphate ester, acid form
LIBRAPHOS EP alkyl phosphate ester, acid form
LIBRAPHOS ER 150 ethoxy alkyl aryl phosphate ester, acid form
LIBRAPHOS HC 2A ethoxy alkyl phosphate ester, acid form
LIBRAPHOS HC 2K potassium salt of Libraphos HC 2A
LIBRAPHOS HC3A alkyl phosphate ester, acid form
LIBRAPHOS L66 potassium salt of Libraphos P4 Ester
LIBRAPHOS MR 100 phosphate ester, acid form
LIBRAPHOS P4 ESTER phosphate ester, acid form
LIBRAPHOS TL 100 P4 ethoxy alkyl phosphate ester, acid form
ALKAWET N mixed phosphate ester
NIKKOL DDP-2 di POE (2) alkyl ether phosphate; free acid form
NIKKOL DDP-4 di POE (4) alkyl ether phosphate; free acid form
NIKKOL DDP-6 di POE (6) alkyl ether phosphate; free acid form
NIKKOL DDP-8 di POE (8) alkyl ether phosphate; free acid form
NIKKOL DDP-10 di POE (10) alkyl ether phosphate; free acid form
NIKKOL DLP 10 dilaureth-10 phosphate
NIKKOL DNPP-4 dinonoxynol-4 phosphate
NIKKOL DOP 8N dioleth-8 phosphate
NIKKOL PHOSTEN HLP-N sodium lauryl phosphate
MARLOPHOR NP7-ACID nonylphenol polyethyleneglycol ether phosphoric acid partial ester
MARLOPHOR OC5-Acid olein polyethyleneglycol ether phosphonc acid partial ester
MARLOPHOR ON 3-acid isotridecyl polyethyleneglycol ether phosphoric acid partial ester
MARLOPHOR ON 5-Acid isotridecyl polyethyleneglycol ether phosphoric acid partial ester
MARLOPHOR ON 7-ACID isotridecyl polyethyleneglycol ether phosphoric acid partial ester
MARLOPHOR T6—Acid tallow polyethyleneglycol ether phosphonc acid partial ester
MARLOPHOR T10-Acid tallow poiyethyleneglycol ether phosphonc add partial ester
MARLOPHOR UW 12-ACID alkyl polyethyleneglycol ether phosphoric acid partial ester
MARLOWET 5301 coconut polyethylene glycol ether phosphoric acid partial ester
MARLOWET 5311 iso-nonanol phosphoric add partial ester
MARLOWET 5320 nonylphenol polyethylene glycol ether phosphoric acid partial ester
MARLOWET 5324 phenol polyethylene glycol ether phosphoric acid partial ester
MARLOWET 5361 alkyl polyethylene glycol ether phosphoric acid partial ester
ATLAS G-2203 potassium salt of phosphoric acid ester
ATLAS G-2207 potassium salt of phosphoric acid ester
FOSFODET 1214 N/16 ethoxylated fatty alcohol phosphate ester
FOSFODET 20 D fatty alcohol, phosphate ester
FOSFODET 9Q/22 ethoxylated alkyl-aryl phosphate ester
FOSFODET T-17 ethoxylated fatty alcohol, phosphate ester
PA 100 phosphated alcohol
PA800 phosphated alcohol ethoxylate
PAE 106 phosphated alcohol ethoxylate
PAE 126 phosphated alcohol ethoxylate
PAE 136 phosphated alcohol ethoxylate
DlSPONIL AEP 5300 alkyl aryl ether phosphate, acid ester
DISPONIL AEP 5302 alkyl aryl ether phosphate, acid ester
DISPONIL AEP 8100 alkyl aryl ether phosphate, acid ester
DISPONIL AEP 9525 alkyl aryl ether phosphate, sodium salt
FORLANIT E hydroxycetyl phosphate
FORLANIT P fatty alcohol ether phosphate, sodium Salt
KATAX AL phosphoric acid ester
OSIMOL 728 modified phosphoric acid ester
OSIMOL LVP modified phosphoric acid ester
H OSTAPHAT KL340 trilaureth-4 phosphate
HOSTAPHAT KL340N trilaureth-4 phosphate
HOSTAPHAT KW340 trilaureth-4 phosphate
HOSTAPHAT KW340N trilaureth-4 phosphate
MARLOPHOR CS ACID isopropyl phosphoric acid partial ester
MAELOFHOR DS-ACID n-butyl phosphoric acid partial ester
MARLOPHOR F 1-ACID n-hexyl polyethylene glycol ether phosphoric acid partial ester
MARLOPHOR FC NA-SALT 2-ethylhexypolyethylene glycol ether phosphoric acid partial ester, sodium salt
MARLOPHOR FC ACID 2-ethylhexylpolyethylene gly colei her phosphoric acid partial ester
MARLOPHOR HS-ACID n-octyl phosphoric acid partial ester
MARLOPHOR IH-ACID 2-ethylhexylphosphoric acid partial ester
MARLOPHOR MO3-ACID lauryl polyethylene glycol ether phosphoric acid partial ester
MARLOPHOR N5-ACID isononyl polyethylene glycol ether phosphoric acid partial ester
MARLOPHOR ND-ACID blend of iso-dkyiphosphoric acid partial ester and atkylphenol polyethylene glycol ether
MARLOPHOR ND DE A SALT blend of iso-alkylphosphoric acid partial ester and alkylphenol poly ethyleneglycol ether
MARLOPHOR NP 5-ACID nonylphenol polyethylene glycol ether phosphoric acid partial ester
SERVOXYL VPT 3/85 2-ethylhexyl polyglycol ether (3EO) phosphate, Na-salt
SERVOXYL VPTZ 100 2-ethylhexyl phosphate
SERVOXYL VPTZ 3/100 2-ethylhexyl polyglycol ether (3EO) phosphate
SERVOXYL VPUZ 100 methyl phosphate
SERVOXYL VPXZ 100 isononyl phosphate
SERVOXYL VPXZ 5/100 isononyl polyglycol ether (5EO) phosphate
POLYSTEP PN 209 alkylphenol ethoxylate phosphoric ester acid
STEPFAC PN SERIES phosphonc ester
TRITON H-55 phosphate ester
TRITON H-66 phosphate ester
TRITON QS-44 phosphate ester
MYKON 8402 phosphated nonyl phenol ethoxylate
Phospholan PS-131 Tridecyl Alcohol (6 EO) Ethoxylate Phosphate Ester
Phospholan PS-220 C₁₀₋₁₄ Alcohol (30 EO) Ethoxylate Phosphate Ester
Phospholan PS-222 C₁₂₋₁₅ Alcohol (3 EO) Ethoxylate Phosphate Ester
Phospholan PS-236 C₁₀₋₁₄ Alcohol (3 EO) Ethoxylate Phosphate Ester Alkyl Phenol Ethoxylate Phosphate
Phospholan CS-1361 Nonylphenol (6 EO) Ethoxylate Phosphate
Ester, Sodium Salt Phospholan CS-141 Nonylphenol (10 EO)
Ethoxylate Phosphate Ester
Phospholan CS-147 Nonylphenol (8EO) Ethoxylate Phosphate Ester Phenol Ethoxylate Phosphate
Phospholan TS-211 Phenol (3 EO) Ethoxylate Phosphate Ester Alkyl Amine Phosphate
Phospholan TEAP Triethylammonium Phosphate
REWOPHAT E 1027 alkyl phenol polyglycol ether phosphate
REWOPHAT EAK 8190 lauryl alcohol polyglycol ether phosphate
REWOPHAT NP 90 alkyl phenol polyglycol ether phosphate
SYNTOPHOS 06 N based on ethoxylated alcohol
ULTRAPHOS 59 based on ethoxylated phenol
WTTCOR SI-3065 complex phosphate ester
COLLASTAT AP phosphoric add ester
ELACTIV K phosphoric acid ester
ELACTIV PS phosphoric acid ester
ELACTIV PV phosphoric acid ester
FLEROL TP 3000 modified phosphoric acid ester
PHOSFETAL 201 K potassium alkyl polyglycol ether phosphate
PHOSFETAL 201 alkyl polyglycol ether phosphate, acid
PHOSFETAL 205 alkyl polyglycol ether phosphate, acid
PHOSFETAL 600 alkylaryl polyglycol ether phosphate, and
PHOSFETAL 601 alkylaryl polyglycol ether phosphate, and
PHOSFETAL 602 alkylaryl polyglycol ether phosphate, acid
PHOSFETAL 603 alkylaryl polyglycol ether phosphate, aad

A useful class of non-pesticidal ingredient are dispersing agents, an exemplified product is characterized by a compound, the hydrophobic part of which is formed by poly-12-hydroxystearic acid (APHS/EO), and a hydrophilic part of which is formed by polyethylene oxide representative examples of which is the commercial product Atlox® 4914 or Hypermer B261 by Uniquema. An alternative ingredient can be a compound exemplified by, branched oxo-alcohols C₁₁, ethoxylated with 5 mol EO (Alcohol C₁₁+5 EO) such as the commercial product Imbentin® U/050 which is reported to be Undecyl alcohol, ethoxylated/Alcohols, C₉₋₁₁, branched, ethoxylated.

Another ingredient category worthy of note is Phosphate esters of ethoxylated fatty alcohols, alkyl phosphates, ethoxylated phosphate esters and the like. These ingredients have been found to be extremely helpful ingredients in the inventive Oil-Based Pymetrozine dispersion compositions.

In some embodiments of the present invention provides a composition of insecticidal oil dispersion comprising Pymetrozine, calcium alkyl benzene sulphonate, castor oil ethoxylate, alkylpolyglucoside, organic derivative of a hectorite clay, (or fumed silica), and vegetable-based oil (e.g., Methyl Soyate).

In some embodiment of the present invention provides a composition of insecticidal oil dispersion comprising pymetrozine, isotridecyl polyoxy-alkyl (e.g. 6 EO) phosphoric acid mono/diester, (such as the acid form) calcium alkyl benzene sulphonate such as branched alkylbenzene (C₁₁₋₁₃) sulfonate, calcium salt), castor oil ethoxylate, alkylpolyglucoside (alkyl polyglucoside/alkyl polysaccharide), organic derivative of a hectorite clay, (or fumed silica), and vegetable-based oil carrier (such as Methyl Soyate).

Additional advantages are realized by addition of end-use dispersibility stabilizer/compatibilizer compounds such as tertiary amine, alkyl amine such as, triethylamine, triethanolamine, n,n-di-isopropyl ethylamine, butylamine, etc. exemplified by triethylamine to the concentrated Oil-Based Pymetrozine Dispersion compositions.

Inclusion of these types of end-use dispersibility stabilizer/compatibilizer compounds provide good dispersion characteristics of the inventive compositions in water after dilution and are useful in preventing noticeable change of color by visual inspection over periods of storage for periods of more than a week above 25° C. (room temperature), such as storage at 54° C. for two weeks or more and/or storage for at least one month at 40° C./75% RH.

Another embodiment of the present invention provides a process for the preparation of Pymetrozine oil dispersion composition comprising the steps of adding, stirring, milling, collecting, homogenizing, and packaging, without the need for pre-hydration or pre-solvation of the Pymetrozine prior to compounding, by choosing the oily carrier from vegetable oils and their alkylated derivatives such as methylated seed oil, Methyl Soyate etc.

In some noted embodiments a container used to package the OBPD compositions will be impermeable to moisture, such that the % water content of the contained OBPD does not increase by more than 1% w/w after a period of storage in the container at elevated temperatures and humidity, exemplified by 54° C. and 40° C./75% RH.

For a significant number of embodiments, a container suitable for packaging the Oil-Based Pymetrozine Dispersion concentrates of the invention should be sufficiently impermeable to light such that the Pymetrozine content is not degraded by more than 5% w/w when stored exposed to sunlight or artificial light with wavelengths between 250 to 400 nm.

Inventors note that they have found that replacing commonly used oily carriers such as paraffins, mineral oils etc., by vegetable-based oils exemplified by methyl Soyate, in Pymetrozine Oil-Based dispersions, the need for pre-hydration or pre-solvation of the Pymetrozine prior to compounding with the other advantageously selected ingredients, has been eliminated and the necessity or amount of emulsifying components can be reduced.

Another embodiment of the present invention provides a composition of Pymetrozine oil dispersion which saves operational cost and production steps, enables high dose loading compared to previously encountered attempts at compounding such products.

Noted embodiments of the inventive OBPD compositions are concentrates adapted to be readily dispersed in excess aqueous media immediately prior to use, often after an extended period of storage. The stability of dispersibility is a major advantage achieved by a number of these embodiments.

Yet another embodiment of the present invention provides a composition of insecticidal oil dispersion comprising:
(a) pesticidal ingredient comprising solid particulate Pymetrozine in the range of 0.1% to 50% (w/w), typically up to 35%±5%,
(b) stabilizing dispersing agents in the range of 0.03% to 10% (w/w),
(c) enhancing emulsifiers in the range of 0.01% to 20% (w/w) typically up to 10%,
(d) rheology modifiers in the range of 0.01% to 5% (w/w), and
(e) vegetable oil-based carrier/adjuvant in the range of 0.4% to 90% (w/w)), more typically up to 65%±5%,
   wherein the pesticidal ingredient optionally comprises an additional pesticidal compound such as flonicamid.

In some concentrated embodiments, the present invention provides a composition of insecticidal oil dispersion comprising:
(a) pesticidal ingredient comprising solid particulate Pymetrozine in the range of greater than 0%-40% (w/w) typically up to 35%,
(b) stabilizing dispersing agents in the range of 3% to 10% (w/w),
(c) enhancing emulsifiers in the range of 1% to 20% (w/w) typically up to 10%,
(d) rheology modifiers in the range of 1% to 5% (w/w), and
(e) vegetable oil-based carrier/adjuvant in the range of 30% to 80% (w/w), more typically up to 65%±5%,
   wherein the pesticidal ingredient optionally comprises an additional pesticidal compound such as flonicamid.

Yet another embodiment of the present invention provides a concentrated composition of insecticidal oil dispersion comprising:
(a) pesticidal ingredient comprising solid particulate Pymetrozine in the range of 5% to 35% (w/w),
(b) alkyl phosphates/ethoxylated phosphate esters in the range of 1% to 10% (w/w),
(c) ethoxylated/Alcohols in the range of 1% to 10% (w/w),
(d) copolymers of α-olefin & ethylene glycol ether in the range of 1% to 10% (w/w),
(e) organic derivative of a hectorite clay in the range of 0.1% to 3%, and optionally fumed silica in the range of 0.1% to 3% (w/w), and
(f) vegetable oil or alkyl vegetable oil in the range of 30% to 80% (w/w), more typically up to 65%±5%,
   wherein the pesticidal ingredient optionally comprises an additional pesticidal compound such as flonicamid.

Yet another embodiment of the present invention provides a composition of insecticidal oil dispersion comprising:
(a) pesticidal ingredient comprising solid particulate Pymetrozine in the range of 20% to 50% (w/w) typically up to 32%±10%,
(b) alkyl phosphates/ethoxylated phosphate esters in the range of 3% to 10% (w/w),
(c) tri-sec-butylphenol polyglycol ether in the range of 1% to 10% (w/w),
(d)alkyl polyglucosides/polyglycosides in the range of 1% to 10% (w/w),
(e) organic derivative of a hectorite clay in the range of 0.1% to 3%, optionally combined with fumed silica in the range of 0.1% to 3% (w/w), and
(f) Methyl Soyate in the range of 30% to 72% (w/w), more typically up to 65%±5%,
   wherein the pesticidal ingredient optionally comprises an additional pesticidal compound such as flonicamid.

Yet another embodiment of the present invention provides a composition of insecticidal oil dispersion comprising:
(a) pesticidal ingredient comprising solid particulate Pymetrozine in the range of 20% to 50% (w/w),
(b) anionic alkyl ether sulfate surfactants such as calcium alkyl benzene sulphonate in the range of 3% to 10% (w/w),
(c) alkoxylated alcohols such as, tri-sec-butylphenol polyglycol ether in the range of 1% to 10% (w/w),
(d)alkyl polyglucosides/polyglycosides in the range of 1% to 10% (w/w),
(e) organic derivative of a hectorite clay in the range of 0.1% to 3%, optionally combined with fumed silica in the range of 0.1% to 3% (w/w), and
(f) Methyl Soyate in the range of 30% to 72% (w/w)), more typically up to 65%±5%
   wherein the pesticidal ingredient optionally comprises an additional pesticidal compound such as flonicamid.

Several embodiments of the invention provide Pymetrozine Oil-Based Dispersion compositions exemplified (though not limited), by comprising in addition to Pymetrozine, some or all of,
copolymers of α-olefin & ethylene glycol (e.g., Atlox® 4914)
Phosphate esters of ethoxylated fatty alcohols (e.g., Hostaphat® 1306)
Organic derivative of a hectorite clay (Bentone® SD 3)
Triethylamine (TEA)
alkyl polyglucosides/alkyl polyglycosides/alkyl polysaccharides (e.g., Glucopon® 650 EC/Agnique® PG 8107-BL/8105-G Atlox® AL-2575/A1-2579)
Alkylated vegetable Oil e.g., Methyl Soyate

Alkyl polyglucosides (Formula 1) are a group of surface active compounds which are alkyl polyglycosides derived from glucose.

### Structure of Alkyl Polyglucoside (APG)

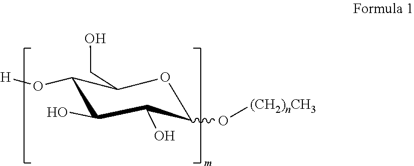

Their hydrophilic and hydrophobic parts are clearly separated. The hydrophilic group in an APG molecule usually consists of one to five condensed glucoside parts (DP=1-5). The hydrophobic group in APG molecules is an alkyl chain containing usually from six to eighteen carbon atoms. Surface activity depends both on the hydrophilic part and the hydrophobic part, although to varying degrees. Surface activity of surfactants is determined primarily by the chain length. According to Traube's rule, surface activity at the water/air interface increases threefold with an increase in the chain length by a CH₂ group (at 20° C.).

The hydrophilic part affects adsorbability to a lesser extent. However, it affects solubility in polar solvents. Depending on the structure of the molecule, alkyl polyglucosides exhibit different solubility in various solvents. The compounds with the degree of polymerization (DP) from 1 to 5 containing alkyl chains whose length is from 6 to 14 carbons are soluble in water. The molecules with 16 to 22 carbon atoms are oil soluble. In general, increasing the degree of polymerization increases solubility in a polar medium while lengthening of the alkyl chain increases solubility in a non-polar medium. Alkyl polyglucosides occur in the form of monomers at low concentrations and produce micelles above the critical micelle concentration (CMC) usually of the order of hundredths of a percent. Aqueous solutions of alkyl polyglucosides may appear in the form of lyotropic liquid crystals at the concentrations of above 30%.

Alkyl polyglycosides/alkyl polyglucosides are part of the group of Alkylpolysaccharide Surfactants The surfactant component comprises one or more alkylpolysaccharide surfactants. Examples of alkylpolysaccharide surfactants include compounds of Formula 2:

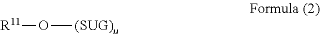

wherein R¹¹ is a straight or branched chain substituted or unsubstituted hydrocarbyl selected from alkyl, alkenyl, alkylphenyl, alkenylphenyl having from about 4 to about 22 carbon atoms for from about 4 to 18 carbon atoms. The SUG moiety is a saccharide residue and may be an open or cyclic (i.e., pyranose) structure. The saccharide may be a monosaccharide having 5 or 6 carbon atoms, a disaccharide, an oligosaccharide or a polysaccharide. Examples of suitable saccharide moieties, including their corresponding pyranose form, include ribose, xylose, arabinose, glucose, galactose, mannose, telose, gulose, allose, altrose, idose, lyxose, ribulose, sorbose (sorbitan), fructose, and mixtures thereof. Examples of suitable disaccharides include maltose, lactose, and sucrose. Disaccharides, oligosaccharides and polysaccharides can be a combination of two or more identical saccharides, for example maltose (two glucoses) or two or more different saccharides, for example sucrose (a combi nation of glucose and fructose). The degree of polymerization, u, is an average number from 1 to about 10, from 1 to about 8, from 1 to about 5, from 1 to about 3, and from 1 to about 2.

In various embodiments, the alkylpolysaccharide surfactant may be an alkylpolyglucoside (APG) surfactant of formula (2) wherein: R¹¹ is a branched or straight chain alkyl group often having from 4 to 22 carbon atoms or from 8 to 18 carbon atoms, or a mixture of alkyl groups having an average value within the given range; SUG is a sugar residue such as a glucose residue (e.g., a glucoside); and u is from 1 to about 5, and more typically from 1 to about 3. In various embodiments, the surfactant component comprises an APG of formula (2) wherein R¹¹ is a branched or straight chain alkyl group having from 8 to 10 carbon atoms or a mixture of alkyl groups having an average value within the given range and u is from 1 to about 3.

Alkyl polyglycosides include though not limited to, APG® 325 (Cognis), an alkyl polyglycoside in which the alkyl group contains 9 to 11 carbon atoms and has an average degree of polymerization of 1.6, PLANTAREN® 2000 (Cognis), an alkyl polyglycoside in which the alkyl group contains 8 to 16 carbon atoms and has an average degree of polymerization of 1.4, PLANTARN® 1300 (Cognis) an alkyl polyglycoside in which the alkyl group contains 12 to 16 carbon atoms and has an average degree of polymerization of 1.6, AGRIMUL® PG 2067 (Cognis), an alkyl polyglycoside in which the alkyl group contains 8 to 10 carbon atoms and has an average degree of polymerization of 1.7, AGRZMCTL® PG 2069 (Cognis), an alkyl polyglycoside in which the alkyl group contains 9 to 11 carbon atoms and has an average degree of polymerization of 1.6, AGRIMUL® PG 2076 (Cognis), an alkyl polyglycoside in which the alkyl group contains 8 to 10 carbon atoms and has an average degree of polymerization of 1.5, ATPLUS® 438 (Unigema, Inc., Wilmington, DE) (an alkylpolysaccharide in which the alkyl group contains 9 to 11 carbon atoms), and ATPLUS® 452 (Unigema, Inc., Wilmington, DE) (an alkylpolysaccharide in which the alkyl group contains 8 to 10 carbon atoms),
Agnique® PG 8105-G C₈/C₁₀ alkyl polyglycoside (D.P.=1.5) 68515-73-1
Agnique® PG 8107-G C₈/C₁₀ alkyl polyglycoside (D.P.=1.7) 68515-73-1
Agnique® PG 8107-BL low foam alkyl polyglycoside (D.P.=1.7) 68515-73-1
Agnique® PG8107-G
   Agrimul® PG 2067

| | | Analyses | | |
|---|---|---|---|---|
| Alkyl | Glucose | | Per cent | Melting |
| radical | units | Hydroxyl | free alcohol | range/° C. |
| n-Decyl | 1.3 | 716 | 0.5 | 70-72 |
| n-Decyl | 2.3 | 802 | 2.7 | 95-100 |
| n-Decyl | 4.0 | 900 | 0.3 | |
| Oxo-decyl | 2.2 | 820 | 0.9 | 108-110 |
| Oxo-decyl | 4.0 | 907 | 0.1 | 195-200 |
| n-Dodecyl | 2.5 | 786 | | |
| Oxo-tridecyl | 1.5 | 651 | 1.6 | 60-70 |
| Oxo-tridecyl | 4.0 | 859 | 0.6 | 217-219 |
| Oxo-tridecyl | 9.0 | 943 | 0.9 | 290-300 |
| n-Tetradecyl | 2.0 | 894 | 0.8 | 110-120 |
| n-Hexadecyl | 1.5 | 629 | 6.0 | 104-106 |
| n-Octadecyl | 1.3 | 525 | | 50-60 |
| n-Octadecyl | 7.0 | 878 | 0.2 | >300 |
| n-Oleyl | 1.0 | 459 | | 30-40 |
| n-Oleyl | 5.0 | 831 | 1.5 | 190-200 |

In some embodiments the alkyl glycoside for use in the present invention may be obtained by the reaction of alkanols with glucose or other mono- or di- or polysaccharides. As used herein the term “alkylglycoside” includes an alkyl glucoside, alkylmonoglycoside and an alkylpolyglycoside (sometimes generally referred to as alkyl polysaccharides). Often, alkylglycosides for use in the present invention are alkylpolyglycosides including alkyl polyglucosides obtained by the reaction of glucose with a straight or branched chain alkanol or mixture of alkanols, for example a mixture of alkanols containing 7 to 18, commonly, 7 to 16 carbon atoms, for example 8 to 10 carbon atoms. The number of glycose groups per alkyl group in the molecule may vary and alkyl mono- or di- or polyglucose or saccharide derivatives are possible. Commercial alkylpolyglucosides usually contain a mixture of derivatives having an average number of glycose groups per alkyl group. Thus, alkylglycosides have the general formula (III)

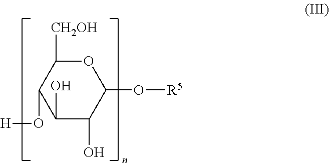

Wherein, n is the degree of polymerisation and is typically within the range from 1 to 3, for example from 1 to 2, and R⁵ is a branched or straight chain alkyl group having from 4 to 18 carbon atoms or a mixture of alkyl groups having an average value within the given range. Typical of alkylglycosides is the product commercially available under the trade names AL2042 (Imperial Chemical Industries PLC) and AGRIMUL® PG2067 (Henkel Corp) wherein n is an average of 1.7 and R⁵ is a mixture of octyl (45%) and decyl (55%), the product commercially available under the trade name AGRIMUL® PG2069 (Henkel Corp) wherein n is an average of 1.6 and R⁵ is a mixture of nonyl (20%), decyl (40%) and undecyl (40%) and the product commercially available under the trade name BEROL® AG6202 (Nouryon, previously, Akzo Nobel) which is 2-ethyl-1-hexylglycoside.

Exemplified APG, Glucopon® 650 EC is apparently an aqueous solution of alkyl polyglucosides based on natural fatty alcohol C₈-C₁₆ and specifically an aqueous solution comprising, D-Glucopyranose, oligomeric, C₁₀-₁₆-alkyl glycosides 25-<50% D-Glucopyranose, oligomeric, decyl octyl glycosides 20-<25%, NaOH 0.3-1%, water ~48%.

In general, exemplified are, aqueous solutions based on: D-Glucopyranose, oligomeric, C₁₀₋₁₆-alkyl glucopyranose, oligomeric, C₈₋₁₀-alkyl glycosides.

Exemplified Agnique® PG 8107-BL is an APG product reported to be C₈₋₁₀ alkyl polyglycoside (D.P.=1.7) containing ~70% active content.

In several experiments the alkyl polyglucosides/alkyl polyglycosides components were found to play a notably useful additional role. While it was found possible to prepare apparently acceptable concentrated Oil-Based Pymetrozine dispersion compositions without this ingredient class they were noted to be difficult to disperse in water especially after a period of storage. Additionally, those experimental samples which did not include alkyl polyglucosides/alkyl polyglycosides were found to particularly sensitive to water content during compounding and more than a minimum amount of water added caused solidification. In contrast samples comprising alkyl polyglucosides/alkyl polyglycosides were much easier to disperse in water. Even more surprising, the use of alkyl polyglucosides (APG) as aqueous solutions in compounding the inventive Oil-Based Pymetrozine Dispersions (OBPD) did not result in the damaging effects seen in experiments where equivalent or even lower amounts of water were introduced.

Perhaps most surprisingly, in addition to this experimentally observed “protection” effect by APG from the heretofore compounding difficulties encountered with water content in OBPD concentrated compositions, an actual positive effect was found when later dispersing the Oil-Based Pymetrozine Dispersion concentrates in water to form diluted end-use pesticide application liquids.

In all events, it would appear that surprisingly despite the heretofore encountered doubts of researchers in this field, Inventors note that it may be that choosing an APG in the form of an aqueous liquid or water solution, not only will not “damage” the characteristics and manufacturability of OBPD concentrates, but may plausibly be of some considerable benefit, both during manufacture and stability during storage and also, the ease with which the OBPD can be diluted and dispersed after periods of storage.

Further, inventors have discovered that in some embodiments the combination of APG together with anionic co-surfactants in compounding the OBPD concentrates most noticeably (so far), from the phosphate/phosphonate (alkylphosphonic acid (RPO(OH)₂) or esters of the same), and sulphate/sulphonate types of surfactant, has further positive effects.

It is even possible that the interaction between the exemplified APG and specific anionic surfactants mediate their combined advantages by their effect on the “freedom” of water molecules in the OBPD. A combination of both Hostaphat 1306 and Ninate 401A has been found notably advantageous.

In all events, it is useful to minimize or entirely exclude the solvents exemplified by any of methanol, ethanol, propanol, isopropanol, butanol, isobutanol, t-butanol, cyclohexanol, 2-Ethyl Hexanol, alkylbenzene, tetrahydrofurfuryl alcohol, ethylene glycol, glycerol, methyl acetate, ethyl acetate, ethyl lactate, butyrolactone, gamma butyrolactone, ethylene carbonate, propylene carbonate, acetonitrile, dimethyl sulphoxide, dimethylformamide, dimethylacetamide, N-methyl-2-pyrrolidone, N-octyl-2-pyrrolidone, N-decyl-2-pyrrolidone, acetone, butanone, methyl isobutyl ketone, methylpropyl ketone, acetophenone, cyclohexanone, methylene chloride, trichloromethane, trichloroethane, tetrahydrofuran, diethylether, 1,2-dimethoxyethane, dioxane, methyl-tert.-butylether, ethanolamine, pyridine, chlorobenzene, toluene, xylene or tetramethylurea.

Inventors stress that in some composition embodiments it is perhaps more important to exclude the aforementioned solvents in order to prepare a useful Oil-Based Pymetrozine dispersion composition than in others, and it is perhaps possible to prepare useful compositions absent one or more of the disclosed classes of component of this embodiment.

Rather, it is often the case that once the improvement afforded by excluding the undesired solvents is achieved, further improvements can be achieved by the choice of each of the classes of components identified as useful, and perhaps optimally improved by a collection of these classes of component.

Alternatively, as discussed herein, the inclusion of several of the components of the inventive composition are able to make the OBPD concentrates less sensitive to the presence of usually damaging solvents than they would be absent the component.

Inventors have determined that a particular sub-set of enhanced advantages are realized when the inventive Oil-based Pymetrozine Dispersion composition comprises the classes of ingredients represented by alkyl polyglucosides/polyglycosides combined with triethethylamine and alkyl phosphates/ethoxylated phosphate esters.

Based on experiments the choice of vegetable-based oil carriers is advantageously selected rather than mineral oil or paraffin, aromatic oils etc. Thus, inventors have expressed a noted advantage for the choice of vegetable oil-based carrier components of the inventive Oil-Based Pymetrozine Dispersion (OBPD), compositions.

While it is possibly feasible to produce fairly acceptable OBPD compositions using mineral oils or paraffin oils, inventors have found that by choosing vegetable oil-based carrier components exemplified by Methyl Soyate instead, the emulsifiers previously required for emulsification of mineral oils or paraffin oils could be reduced or even eliminated, but arguably more importantly as discussed herein, employing methyl Soyate etc. as carrier has the surprising effect of allowing the Pymetrozine compound to be compounded into an Oil-Based Pymetrozine Dispersion concentrate without having to pre-hydrate the Pymetrozine prior to compounding.

The above material provides non-limiting specific examples of each category of advantageous non-insecticidal components (excipients), in embodiments of the inventive Pymetrozine Oil-Based dispersions. However, inventors stress that each of the above mentioned specific ingredients is simply an example. Researchers skilled in the arts of formulating agricultural pesticide dispersions and especially Pymetrozine Oil-Based Dispersions, will immediately recognize that each component can be replaced with alternatives that will perform the same function adequately. Inventors also stress that they do not insist that examples of non-insecticidal formulation aid ingredients mentioned above, namely Atlox® 4914; Hostaphat® 1306; Bentone® SD 3, TEA, Glucopon® 650 EC, and methyl Soyate are the best species or optimum specific ingredients, but rather they provide a clear guidance to researchers skilled in these arts, of the classes of advantageous ingredient.

Simply as an (non-limiting), example, tridecyl polyglycol ether (3EO) phosphate, sold as Servoxyl® VPDZ 3/100, in certain circumstances may be an alternative to the above mentioned Hostaphat® 1306. Whether one ingredient example is preferred over another example of that same class of ingredient will often depend on the identity of the other chosen excipients and/or additional pesticidal ingredient, and the preferred choice is well within the skills of a formulation scientist. In another example, in particular circumstances the organic derivative of a hectorite clay mentioned above is known to be a useful Rheological additive, researchers may clearly find that this ingredient may be replaced or augmented by Fumed Silica products exemplified by AEROSIL® R972.

Researchers may well find that an anionic tristyrylphenol sulfate surfactant such as the anionic tristyrylphenol sulfate surfactant exemplified by the ammonia salt, Soprophor® 4D/384, may be a useful dispersive additive to replace one of those exemplified or simply added to complement the dispersive capability.

Several embodiments of the invention provide Pymetrozine Oil-Based Dispersion compositions which comprise a further pesticide without departing from the scope of the invention, notably though not limited to, an insecticide. Model exemplified additional pesticide molecules may include flonicamid.

In yet another embodiment, the present invention provides a (non-limiting), exemplified process for the preparation of insecticidal vegetable Oil Based Pymetrozine dispersion composition, wherein the process comprising steps of:
(a) charging vegetable oil-based adjuvant in a vessel equipped with e.g., high shear disperser, and stirring followed by heating to e.g., 45-50° C.,
(b) charging dispersing agent and emulsifiers,
(c) charging rheology modifier under stirring for e.g., 30 min, and apply high shear,
(d) adding Pymetrozine (and optionally other pesticide(s)) to the obtained homogenized solution under continuous stirring, and apply High Shear
(e) milling the obtained mixture till the desired particle size distribution is achieved and optionally cooling the contents to room temperature if required, and
(f) packaging the obtained oil dispersion into suitable containers.

A suitable storage container will typically be impermeable to light and moisture.

In yet another embodiment, the present invention provides an exemplary (though non-limiting), process for the preparation of insecticidal Pymetrozine oil-based dispersion compositions, wherein the process comprising steps of:
(a) charging vegetable-based oil in a vessel equipped with stirring means and start stirring optionally followed by heating to e.g., 40-45° C. The vessel is advantageously equipped with high shear disperser as the stirring means.
(b) charging alkyl phosphates/alkoxylated phosphate esters, emulsifier and stirring the mixture for hominization,
(c) optionally, charging fumed silica and/or organic derivative of a hectorite clay (Rheology modifier), under stirring, e.g., for 30 min, and apply high shear,
(d) adding Pymetrozine to the obtained homogenized solution, under continuous stirring and apply high shear,
(e) milling the obtained mixture till the desired particle size distribution is achieved and cooling the contents to room temperature if required,
(f) continue stirring at room temperature e.g., over a period of 2 hours, and
(g) packaging the obtained oil dispersion into suitable storage container(s) e.g., into drums or into commercial retail containers e.g., bottles, cans etc.
A suitable storage container will typically be impermeable to light and moisture.

In yet another embodiment, the present invention provides a process for the preparation of insecticidal oil dispersion composition, wherein the process comprising steps of:
(a) charging vegetable oil-based carrier in a high shear disperser and start stirring followed by heating to e.g., 40-45° C.
(b) charging alkyl phosphates/ethoxylated phosphate esters, ethoxylated alcohols/copolymers of α-olefin with ethylene glycol, and stirring the mixture for hominization,
(c) optionally, charging fumed silica and/or organic derivative of a hectorite clay under stirring, under stirring, and apply high shear,
(d) adding Pymetrozine to the obtained homogenized solution under continuous stirring, and apply high shear,
(e) milling the obtained mixture until the desired particle size distribution is achieved and cooling the contents to room temperature if required,
(f) continue stirring at room temperature over a period of e.g., 2 hours, and
(h) packaging the obtained oil dispersion into suitable storage container(s) e.g., into drums or into commercial retail containers e.g., bottles, cans etc..

A suitable storage container will typically be impermeable to light and moisture.

In some noted embodiments a suitable container used to package the OBPD compositions will be impermeable to moisture, such that the % water content of the contained OBPD does not increase by more than 1% w/w after a period of storage in the container at elevated temperatures and humidity, exemplified by 54° C. and 40° C./75% RH.

For a significant number of embodiments, a container suitable for packaging the Oil-Based Pymetrozine Dispersion concentrates of the invention should be sufficiently impermeable to light such that the Pymetrozine content is not degraded by more than 5% w/w when stored exposed to sunlight or artificial light with wavelengths between 250 to 400 nm.

### DETAILED DESCRIPTION OF THE INVENTION

The term “comprising”, which is synonymous with “including”, “containing”, or “characterized by” here is defined as being inclusive or open-ended, and does not exclude additional, unrecited elements or method steps, unless the context clearly requires otherwise.

The present invention provides a composition of insecticidal oil dispersion comprising Pymetrozine, one or more dispersing agents, one or more emulsifiers, one or more rheology modifiers and one or more, advantageously vegetable-based, oil adjuvants.

One embodiment of the present invention provides a composition of insecticidal oil-based dispersion comprising Pymetrozine, alkyl phosphates/ethoxylated phosphate esters, triethethylamine, alkyl polyglucosides/polyglycosides, organic derivative of a hectorite clay, and methyl Soyate oil.

One embodiment of the present invention provides a composition of insecticidal oil dispersion comprising Pymetrozine, alkyl phosphates/ethoxylated phosphate esters, triethethylamine, alkyl polyglucosides/polyglycosides, organic derivative of a hectorite clay, and methyl Soyate oil and a polymeric surfactant of agricultural use in which the hydrophilic portion is PEG and the hydrophobic portion is alkyd resin.

One embodiment of the present invention provides a composition of insecticidal oil dispersion comprising Pymetrozine, alkyl phosphates/ethoxylated phosphate esters, triethethylamine, alkyl polyglucosides/polyglycosides, organic derivative of a hectorite clay, and methyl soyate oil and a polymeric surfactant of agricultural use which is based on ethoxylated oxo-alcohols.

The present invention also relates in many of the embodiments to Pymetrozine oil-based dispersion compositions which have minimized content or are free of solvents exemplified by any of methanol, ethanol, propanol, isopropanol, butanol, isobutanol, t-butanol, cyclohexanol, 2-Ethyl Hexanol, alkylbenzene, tetrahydrofurfuryl alcohol, ethylene glycol, glycerol, methyl acetate, ethyl acetate, ethyl lactate, butyrolactone, gamma butyrolactone, ethylene carbonate, propylene carbonate, acetonitrile, dimethyl sulphoxide, dimethylformamide, dimethylacetamide, N-methyl-2-pyrrolidone, N-octyl-2-pyrrolidone, N-decyl-2-pyrrolidone, acetone, butanone, methyl isobutyl ketone, methylpropyl ketone, acetophenone, cyclohexanone, methylene chloride, trichloromethane, trichloroethane, tetrahydrofuran, diethylether, 1,2-dimethoxyethane, dioxane, methyl-tert.-butylether, ethanolamine, pyridine, chlorobenzene, toluene, xylene or tetramethylurea.

The present invention also relates to Pymetrozine oil-based dispersion compositions that include in addition to Pymetrozine insecticide, at least one, though typically, a combination, of alkyl phosphates/ethoxylated phosphate esters, triethethylamine, alkyl polyglucosides/polyglycosides, ethoxylated oxo-alcohols/PEG-alkyd resin copolymer; organic derivative of a hectorite clay and/or fumed silica; and methyl Soyate oil.

In general, an oil dispersion (OD) formulation is a solid active ingredient dispersed in oil. The oil can vary from paraffinic to aromatic solvent types and vegetable oil or methylated seed oils. Ideally the active ingredient is uniformly suspended in the oil phase. In the current invention, vegetable oil or methylated seed oils are found to have distinct advantages over paraffinic and aromatic carrier types Insecticidal agent used in the composition of the present invention includes Pymetrozine. The addition of another pesticidally active component is clearly envisioned by inventors and entirely within the scope of this invention. Clearly the addition of additional excipients to increase the compatibility of all components of the inventive Oil-Based Pymetrozine Dispersion compositions, in no way detracts from the scope envisioned.

The concentration of Pymetrozine used in the Oil-Based Pymetrozine Dispersion is from greater than 0% and equal or less than 40% (w/w), often it is from 5% to 35% (w/w), and notably from 10% to 32% (w/w). Typically used concentration of Pymetrozine is from 15% to 26% (w/w) of the total weight of the composition. Inventors have exemplified many of the inventive compositions comprising high load pesticide content including Pymetrozine content of about 20% and above, as being non-limiting while clearly representative of the entire breadth of the disclosed range of content, rather than any indication that the invention should be in any way so limited.

Dispersing agent used in the composition of the present invention includes but not limited to ethylene oxide-propylene oxide block polymers, alkylphenol polyglycol ethers, phosphated or sulphated derivatives of tristyrylphenol polyglycol ethers, these, calcium alkyl benzene sulphonate CALSOGEN® n-C₁₂-alkyl benzene sulfonate calcium salt phosphate ester (SOPHROPHOR® FLR), n-C₁₂ alkyl benzene sulfonate calcium salt, n-C₁₂ alkyl benzene sulfonate calcium salt (PHENYLSULFONAT® CAL) and calcium dodecyl benzene sulphonated (RHODOCAL® 60 BER) alkyl phosphates, alkoxylated phosphate esters

In some embodiments the concentration of dispersing agent used in the Oil-Based Pymetrozine Dispersion is from 1% to 10% (w/w). In some embodiments used concentration of dispersing agent is 3% to 8% of the total weight of the composition.

In some embodiments the emulsifier used in the composition of the present invention includes but not limited to nonionic, anionic, cationic and amphoteric emulsifiers, or a blend of two or more emulsifiers. In some embodiments, used emulsifiers include aliphatic amine alkoxylates, polyoxyethyleneglycerol fatty acid esters, castor oil alkoxylates, fatty acid alkoxylates, fatty acid poly-diethanolamides, lanolin ethoxylates, fatty acid polyglycol esters, isoforms tridecyl alcohol, alkyl polyglycosides, castor oil ethoxylate with 36 mole EO (EMULSOGEN® 360), castor oil ethoxylate with 36 mole EO (ATLOX® 4853B), tri-sec-butylphenol polyglycol ether with 4 EO (SAPOGENAT® T 040), ethoxylate of alkyl polyethylene glycol ether (LUTENSOL® TO 5), or combinations thereof.

In some embodiments the concentration of emulsifiers used in the Oil-Based Pymetrozine Dispersion is from 1% to 20% (w/w). Typically used concentration of emulsifiers is 1% to 10% (w/w).

Rheology modifiers useful in the compositions of the present invention includes but not limited to organic derivative of a hectorite clay (such as BENTONE® 38, BENTONE® 27, BENTONE® 1000, BENTONE® SD-3), vegetable oil derivatives such as blend of vegetable oil base (SURFOM® ESP 8105), and the fumed (or colloidal), silicas such as AEROSIL® R974, AEROSIL® 200, AEROSIL® 972, AEROSIL® R816, AEROSIL® 300 etc. Noted rheology modifiers are exemplified though not limited to, BENTONE® SD-3, BENTONE® 38, BENTONE® 27, BENTONE® 1000, AEROSIL® R-816, AEROSIL® 200, AEROSIL® 300, AEROSIL® R-816 AND AEROSIL® R-972.

Further rheology modifiers are envisioned by inventors and they have devised a simple protocol for selecting rheology agents that are tailored to the particular embodiment of the inventive Oil-Based Pymetrozine Dispersion concentrate composition.

Often the choice of Oil-Based Carrier (or solvent) for the OBPD concentrate will be determinative at least for the initial screening of candidate rheology modifier types/grades, thus, pure solvent/carriers may be used for initial screening. Additionally, the amount and method by which the candidate rheology modifier is incorporated into the OBPD may be usefully determined using inventive OBPD composition embodiments that would benefit from further optimization.

### Protocol/Methodology:

1: Identify relevant rheology modifier candidates
2: Select carrier model systems per solvent for initial screening and useful % content,
3: Select OBPD composition model(s) requiring stability optimization by rheology,
4: For each screened rheology modifier determine experimentally, the optimum method for incorporation into the model OBPD composition using the % content determined during screening carrier model systems, based on desired viscosity and rheology profile,
5: optimize the % content of the chosen rheology modifier for actual OBPD concentrates, by comparing stability results from each experiment to desired specifications.

See below various examples of rheology candidates, their chemical class, and methods of incorporation.

| Trade name | Chemical nature | Incorporation |
|---|---|---|
| Thixatrol ® | Diamide wax mixture | Disperse at elevated |
| Plus | N,N′-ethane-1,2-diylbis(decanamide); / | temperature before |
| | 12-hydroxy-N-[2-[1- | adding Pymetrozine |
| | oxydecyl)amino]ethyl]octadecanamide; / | tech |
| | N,N′-ethane-1,2-diylbis(12- | |
| | hydroxyoctadecanamide) | |
| Thixatrol ® | polyamide wax paste (20% active) in Xylene | Disperse at elevated |
| 220X | fatty acid amide wax pre-swollen into | temperature before |
| | xylene | adding Pymetrozine |
| | | tech |
| Crayvallac ® | Micronized | During milling (aided |
| MT | Amide Modified Hydrogenated Castor Oil | by the generated |
| | Rheology Modifier | heating) |
| Crayvallac ® | modified micronized hydrogenated castor | During milling (aided |
| PF | oil rheology modifier | by the generated |
| | | heating) |
| BYK-431 | Solution of a high molecular weight, urea- | During milling (aided |
| Rheobyk-431 | modified, non-polar polyamide | by the |
| | | generated |
| | | heating) |
| Rheobyk-405 | Solution of polyhydroxycarboxylic acid | works together with |
| | amides | fumed silica, to be |
| | | added together |
| Rheobyk- | Solution of a modified urea | before or after |
| 7411ES | | milling, with moderate |
| | | stirring |
| Rheobyk 100 | Castor oil derivative | Disperse at elevated |
| | | temperature before |
| | | adding tech |
| EFKA RM 1920 | Hydrogenated castor oil | During milling - as a |
| | | pre-gel (20-30% |
| EFKA RM 1965 | Over based calcium sulfate complex | Dluring milling |
| Bentone ® | Hectorite clay | During milling or post |
| SD- 3 | | milling with high |
| | | shear |

The concentration of rheology modifiers used in the insecticidal oil dispersion is from 0.1% to 5% (w/w). typically used concentration of rheology modifiers 0.1% to 1% of the total weight of the composition.

Oil adjuvant used in the composition of the present invention includes but not limited to methyl soyate oil, rapeseed oil, olive oil, castor oil, rape oil, corn oil, cottonseed oil, sunflower oil, palm methyl ester oil. While choice of oil adjuvant is broad and could theoretically include mineral oil or paraffin oil, Inventors note that use of methyl soyate, alkyl esters of rape seed oil, sunflower oil, palm methyl ester oil, etc., allowed the Pymetrozine active ingredient to be efficiently incorporated in the OBPD without the need for prior pre-hydration. In some high load embodiments this can be advantageous, and formulators may choose to avoid the use of mineral oil or paraffin oil in preparing these compositions.

The concentration of oil adjuvant (Oil-based Carrier) used in the insecticidal oil dispersion (OBPD), is from 15% to 90% more commonly from 40% to 80% (w/w). More typically the used concentration of Oily Carrier is from about 45% to 70% (w/w) of the total weight of the composition, although several exemplified embodiments contained between 50% and 65% w/w of Oily Carrier.

The present invention is to provide a composition of Pymetrozine oil dispersion with saves operational cost by industrially and economically feasible process combining easy compounding of stable, non-viscous OD concentrate that displays and maintains high dispersibility in water and maintains that level of dispersibility after extended storage even at elevated temperatures.

The present invention is to provide process for the preparation of Oil-Based Pymetrozine Dispersion compositions comprising the steps of adding, stirring, milling, collecting, homogenizing, and packaging. However as will be further expanded, advanced optimization of the order in which some non-insecticidal formulation aids (NIFA), are incorporated into the OBPD can have notable effects.

In noted embodiments, when sulphate/sulphonate based NIFAs exemplified by branched Alkylbenzene Sulfonate (Calcium Salt), were added to OBPD embodiments which had already been optimized with phosphate/phosphonate NIFAs, and incorporated after all other ingredients have been milled and homogenized, unforeseen further advantages were realized. The dispersibility in water while previously uncomplicated and physically stable, now the dispersibility was found similar to that of emulsifiable concentrates, and the OBPD itself was itself further stabilized as regards separation beyond the previously acceptable levels.

The following non-exhaustive, examples describe the nature of the invention and are given only for the purpose of illustrating the present invention in more detail and are not limitative and relate to solutions, which have been particularly effective on bench scale addressing one or more challenges.

As previously mentioned, formulating Oil-Based Pymetrozine Dispersion (OBPD) compositions presents multiple challenges, at the compounding stage; in the quality evaluation, in the storage stability characteristics; and further challenges when the composition is an oil-based, dispersion and further challenges present themselves when the oil-based dispersion is a concentrate intended to be dispersed in aqueous media (water) prior to its end-use application, which requires ease of dispersibility after storage.

In the following non-limiting examples various compositions are presented and often compared and contrasted with other sample compositions herein presented.

Inventors wish to stress that other than a limited number of comparative examples, the exemplified compositions are not either “good” or “bad” but rather, identify a progression spectrum whereby, several compositions have overcome a limited number of formulation challenges and other exemplified compositions have performed better and have overcome a multitude of challenges.

Inventors do not limit the scope of their invention to only the most optimum of the exemplified compositions, but rather inventors wish to stress the success of each individual solution to each one of the aforementioned challenges while acknowledging that those compositions overcoming many or all the difficulties associated with formulating Pymetrozine Oil-Based dispersions are clearly considered more optimized than the inventive compositions where the level of success is not as striking.

### Formulation A—General

| Materials | CAS/Identity | % w/w |
|---|---|---|
| Pymetrozine | 123312-89-0 | 20 |
| Span 20 | 1338-39-2 | |
| | Sorbitan laurate, Sorbitan monolaurate | |
| Crodafos | 9046-01-9 | |
| T5A | Trideceth-5 Phosphate | |
| | Branched alcohol (iso-C₁₃), 5 EO | |
| Imbentin | branched oxo alcohols C₁₁, ethoxylated with | |
| U/050 | 5 mol EO (Undeceth-5) | |
| | Alkoxylated fatty alcohols/Ethoxylated fatty | |
| | alcohols | |
| | 69011-36-5 | |
| | Isotridecyl alcohol, ethoxylated (9043-30-5) | |
| AEROSIL | 112926-00-8 | |
| R972 | hydrophobic fumed silica treated with dichloro | |
| | dimethyl silane | |
| Bentone ® | organic derivative of a smectite clay (hectorite) | |
| SD- 3 | | |
| oil | | To 100% |
| | TOTAL | 100 |

### Formulation A1—Hydrotreated Light Paraffinic Petroleum Distillates Carrier

| Materials | CAS/Identity | % w/w |
|---|---|---|
| Pymetrozine | 123312-89-0 Pre-hydrated Pymetrozine (84:16) | ~24 |
| Span 20 | 1338-39-2 Sorbitan laurate, Sorbitan | 2 |
| | monolaurate | |
| Crodafos | 9046-01-9 Trideceth-5 Phosphate Branched | 5 |
| T5A | alcohol (iso-C₁₃), 5 EO | |
| Imbentin | branched oxoalcohols C₁₁, ethoxylated with 5 | 5 |
| U/050 | mol EO (Undeceth-5) | |
| | alkoxylated fatty alcohols/Ethoxylated fatty | |
| | alcohols CAS | |
| | 69011-36-5 | |
| | Isotridecyl alcohol, ethoxylated (9043-30-5) | |
| AEROSIL | 112926-00-8 | 1 |
| R972 | hydrophobic fumed silica treated with dichloro | |
| | dimethyl silane | |
| Bentone ® | organic derivative of a smectite clay (hectorite) | 1 |
| SD- 3 | | |
| SK Oil | 64742-55-8 Hydrotreated Light Paraffinic | To 100% |
| | Petroleum Distillates | |
| | TOTAL | 100 |

When using less preferred paraffinic type carrier, it was necessary to pre-hydrate the Pymetrozine before compounding could commence. Pre-hydration of the Pymetrozine before incorporation is not ideal from the point of view of production and it is not preferred and as it was found necessary to use ~16% water leaving a low amount of oil that could be incorporated into the dispersion. The dispersion composition was also not ideal from the point of view of appearance and physical attributes including sedimentation, paste formation, and end-use dispersion in water, both at the compounding stage but also during stability despite the pre-hydration.

### Formulation A2—Methyl Soyate Carrier

When using Vegetable Oil derivative as carrier, it was not necessary to pre-hydrate the Pymetrozine before compounding could commence. However even though this issue is solved the composition can be improved even further by e.g., selecting non-insecticidal formulation aids that have greater compatibility with methyl Soyate than with the replaced paraffin-based carrier.

| Materials | CAS/Identity | % w/w |
|---|---|---|
| Pymetrozine | 123312-89-0 | 20 |
| Span 20 | 1338-39-2 Sorbitan laurate, Sorbitan | 2 |
| | monolaurate | |
| Crodafos | 9046-01-9 Trideceth-5 Phosphate branched | 5 |
| T5A | alcohol (iso-C₁₃) , 5 EO | |
| Imbentin | branched oxo alcohols C₁₁, ethoxylated with 5 | 5 |
| U/050 | mol EO (Undeceth-5) | |
| | alkoxylated fatty alcohols/Ethoxylated fatty | |
| | alcohols (69011-36-5) | |
| | isotridecyl alcohol, ethoxylated (9043-30-5) | |
| AEROSIL | 112926-00-8 | 1 |
| R972 | hydrophobic fumed silica treated with dichloro | |
| | dimethyl silane | |
| Bentone ® | organic derivative of a smectite clay | 1 |
| SD- 3 | (hectorite) | |
| Methyl | 67784-80-9/68919-53-9/67762-38-3 | To 100% |
| Soyate | Soybean oil acids methyl ester | |
| TOTAL | | 100 |

Formulation A3—Methyl Soyate Carrier & Combination with Flonicamid

| Materials | CAS/Identity | % w/w |
|---|---|---|
| Pymetrozine | 123312-89-0 | 20 |
| flonicamid | 158062-67-0 | 10 |
| Span 20 | 1338-39-2 | 2 |
| | Sorbitan laurate, Sorbitan monolaurate | |
| Crodafos | 9046-01-9 Trideceth-5 Phosphate Branched | 5 |
| T5A | alcohol (iso-C₁₃), 5 EO | |
| IMBENTIN | branched oxoalcohols C₁₁, ethoxylated with 5 | 5 |
| U/050 | mol EO | |
| | Alkoxylated fatty alcohols/Ethoxylated fatty | |
| | alcohols | |
| | Cas 69011-36-5 Isotridecyl alcohol, | |
| | ethoxylated (9043-30-5) | |
| AEROSIL | 112926-00-8 | 1 |
| R972 | hydrophobic fumed silica treated with | |
| | Dichlordimethylsilane | |
| Bentone ® | organic derivative of a smectite clay | 1 |
| SD- 3 | (hectorite) | |
| Methyl | 67784-80-9/68919-53-9/67762-38-3 | 56 |
| Soyate | Soybean oil acids methyl ester | |
| | TOTAL | 100 |

### Formulation B—General

| Materials | CAS/Identity | % w/w |
|---|---|---|
| Pymetrozine | 123312-89-0 | 20 |
| Span 20 | 1338-39-2 Sorbitan laurate, Sorbitan | |
| | monolaurate | |
| Rhodafac ® | 9046-01-9 Anionic polyoxyethylene tridecyl | |
| RS 610 | phosphate ester | |
| | 2-tridecoxyethyl dihydrogen phosphate | |
| Imbentin | branched oxoalcohols C₁₁, ethoxylated with 5 | |
| U/050 | mol EO (Undeceth-5) | |
| | Alkoxylated fatty alcohols/ethoxylated | |
| | fatty alcohols Cas 69011-36-5 | |
| | Isotridecyl alcohol, ethoxylated (9043-30-5) | |
| AEROSIL | 112926-00-8 | |
| R972 | hydrophobic fumed silica treated with | |
| | Dichlordimethylsilane | |
| Bentone ® | organic derivative of a smectite clay | |
| SD- 3 | (hectorite) | |
| Oil | | To 100 |
| | TOTAL | 100 |

### Formulation E1—Hydrotreated Light Paraffinic Petroleum Distillates Carrier

| Materials | CAS/Identity | % w/w |
|---|---|---|
| Pymetrozine | 123312-89-0 Pre-hydrated Pymetrozine | ~24 |
| | Pymetrozine /water = ~84:16 | |
| Span 20 | 1338-39-2 | 2 |
| | Sorbitan laurate, Sorbitan monolaurate | |
| Rhodafac ® | 9046-01-9 | 5 |
| RS 610 | Anionic polyoxyethylene tridecyl phosphate | |
| | ester | |
| | 2-tridecoxyethyl dihydrogen phosphate | |
| Imbentin | branched oxo alcohols C₁₁, ethoxylated with 5 | 5 |
| U/050 | mol EO (Undeceth-5) | |
| | Alkoxylated fatty alcohols/Ethoxylated fatty | |
| | alcohols Cas 69011-36-5 | |
| | Isotridecyl alcohol, ethoxylated (9043-30-5) | |
| AEROSIL | 112926-00-8 | 1 |
| R972 | hydrophobic fumed silica treated with | |
| | Dichlordimethylsilane | |
| Bentone ® | organic derivative of a smectite clay | 1 |
| SD- 3 | (hectorite) | |
| SK Oil | 64742-55-8 Hydrotreated Light Paraffinic | To 100 |
| | Petroleum Distillates | |
| | TOTAL | 100 |

When using Paraffinic type carrier, it was necessary to pre-hydrate the Pymetrozine before compounding could commence. Pre-hydration of the Pymetrozine before incorporation is not ideal from the point of view of production and it is not preferred and as it was found necessary to use ~16% water leaving a low amount of oil that could be incorporated into the dispersion. The dispersion composition was also not ideal from the point of view of appearance and physical attributes including sedimentation, paste formation, both at the compounding stage but also during stability despite the pre-hydration.

### Formulation B2—Methyl Soyate Carrier

When using Vegetable Oil derivative as carrier, it is not necessary to pre-hydrate the Pymetrozine before compounding can commence. However even though this issue is solved, the composition can be improved even further by e.g., selecting non-insecticidal formulation aids that have greater compatibility with methyl Soyate than with the replaced paraffin-based carrier.

| Materials | CAS/Identity | % w/w |
|---|---|---|
| Pymetrozine | 123312-89-0 | 20 |
| Span 20 | 1338-39-2 | 2 |
| | Sorbitan laurate, Sorbitan monolaurate | |
| Rhodafac ® | 9046-01-9 | 5 |
| RS 610 | Anionic polyoxyethylene tridecyl phosphate | |
| | ester | |
| | 2-tridecoxyethyl dihydrogen phosphate | |
| Imbentin | branched oxoalcohols C₁₁, ethoxylated with 5 | 5 |
| U/050 | mol EO (Undeceth-5) | |
| | Alkoxylated fatty alcohols/Ethoxylated fatty | |
| | alcohols Cas 69011-36-5 | |
| | Isotridecyl alcohol, ethoxylated (9043-30-5) | |
| AEROSIL | 112926-00-8 | 1 |
| R972 | hydrophobic fumed silica treated with | |
| | Dichlordimethylsilane | |
| Bentone ® | organic derivative of a smectite clay | 1 |
| SD- 3 | (hectorite) | |
| Methyl | 67784-80-9/68919-53-9/67762-38-3 | To 100 |
| Soyate | Soybean oil acids methyl ester | |
| | TOTAL | 100 |

Formulation B3—Methyl Soyate Carrier & Combination with Flonicamid

| Materials | CAS/Identity | % w/w |
|---|---|---|
| Pymetrozine | 123312-89-0 | 20 |
| flonicamid | 158062-67-0 | 10 |
| Span 20 | 1338-39-2 Sorbitan laurate, Sorbitan monolaurate | 2 |
| Rhodafac ® | 9046-01-9 Anionic polyoxyethylene tridecyl | 5 |
| RS 610 | phosphate ester | |
| | 2-tridecoxyethyl dihydrogen phosphate | |
| Imbentin | branched oxo alcohols C₁₁, ethoxylated with | 5 |
| U/050 | 5 mol EO (Undeceth-5) | |
| | Alkoxylated fatty alcohols/Ethoxylated fatty | |
| | alcohols Cas 69011-36-5 | |
| | Isotridecyl alcohol, ethoxylated (9043-30-5) | |
| AEROSIL | 112926-00-8 | 1 |
| R972 | hydrophobic fumed silica treated with | |
| | Dichlordimethylsilane | |
| Bentone SD3 | organic derivative of a smectite clay (hectorite) | 1 |
| Methyl | 67784-80-9/68919-53-9/67762-38-3 | 56 |
| Soyate | Soybean oil acids methyl ester | |
| | TOTAL | 100 |

### Formulation D—General

| Materials | CAS/Identity | % w/w |
|---|---|---|
| Pymetrozine | Active Ingredient | 20 |
| Span 20 | 1338-39-2 Sorbitan laurate, Sorbitan | |
| | monolaurate | |
| Soprophor | Tristyrylphenol ether sulfate, ammonium salt | |
| 4D/384 | | |
| Imbentin | branched oxoalcohols C₁₁, ethoxylated with 5 | |
| U/050 | mol EO (Undeceth-5) | |
| | Alkoxylated fatty alcohols/Ethoxylated fatty | |
| | alcohols Cas 69011-36-5 | |
| | Isotridecyl alcohol, ethoxylated (9043-30-5) | |
| AEROSIL | 112926-00-8hydrophobic fumed silica treated | |
| R972 | with Dichlordimethylsilane | |
| Bentone ® | organic derivative of a smectite clay | |
| SD- 3 | (hectorite) | |
| Oil | | To 100 |
| | TOTAL | 100 |

### Formulation D1—Hydrotreated Light Paraffinic Petroleum Distillates

| Materials | CAS/Identity | % ww |
|---|---|---|
| Pymetrozine | 123312-89-0 Pre-hydrated Pymetrozine | ~24 |
| | Pymetrozine/water = ~84:16 | |
| Span 20 | 1338-39-2 Sorbitan laurate, Sorbitan | 2 |
| | monolaurate | |
| Soprophor | Tristyrylphenol ether sulfate, ammonium salt | 5 |
| 4D/384 | | |
| Imbentin U/050 | branched oxoalcohols C₁₁, ethoxylated with 5 | 5 |
| | mol EC (Undeceth-5) | |
| | Alkoxylated fatty alcohols/Ethoxylated fatty | |
| | alcohols CAS 69011-36-5 | |
| | Isotridecyl alcohol, ethoxylated (9043-30-5) | |
| AEROSIL | 112926-00-8 | 1 |
| R972 | hydrophobic fumed silica treated with | |
| | Dichlordimethylsilane | |
| Bentone ® | organic derivative of a smectite clay | 1 |
| SD- 3 | (hectorite) | |
| SK Oil | | To 100 |
| | TOTAL | 100 |

When using Paraffinic type carrier, it was necessary to pre-hydrate the Pymetrozine before compounding could commence. Pre-hydration of the Pymetrozine before incorporation is not ideal from the point of view of production and it is not preferred and as it was found necessary to use ~16% water leaving a low amount of oil that could be incorporated into the dispersion. The dispersion composition was also not ideal from the point of view of appearance and physical attributes including sedimentation, paste formation, both at the compounding stage but also during stability despite the pre-hydration.

### Formulation D2—Methyl Soyate Carrier

When using Vegetable Oil derivative, such as methyl soyate, as carrier, it is not necessary to pre-hydrate the Pymetrozine before compounding can commence. However, even though this issue is solved the composition can be improved even further by e.g., selecting non-insecticidal formulation aids that have greater compatibility with methyl Soyate than with the replaced paraffin-based carrier.

| Materials | CAS/Identity | % w/w |
|---|---|---|
| Pymetrozine | 123312-89-0 | 20 |
| Span 20 | 1338-39-2 Sorbitan laurate, Sorbitan | 2 |
| | monolaurate | |
| Soprophor | Tristyrylphenol ether sulfate, ammonium salt | 5 |
| 4D/384 | | |
| Imbentin | branched oxoalcohols C₁₁, ethoxylated with 5 | 5 |
| U/050 | mol EO (Undeceth-5) | |
| | Alkoxylated fatty alcohols/Ethoxylated fatty | |
| | alcohols Cas 69011-36-5 | |
| | Isotridecyl alcohol, ethoxylated (9043-30-5) | |
| AEROSIL | 112926-00-8 | 1 |
| R972 | hydrophobic fumed silica treated with | |
| | Dichlordimethylsilane | |
| Bentone ® | organic derivative of a smectite clay | 1 |
| SD- 3 | (hectorite) | |
| Methyl | 67784-80-9/68919-53-9/67762-38-3 | To 100 |
| Soyate | Soybean oil acids methyl ester | |
| | TOTAL | 100 |

Formulation D3—Methyl Soyate Carrier & Combination with Flonicamid

| Materials | CAS/Identity | % ww |
|---|---|---|
| Pymetrozine | 123312-89-0 | 20 |
| flonicamid | Active Ingredient | 10 |
| Span 20 | 1338-39-2 | 2 |
| | Sorbitan laurate, Sorbitan monolaurate | |
| Soprophor | Tristyrylphenol ether sulfate, ammonium salt | 5 |
| 4D/384 | | |
| Imbentin | Undecyl alcohol, ethoxylated | 5 |
| U/050 | ethoxylated, branched C₉₋₁₁ Alcohols, | |
| | Branched oxoalcohols C₁₁, ethoxylated with 5 | |
| | mol EO | |
| AEROSIL | 112926-00-8 | 1 |
| R972 | hydrophobic fumed silica treated with | |
| | Dichlordimethylsilane | |
| Bentone ® | organic derivative of a smectite clay | 1 |
| SD- 3 | (hectorite) | |
| Methyl | 67784-80-9/68919-53-9/67762-38-3 | 56 |
| Soyate | Soybean oil acids methyl ester | |
| | TOTAL | 100 |

### Formulation E—General

| Materials | CAS/Identity | % w/w |
|---|---|---|
| Pymetrozine | 123312-89-0 | 20 |
| Ninate ® | alkyl (C₁₀₋₁₆) Benzenesulfonic acid, | |
| 60 B-E | calcium Salt | |
| | Alkyl Benzene Sulfonates 60-<70% | |
| | Isobutyl Alcohol 30-<40% | |
| Servoxyl ® | Tridecyl Polyglycol ether (3EO) Phosphate | |
| VPDZ 3/100 | | |
| Imbentin ® | Undecyl alcohol, ethoxylated | |
| U/050 | Alcohols, C₉₋₁₁, branched, ethoxylated, | |
| | branched oxoalcohols C11, ethoxylated | |
| | with 5 mol EO | |
| AEROSIL ® | 112926-00-8 | |
| R972 | hydrophobic fumed silica treated with | |
| | Dichlordimethylsilane | |
| OIL | | To 100 |
| | TOTAL | 100 |

### Formulation E1—Distillates (Petroleum), Hydrotreated Light

When using Paraffinic type carrier, it was necessary to pre-hydrate the Pymetrozine before compounding could commence. Pre-hydration of the Pymetrozine before incorporation is not ideal from the point of view of production and it is not preferred and as it was found necessary to use ~16% water leaving a low amount of oil that could be incorporated into the dispersion. The dispersion composition was also not ideal from the point of view of appearance and physical attributes including sedimentation, paste formation, both at the compounding stage but also during stability despite the pre-hydration.

| Materials | CAS/Identity | % ww |
|---|---|---|
| Pymetrozine | 123312-89-0 Pre-hydrated | ~24 |
| | Pymetrozine | |
| | Pymetrozine/water = ~84:16 | |
| Ninate | Alkyl (C₁₀₋₁₆) Benzenesulfonic | 5 |
| 60 B-E | acid, Calcium Salt | |
| | Alkyl Benzene Sulfonates 60-<70% | |
| | Isobutyl Alcohol 30-<40% | |
| Servoxyl | Tridecyl Polyglycol ether (3EO) | 5 |
| VPDZ 3/100 | Phosphate | |
| Imbentin | branched oxoalcohols C₁₁, | 5 |
| U/050 | ethoxylated with 5 mol EO | |
| | (Undeceth-5) | |
| | Alkoxylated fatty | |
| | alcohols/Ethoxylated fatty | |
| | alcohols Cas 69011-36-5 | |
| | Isotridecyl alcohol, ethoxylated | |
| | (9043-30-5) | |
| AEROSIL | 112926-00-8 hydrophobic fumed | 2 |
| R972 | silica treated with | |
| | Dichlordimethylsilane | |
| GADOT | 64742-47-8 Distillates | To 100 |
| D 60 | (petroleum), hydrotreated light | |
| | TOTAL | 100 |

### Formulation E2—Methyl Soyate

When using Vegetable Oil derivative as carrier, it was not necessary to pre-hydrate the Pymetrozine before compounding could commence. However even though this issue is solved the composition can be improved even further by e.g., selecting non-insecticidal formulation aids that have greater compatibility with methyl Soyate than with the replaced paraffin-based carrier.

| Materials | CAS/Identity | % ww |
|---|---|---|
| Pymetrozine | 123312-89-0 | 20 |
| Ninate 60 | Alkyl (C₁₀₋₁₆) Benzenesulfonic acid, Calcium | 5 |
| B-E | Salt | |
| | Alkyl Benzene Sulfonates 60-<70% | |
| | Isobutyl Alcohol 30-<40% | |
| Servoxyl | Tridecyl Polyglycol ether (3EO) Phosphate | 5 |
| VPDZ 3/100 | | |
| Imbentin | branched oxoalcohols C₁₁, ethoxylated with 5 | 5 |
| U/050 | mol EO (Undeceth-5) | |
| | Alkoxylated fatty alcohols/Ethoxylated | |
| | fatty alcohols Cas | |
| | Isotridecyl alcohol, ethoxylated (9043- | |
| | 30-5/69011-36-5) | |
| AEROSIL | 112926-00-8 | 2 |
| R972 | hydrophobic fumed silica treated with | |
| | Dichlordimethylsilane | |
| Methyl | 67784-80-9/68919-53-9/67762-38-3 | To 100 |
| Soyate | Soybean oil acids methyl ester | |
| | TOTAL | 100 |

Formulation E3—Methyl Soyate & Combination with Flonicamid

| Materials | CAS/Identity | % ww |
|---|---|---|
| Pymetrozine | Active Ingredient | 20 |
| flonicamid | Active Ingredient | 10 |
| Ninate 60 | Alkyl (C₁₀₋₁₆) Benzenesulfonic acid, Calcium | 5 |
| B-E | Salt | |
| | Alkyl Benzene Sulfonates 60-<70% | |
| | Isobutyl Alcohol 30-<40% | |
| Servoxyl | Tridecyl Polyglycol ether (3EO) Phosphate | 5 |
| VPDZ 3/100 | | |
| Imbentin | branched oxoalcohols C₁₁, ethoxylated with | 5 |
| U/050 | 5 mol EO (Undeceth-5) | |
| | Alkoxylated fatty alcohols/Ethoxylated | |
| | fatty alcohols Cas | |
| | Isotridecyl alcohol, ethoxylated | |
| | (9043-30-5/69011-36-5) | |
| AEROSIL | 112926-00-8 | 2 |
| R972 | hydrophobic fumed silica treated with | |
| | Dichlordimethylsilane | |
| Methyl | 67784-80-9/68919-53-9/67762-38-3 | 53 |
| Soyate | Soybean oil acids methyl ester | |
| | TOTAL | 100 |

### Formulation F—General

| Materials | CAS/Identity | % ww |
|---|---|---|
| Pymetrozine | Active Ingredient | 20 |
| Ninate 60 | Alkyl (C₁₀₋₁₆) Benzenesulfonic acid, Calcium | |
| B-E | Salt | |
| | Alkyl Benzene Sulfonates 60-<70% | |
| | Isobutyl Alcohol 30-<40% | |
| Servoxyl | Tridecyl Polyglycol ether (3EO) Phosphate | |
| VPDZ 3/100 | | |
| Imbentin | Undecy1 alcohol, ethoxylated, | |
| U/050 | Alcohols, C₉₋₁₁, branched, ethoxylated, | |
| | branched oxo alcohols C₁₁, ethoxylated with | |
| | 5 mol EO | |
| Atlox 4912 | Block Co-Polymer EO-12-hydroxystearic acid | |
| Bentone ® | organic derivative of a smectite clay | |
| SD- 3 | (hectorite) | |
| OIL | | To 100 |
| | TOTAL | 100 |

### Formulation F1—Hydrotreated Middle Distillates (Petroleum)

| Materials | CAS/Identity | % w/w |
|---|---|---|
| Pymetrozine | 123312-89-0 Pre-hydrated | ~24 |
| | Pymetrozine Pymetrozine/water = ~84:16 | |
| Ninate | Alkyl (C₁₀₋₁₆) Benzenesulfonic acid, Calcium | 5 |
| 60 B-E | Salt | |
| | Alkyl Benzene Sulfonates 60-<70% | |
| | Isobutyl Alcohol 30-<40% | |
| Servoxyl | Tridecyl Polyglycol ether (3EO) Phosphate | 5 |
| VPDZ 3/100 | | |
| Imbentin | Undecyl alcohol, ethoxylated, | 5 |
| U/050 | Alcohols, C₉₋₁₁, branched, ethoxylated, | |
| | branched oxoalcohols C₁₁, ethoxylated with | |
| | 5 mol EO | |
| Atlox 4912 | Block Co-Polymer EO-12-hydroxystearic acid | 3 |
| Bentone ® | organic derivative of a smectite clay | 1 |
| SD- 3 | (hectorite) | |
| Isopar V | 64742-46-7 | To 100 |
| | Hydrotreated middle distillates (petroleum) | |
| | TOTAL | 100 |

### Formulation F2—Methyl Soyate

| Materials | CAS/Identity | % w/w |
|---|---|---|
| Pymetrozine | 123312-89-0 | 20 |
| Ninate | Alkyl (C₁₀₋₁₆) Benzenesulfonic acid, Calcium | 5 |
| 60 B-E | Salt | |
| | Alkyl Benzene Sulfonates 60-<70% | |
| | Isobutyl Alcohol 30-<40% | |
| Servoxyl | Tridecyl Polyglycol ether (3EO) Phosphate | 5 |
| VPDZ 3/100 | | |
| Imbentin | Undecyl alcohol, ethoxylated, | 5 |
| U/050 | Alcohols, C₉₋₁₁, branched, ethoxylated, | |
| | branched oxoalcohols C₁₁, ethoxylated with 5 | |
| | mol EO | |
| Atlox 4912 | Block Co-Polymer EO-12-hydroxystearic acid | 3 |
| Bentone ® | organic derivative of a smectite clay | 1 |
| SD- 3 | (hectorite) | |
| Methyl | 67784-80-9/68919-53-9/67762-38-3 | To 100 |
| Soyate | Soybean oil acids methyl ester | |
| | TOTAL | 100 |

Formulation F3—Methyl Soyate & Combination with Flonicamid

| Materials | CAS/Identity | % w/w |
|---|---|---|
| Pymetrozine | 123312-89-0 | 20 |
| flonicamid | Active Ingredient | 10 |
| Ninate 60 | Alkyl (C₁₀₋₁₆) Benzenesulfonic acid, Calcium | 5 |
| B-E | Salt | |
| | Alkyl Benzene Sulfonates 60-<70% | |
| | Isobutyl Alcohol 30-<40% | |
| Servoxyl | Tridecyl Polyglycol ether (3EO) Phosphate | 5 |
| VPDZ 3/100 | | |
| Imbentin | branched oxoalcohols C₁₁, ethoxylated | 5 |
| U/050 | with 5 mol EO (Undeceth-5) | |
| | Alkoxylated fatty alcohols/Ethoxylated | |
| | fatty alcohols | |
| | Isotridecyl alcohol, ethoxylated (9043- | |
| | 30-5/69011-36-5) | |
| Atlox 4912 | Block Co-Polymer | 3 |
| | EO-12-hydroxystearic acid | |
| Bentone ® | organic derivative of a smectite clay | 1 |
| SD- 3 | (hectorite) | |
| Methyl | 67784-80-9/68919-53-9/67762-38-3 | 51 |
| Soyate | Soybean oil acids methyl ester | |
| | TOTAL | 100 |

After the tests, replacing the paraffinic solvents with methylated Seed Oil (Methyl Soyate) was justified if only because it was not necessary to pre-hydrate the Pymetrozine prior to compounding. Further trials to optimize the Oil-based dispersion included the following non-limiting examples

### Formulation AA—Ethoxylated Alkyl Phosphate and Alkoxylated Fatty Alcohol/Acid.

The viscosity became high when stored at 54 C although the composition did not solidify, and was acceptable after shaking, (good) however the dispersibility in water needed further optimization.

### Formulation AA1—Pymetrozine Solo

| Materials | CAS/Identity | % w/w |
|---|---|---|
| Pymetrozine | 123312-89-0 | 20 |
| Servoxyl VPDZ | Tridecyl Polyglycol ether (3EO) | 4 |
| 3/100 | Phosphate | |
| Atlox ® 4914 | 173717-47-0 PEG polyisobutenyl | 3 |
| | anhydride - tall oil fatty acid | |
| | copolymer | |
| Methyl Soyate | 67784-80-9/68919-53-9/67762-38-3 | To 100 |
| | Soybean oil acids methyl ester | |
| Bentone ® SD- 3 | organic derivative of a smectite clay | 2 |
| | (hectorite) | |
| | TOTAL | 100 |

### Formulation AA2—Pymetrozine & Flonicamid

| Materials | CAS/Identity | % ww |
|---|---|---|
| Pymetrozine | Active Ingredient | 20 |
| Flonicamid | Active Ingredient | 10 |
| Servoxyl | Tridecyl Polyglycol ether (3EO) | 4 |
| VPDZ 3/100 | Phosphate | |
| Atlox ® | 173717-47-0 PEG polyisobutenyl | 3 |
| 4914 | anhydride - tall oil fatty acid | |
| | copolymer | |
| Methyl | 67784-80-9/68919-53-9/67762-38-3 | To 100 |
| Soyate | Soybean oil acids methyl ester | |
| Bentone ® | organic derivative of a smectite | 2 |
| SD- 3 | clay (hectorite) | |
| | TOTAL | 100 |

Formulation AA3—PreHydrated Pymetrozine+Mineral/Paraffin type Oil, —Not Optimized

| Materials | CAS/Identity | % w/w |
|---|---|---|
| Pymetrozine | 123312-89-0 Pre-hydrated Pymetrozine | ~24 |
| | Pymetrozine/water = ~84:16 | |
| Servoxyl | Tridecyl Polyglycol ether (3EO) Phosphate | 4 |
| VPDZ 3/100 | | |
| Atlox ® 4914 | 173717-47-0 PEG polyisobutenyl anhydride | 3 |
| | tall oil fatty acid copolymer | |
| Paraffin or | | To 100 |
| Mineral Oil | | |
| Bentone ® | organic derivative of a smectite clay | 2 |
| SD- 3 | (hectorite) | |
| | TOTAL | 100 |

### Formulation BE Ethoxylated Alkyl Phosphate/Alkoxylated Fatty Alcohol PG56T or Acid/APG

Better stability. After storage at 54 C, dispersion still requires 3-4 inversions for full suspension

### Formulation EE1—Pymetrozine Solo

| Materials | CAS/Identity | % ww |
|---|---|---|
| Pymetrozine | 123312-89-0 | 20 |
| Atlox ® | 173717-47-0 PEG polyisobutenyl anhydride - | 5 |
| 4914 | tall oil fatty acid copolymer | |
| Hostaphat ® | lsotridecyl polyoxethyl (6 EO) phosphoric | 4 |
| 1306 | acid mono/diester, acid form | |
| Glucopon ® | D-Glucopyranose, oligomeric, C₁₀-₁₆-alkyl | |
| 650 EC | glycosides 25-<50% | |
| | D-Glucopyranose, oligomeric, decyl octyl | 5 (4.78) |
| | glycosides 20-<25%, NaOH 0.3-1%, water ~48%. | |
| Methyl | 67784-80-9/68919-53-9/67762-38-3 | To 100 |
| soyate | Soybean oil acids methyl ester | |
| | TOTAL | 100 |

### Formulation BB2—Pymetrozine & Flonicamid

| Materials | CAS/Identity | % w/w |
|---|---|---|
| Pymetrozine | 123312-89-0 | 20 |
| Flonicamid | 158062-67-0 | 10 |
| Atlox ® | 173717-47-0 PEG polyisobutenyl anhydride - | 5.00 |
| 4914 | tall oil fatty acid copolymer | |
| Hostaphat | lsotridecyl polyoxethyl (6 EO) phosphoric | 4.00 |
| 1306 | acid mono/diester, acid form | |
| Glucopon ® | D-Glucopyranose, oligomeric, C₁₀-₁₆-alkyl | 4.78 |
| 650 EC | glycosides 25-<50% | |
| | D-Glucopyranose, oligomeric, decyl octyl | |
| | glycosides 20-<25%, NaOH 0.3-1%, water ~48%. | |
| Methyl | 67784-80-9/68919-53-9/67762-38-3 | To 100 |
| soyate | Soybean oil acids methyl ester | |
| | TOTAL | 100 |

### Formulation BB3—Pre-Hydrated Pymetrozine+Mineral/Paraffin Type Oil, —not Optimized

| Materials | CAS/Identity | % w/w |
|---|---|---|
| Pymetrozine | 123312-89-0 Pre-hydrated Pymetrozine | ~24 |
| | Pymetrozine/water = ~84:16 | |
| Atlox ® | 173717-47-0 PEG polyisobutenyl anhydride - | 5 |
| 4914 | tall oil fatty acid copolymer | |
| hostaphat | lsotridecyl polyoxethyl (6 EO) phosphoric | 4 |
| 1306 | acid mono/diester, acid form | |
| Glucopon ® | D-Glucopyranose, oligomeric, C₁₀-₁₆-alkyl | |
| 650 EC | glycosides 25-<50% | |
| | D-Glucopyranose, oligomeric, decyl octyl | 5 (4.78) |
| | glycosides 20-<25%, NaOH 0.3-1%, water ~48%. | |
| Paraffin or | | To 100 |
| Mineral Oil | | |
| | TOTAL | 100 |

### Formulation CC—Ethoxylated Alkyl Phosphate/APG/Triethylamine (TEA)

Adding TEA (Tri Ethyl Amine) to the system improves the dispersibility in water as well as after storage for two weeks at 54 C. Additionally, the Oil-Based dispersion is color-stable (not yellow) compared with some other examples not containing TEA.

Exemplified APG, Glucopon® 650 EC

### Formulation CC1—Pymetrozine Solo

| Materials | CAS/Identity | % w/w |
|---|---|---|
| Pymetrozine | Active Ingredient | 20 |
| Hostaphat ® | lsotridecyl polyoxethyl (6 EO) phosphoric | 4 |
| 1306 | acid mono/diester, acid form | |
| Bentone ® | organic derivative of a smectite clay | 0.5 |
| SD- 3 | (hectorite) | |
| TEA | Tri Ethyl Amine | 0.05 |
| Glucopon ® | D-Glucopyranose, oligomeric, C₁₀₋₁₆-alkyl | |
| 650 EC | glycosides 25-<50% | |
| | D-Glucopyranose, oligomeric, decyl octyl | 4.5 |
| | glycosides 20-<25%, NaOH 0.3-1%, water ~48%. | |
| Methyl | 67784-80-9/68919-53-9/67762-38-3 | To 100 |
| Soyate | Soybean oil acids methyl ester | |
| | TOTAL | 100 |

### Formulation CC2—Pymetrozine & Flonicamid

| Materials | CAS/Identity | % w/w |
|---|---|---|
| Pymetrozine | 123312-89-0 | 20 |
| Flonicamid | 158062-67-0 | 10 |
| Hostaphat ® | lsotridecyl polyoxethyl (6 EO) phosphoric | 4 |
| 1306 | acid mono/diester, acid form | |
| Bentone ® | organic derivative of a smectite clay | 0.5 |
| SD- 3 | (hectorite) | |
| TEA | Tri Ethyl Amine | 0.05 |
| Glucopon ® | D-Glucopyranose, oligomeric, C₁₀₋₁₆-alkyl | |
| 650 EC | glycosides 25-<50% | |
| | D-Glucopyranose, oligomeric, decyl octyl | 4.5 |
| | glycosides 20-<25%, NaOH 0.3-1%, water ~48%. | |
| Methyl | | To 100 |
| Soyate | | |
| | TOTAL | 100 |

### Formulation CC3—Pre-Hydrated Pymetrozine+Mineral/Paraffin Type Oil, not Optimized

| Materials | CAS/Identity | % w/w |
|---|---|---|
| Pymetrozine | 123312-89-0 Pre-hydrated Pymetrozine | ~24 |
| | Pymetrozine/water = ~84:16 | |
| | Pymetrozine/water = ~84:16 | |
| Hostaphat ® | lsotridecyl polyoxethyl (6 EO) phosphoric | 4 |
| 1306 | acid mono/diester, acid form | |
| Bentone ® | organic derivative of a smectite clay | 0.5 |
| SD- 3 | (hectorite) | |
| TEA | Tri Ethyl Amine | 0.05 |
| Glucopon ® | D-Glucopyranose, oligomeric, C10-16-alkyl | 4.5 |
| 650 EC | glycosides 25-<50% | |
| | D-Glucopyranose, oligomeric, decyl octyl | |
| | glycosides 20-<25%, NaOH 0.3-1%, water ~48%. | |
| Paraffin or | | To 100 |
| Mineral Oil | | |
| | TOTAL | 100 |

### Formulation DD—General—Alkoxylated Alkyl Phosphate/APG/TEA/Surfactant

| Materials | CAS/Identity | % w/w | g/500 g |
|---|---|---|---|
| Pymetrozine | 123312-89-0 | ~20 | ~100 |
| Atlox ® 4914 | 173717-47-0 | | |
| | PEG poly isobutenyl anhydride - | | |
| | tall oil fatty acid copolymer | | |
| Hostaphat ® | lsotridecyl polyoxethyl (6 EO) | | |
| 1306 | phosphoric acid mono/diester, | | |
| | acid form | | |
| Bentone ® | organic derivative of a smectite | | |
| SD3 | clay (hectorite) | | |
| TEA | Triethylamine | | |
| Alkylpolyglycoside/ | | | |
| Alkylpolyglucoside | | | |
| Methyl soyate | 67784-80-9/68919-53-9/ | To 100 | To 500 |
| | 67762-38-3 | | |
| | Soybean oil acids methyl ester | | |
| Total | | 100 | 500 |

### Formulation DD1—Alkoxylated Alkyl Phosphate/Glucopon® 650 EC/TEA/Surfactant

| Materials | CAS/Identity | % w/w | 500 g |
|---|---|---|---|
| Pymetrozine | 123312-89-0 | 20 | 100 |
| Atlox ® | 173717-47-0 | 5 | 25 |
| 4914 | PEG polyisobutenyl anhydride - tall | | |
| | oil fatty acid copolymer | | |
| Hostaphat ® | lsotridecyl polyoxethyl (6 EO) | 4 | 20 |
| 1306 | phosphoric acid mono/diester, acid | | |
| | form | | |
| Bentone ® | organic derivative of a smectite | 0.5 | 2.5 |
| SD3 | clay (hectorite) | | |
| TEA | Triethylamine | 0.05 | 0.25 |
| Glucopon ® | D-Glucopyranose, oligomeric, C₁₀-₁₆- | 4.5 | 22.5 |
| 650 EC | alkyl glycosides 25-<50% | | |
| | D-Glucopyranose, oligomeric, decyl | | |
| | octyl glycosides 20-<25%, | | |
| | NaOH 0.3-1%, water ~48%. | | |
| Methyl | 67784-80-9/68919-53-9/67762-38-3 | To 100 | To 500 |
| soyate | Soybean oil acids methyl ester | | |
| Total | | 100 | 500 |

### Formulation DD2—Alkoxylated Alkyl Phosphate/Agnique PG 8107-BL/TEA/Surfactant

| Materials | CAS/Identity | % w/w | g/500 g |
|---|---|---|---|
| Pymetrozine | 123312-89-0 | 21 (20.91) | 105 |
| Atlox ® | 173717-47-0 | 15 | 25 |
| 4914 | PEG polyisobutenyl anhydride - | | |
| | tall oil fatty acid copolymer | | |
| Hostaphat ® | lsotridecyl polyoxethyl (6 EO) | 4 | 20 |
| 1306 | phosphoric acid mono/diester, | | |
| | acid form | | |
| Bentone ® | organic derivative of a | 0.5 | 2.5 |
| SD3 | smectite clay (hectorite) | | |
| TEA | Triethylamine | 0.05 | 0.25 |
| Agnique ® | C₈₋₁₀ alkylpolyglycoside | 4.5 | 22.5 |
| PG 8107-BL | (D.P. = 1.7) ~70% active | | |
| | content | | |
| Methyl | 67784-80-9/68919-53-9/ | To 100 | To 500 |
| soyate | 67762-38-3 | | |
| | Soybean oil acids methyl ester | | |
| Total | | 100 | 500 |

Replacing the APG, Glucopon with Agnique PG is found acceptably good for stability as regards viscosity, sedimentation, and for the dispersion in water after stability (dispersibility stability)

### Formulation DD3—Alkoxylated Alkyl Phosphate/Agnique® PG 8107-BL/TEA/Surfactant

Combination with Flonicamid

| Materials | CAS/Identity | % w/w | g/500 g |
|---|---|---|---|
| Pymetrozine | 123312-89-0 | 21 (20.91) | 105 |
| flonicamid | 158062-67-0 | 10 (10.31) | 52 |
| Atlox ® 4914 | 173717-47-0 | 5 | 25 |
| | PEG polyisobutenyl anhydride - | | |
| | tall oil fatty acid copolymer | | |
| Hostaphat ® | lsotridecyl polyoxethyl (6 EO) | 4 | 20 |
| 1306 | phosphoric acid mono/diester, | | |
| | acid form | | |
| Bentone ® | organic derivative of a smectite | 0.5 | 2.5 |
| SD3 | clay (hectorite) | | |
| TEA | Triethylamine | 0.05 | 0.25 |
| Agnique ® | low foam alkyl polyglycoside | 4.5 | 22.5 |
| PG 8107-BL | (D.P. = 1.7) | | |
| Methyl | 67784-80-9/68919-53-9/67762- | To 100 | To 500 |
| soyate | 38-3 | | |
| | Soybean oil acids methyl ester | | |
| Total | | 100 | 500 |

Formulation DD4—Alkoxylated Alkyl Phosphate/Glucopon® 650 EC/TEA/Surfactant Combination with Flonicamid

| Materials | CAS/Identity | % w/w | for 500 g |
|---|---|---|---|
| Pymetrozine | 123312-89-0 | 20 | 100 |
| flonicamid | 158062-67-0 | 10 | 50 |
| Atlox ® 4914 | 173717-47-0 | 5 | 25 |
| | PEG polyisobutenyl anhydride - | | |
| | tall oil fatty acid copolymer | | |
| Hostaphat ® | lsotridecyl polyoxethyl (6 EO) | 4 | 20 |
| 1306 | phosphoric acid mono/diester, | | |
| | acid form | | |
| Bentone ® | organic derivative of a smectite | 0.5 | 2.5 |
| SD3 | clay (hectorite) | | |
| TEA | Triethylamine | 0.05 | 0.25 |
| Agnique ® | low foam alkyl polyglycoside | 4.5 | 22.5 |
| PG 8107-BL | (D.P. = 1.7) | | |
| Methyl | 67784-80-9/68919-53-9/67762- | To 100 | To 500 |
| soyate | 38-3 | | |
| | Soybean oil acids methyl ester | | |
| Total | | 100 | 500 |

### Formulation EE—Anionic Phosphate/APG/TEA/Surfactant

[20 g Formulation CC2+1 g added Surfactants for compatibility testing after Storage at 54° C. 2 W]

| Materials | ADDED SURFACTANT | QUALITY |
|---|---|---|
| Formulation | 9043-30-5 Polyoxyethylenated | Acceptable |
| CC2 + | (POE 8) isotridecanol | |
| Imbentin T080 | | |
| Formulation | 90194-36-8 Calcium Alkylbenzene | Acceptable |
| CC2 + | Sulfonate (69%) | |
| Ninate 70B-E | (Isobutyl Alcohol 25-30%) | |
| Formulation | linear dodecyl benzene sulfonate 57% | Acceptable |
| CC2 + | 2-ethylhexanol ~43% | |
| Nansa EVM | | |
| 70/2E | | |
| Formulation | Poloxamer 184 | Acceptable |
| CC2 + | Ethoxylated/Propoxylated alcohol | |
| Synperonic PE- | | |
| L64 | | |
| Formulation | Tridecyl polyglycol ether Phosphate | Acceptable |
| CC2 + | | |
| Servoxyl VPDZ | | |
| 3/100 | | |
| Formulation | 68953-96-8 branched Alkylbenzene | Acceptable |
| CC2 + | (C₁₁₋₁₃) sulfonate, calcium salt | |
| Ninate 401A | 55%-65% | |
| | Solvent naphtha, petroleum, heavy | |
| | arom. 10%-<20% | |
| | 1-hexanol 10%-15% | |
| | Naphthalene 1%-<3% | |
| Formulation | Polyethylene Glycol | Unacceptable |
| CC2 + | | Solidification |
| PEG 200 | | |
| Formulation | Polyoxyethylene Sorbitan Fatty Acid | Unacceptable |
| CC2 + | Ester | Solidification |
| Tween 24 | | |

### Some Exemplified Finer Tuned Embodiments of the Inventive Compositions

a. Anionic Phosphate+Sulphonate
1. Add Methyl Soyate to a Vessel
2. Add the materials: Atlox®4914, Agnique PG 8107-BL/Glucopon 650 EC, TEA, Hostaphat® 1306, Ninate 401A.
3. Mix to get homogenous mixture.
4. Add the active ingredient(s)—Pymetrozine (and Flonicamid) with agitation and high Shear
5. Add Bentone® SD-3 and Apply High Shear.
6. Mill the dispersion to get the desired particle size.

1. Agnique ®PG 8107-BL + TEA + Ninate ®401 +
Hostaphat ®1306 + 4914+

| | |
|---|---|
| | Pymetrozine + |
| Pymetrozine | Flonicamid |

| Materials | % w/w | Materials | % w/w |
|---|---|---|---|
| 95% pymetrozine | 21 (20.91) | 95% Pymetrozine | 21 (20.91) |
| — | | 97% flonicamid | 10 (10.31) |
| Atlox ® 4914 | 5 | Atlox ® 4914 | 5 |
| Hostaphat 1306 | 4 | Hostaphat 1306 | 4 |
| Bentone ® SD- 3 | 0.5 | Bentone ® SD- 3 | 0.5 |
| Ninate ® 401A | 2 | Ninate ® 401A | 2 |
| TEA | 0.05 | TEA | 0.05 |
| Agnique ® | 4.5 | Agnique ® | 4.5 |
| PG 8107-BL | | PG 8107-BL | |
| Methyl Soyate | To 100 | Methyl Soyate | To 100 |
| TOTAL | 100 | TOTAL | 100 |

Hostaphat ® 1306 - Phosphate esters of ethoxylated fatty alcohols Ninate ® 401 Branched Alkylbenzene (C₁₁₋₁₃) sulfonate, calcium salt

2.Glucopon 650 EC + TEA + Ninate ®401 + Hostaphat
1306 + Atlox ® 4914

| | |
|---|---|
| Pymetrozine | Pymetrozine + Flonicamid |

| Materials | % w/w | Materials | % w/w |
|---|---|---|---|
| 95% Pymetrozine | 21 (20.91) | 95% Pymetrozine | 21 (20.91) |
| — | | 97% flonicamid | 10 (10.31) |
| Atlox ® 4914 | 5 | Atlox ® 4914 | 5 |
| Hostaphat 1306 | 4 | Hostaphat 1306 | 4 |
| Bentone ® SD- 3 | 0.5 | Bentone ® SD- 3 | 0.5 |
| Ninate 401A | 2 | Ninate 401A | 2 |
| TEA | 0.05 | TEA | 0.05 |
| Glucopon 650 EC | 4.5 | Glucopon 650 EC | 4.5 |
| Methyl Soyate | To 100 | Methyl Soyate | To 100 |
| TOTAL | 100 | TOTAL | 100 |

b. Anionic Phosphate without Sulphonate
1. Add Methyl Soyate to a Vessel
2. Add the materials: Atlox®4914, Agnique PG 8107-BL/Glucopon 650 EC, TEA, Hostaphat® 1306.
3. Mix to get homogenous mixture.
4. Add the Actives—Pymetrozine (and Flonicamid) with agitation and high Shear
5. Add BentoneR SD—3 and Apply High Shear.
6. Mill the dispersion to get the desired particle size.
7. Package in suitable containers (typically impermeable to light and moisture see above)

3.Agnique ® PG 8107-BL + TEA +
Hostaphat@1306 + Atlox ® 4914

| Pymetrozine | | Pymetrozine + Flonicamid | |
|---|---|---|---|
| Materials | % w/w | Materials | % w/w |
| 95% Pymetrozine | 21 (20.91) | 95% Pymetrozine | 21 (20.91) |
| — | | 97% flonicamid | 10 (10.31) |
| Atlox ® 4914 | 5 | Atlox ® 4914 | 5 |
| Hostaphat 1306 | 4 | Hostaphat 1306 | 4 |
| Bentone ® SD- 3 | 0.5 | Bentone ® SD- 3 | 0.5 |
| TEA | 0.05 | TEA | 0.05 |
| Agnique PG 8107-BL | 4.5 | Agnique PG 8107-BL | 4.5 |
| Methyl Soyate | To 100 | Methyl Soyate | To 100 |
| TOTAL | 100 | TOTAL | 100 |

Hostaphat ® 1306 - Phosphate esters of ethoxylated fatty alcohols

4.Glucopon 650 EC + TEA + Hostaphat 1306 + Atlox ® 4914

| | |
|---|---|
| Pymetrozine | Pymetrozine + Flonicamid |

| Materials | % w/w | Materials | % w/w |
|---|---|---|---|
| 95% Pymetrozine | 21 (20.91) | 95% Pymetrozine | 21 (20.91) |
| — | | 97% flonicamid | 10 (10.31) |
| Atlox ® 4914 | 5 | Atlox ® 4914 | 5 |
| Hostaphat 1306 | 4 | Hostaphat 1306 | 4 |
| Bentone ® SD- 3 | 0.5 | Bentone ® SD- 3 | 0.5 |
| TEA | 0.05 | TEA | 0.05 |
| Glucopon 650 EC | 4.5 | Glucopon 650 EC | 4.5 |
| Methyl Soyate | To 100 | Methyl Soyate | To 100 |
| TOTAL | 100 | TOTAL | 100 |

Results indicate that the Compositions 3 and 4 comprising, in addition to Pymetrozine (and Flonicamid), Atlox® 4914; Hostaphat 1306; Bentone® SD-3; TEA; Glucopon 650 EC or Agnique PG 8107-BL and Methyl Soyate performed well and displayed good dispersion in water. Inventors however found that the addition of Ninate 401A in compositions 1 and 2 above, improved the ease of dilution in water after storage at temperatures exemplified by 54° C. Additionally, a week after dispersion in the water, the sediment is minimal and after 2-3 inversions of the diluted sample, no sediment is observed.

c. Optimization by Process

While compositions comprising both Hostaphat® 1306 and Ninate® 401A [1 and 2 above] were very good, inventors managed to optimize these compositions even more when the branched alkylbenzene (C₁₁₋₁₃) sulfonate salt (NINATE 401A) is added after all the other ingredients have been milled.

So, taking the above examples 2 above the following preparation method was used providing further optimized characteristics.
1. Add Methyl Soyate to a Vessel
2. Add the materials: Atlox® 4914, Agnique® PG 8107-BL/Glucopon® 650 EC, TEA, Hostaphat® 1306.
3. Mix to get homogenous mixture.
4. Add Bentone® SD-3 and apply high shear
5. Add the active ingredient(s) Pymetrozine (and Flonicamid) while applying agitation and high shear
6. Mill the dispersion to get the desired particle size.
7. After milling add the material NINATE® 401A and mix to get homogenous dispersion.
8. Package in suitable containers (typically impermeable to light and moisture see above)

### Pymetrozine+Flonicamid

| Materials | % w/w | g per 500 g |
|---|---|---|
| 95% Pymetrozine | 21 (20.91) | 105 (104.55) |
| 97% flonicamid | 10 (10.31) | 52 (51.55) |
| Atlox ® 4914 | 5 | 25 |
| Hostaphat 1306 | 4 | 20 |
| Bentone ® SD-3 | 0.5 | 2.5 |
| Ninate ® 401A | 2 | 10 |
| TEA | 0.05 | 0.25 |
| Glucopon ® 650 EC | 4.5 | 22.5 |
| Methyl Soyate | To 100 | To 500 |
| TOTAL | 100 | 500 |

### Stability

Dispersibility Stability—Influence of Alkyl polyglycoside/Alkyl Polygucoside and TEA
Oil-based dispersion samples comprising Methyl Soyate, Hostaphat® 1306, Atlox® 4914, Bentone® SD-3 and the additional co-formulants are indicated in the table:
Glucopon® 650 EC—Aqueous solution of alkyl polyglucosides based on natural fatty alcohol C₈-C₁₄
Agnique® PG 8107-BL—C₈₋₁₀ alkyl Polyglycoside (D.P.=1.7) ca. 70% active content
TEA—Triethyl amine

| Oil-Based | | |
|---|---|---|
| Dispersion | AFTER STORAGE | |
| Includes | Room Temperature | 54° C. |
| Triethyl | Spontaneously dispersed in water | Lack of Yellow color |
| Amine | After 1 inversion no particles | on introduction to |
| | | water |
| | | Many particles even |
| | | after many inversions |
| Agnique ® | Good dispersion | White good dispersion. |
| PG 8107-BL | After few inversions no particles | After few inversions |
| Triethyl | | no particles |
| Amine | | |
| Glucopon ® | Good dispersion | White good dispersion |
| 650 | After few inversions no particles | After few inversions |
| Triethyl | | no particles |
| Amine | | |
| Glucopon ® | White dispersion | High viscosity, |
| 650 | (though not as good as with TEA) | difficult dilution in |
| | After few inversions no particles | water but after few |
| | | inversions no |
| | | particles are |
| | | observed |

### Formulation CC2—Stability Data (GlucoponR 650 EC+Triethyl Amine)

| | Storage | |
|---|---|---|
| Stability tests | Room Temp | 54° C. |
| Appearance | Beige, flowable, no sediments, homogenous | |
| Dispersibility | Dispersed slowly as a white | |
| in Water | cloud in the water. no sediments | |
| Pymetrozine content | 203.7 | 201.1 |
| Flonicamid content | 106.5 | 105.2 |
| (g/l) | | |
| Pymetrozine Suspensibi | 99.13% | 98.79% |
| Flonicamid | 100.36% | 100% |
| Density | 1.0286 g/cm³ | 1.0212 g/cm³ |
| Remaining on 75 μm | 0 | 0 |
| Wet Sieve | | |
| Dispersion stability | Sediment | Sediment |
| (initial) | volume: <0.05 | volume: <0.05 |
| | Top cream/oil: 0 ml | Top cream/oil: 0 ml |
| Re dispersion after | | |
| 24 h + 0.5 h | | |

### Compositions That Have Room for Optimization

Having provided the guiding principles for readily producing pourable, storage stable concentrated Pymetrozine oil-based dispersion compositions, several compositions are illustrated which can now be further optimized. Exemplified are the composition outline prototypes for optimization of high pesticide loading comprising Pymetrozine and Flonicamid as a model compound mixing partner.

| Materials | % w/w | g per 300 g |
|---|---|---|
| Pymetrozine | 31 (31.37) | 94 (94.1) |
| Flonicamid | 15 (15.47) | 46 (46.4) |
| Atlox ® 4914 | 5 | 15 |
| Hostaphat ® 1306 | 6 | 18 |
| Bentone ® SD-3 | 0.5 | 1.5 |
| TEA | 0.075 | 0.225 |
| Agnique ® PG 8107-BL | 6.75 | 20.25 |
| Methyl Soyate | To 100 | To 300 |
| TOTAL | 100 | 300 |

The composition did not solidify during compounding and after storage at elevated temperatures. However, the viscosity was high and dispersion of the concentrate into water was challenging. The effects of the low amount of solvent/carrier in the system presents challenges.

The following formulations have high pesticide content, although the compositions address some challenges, they would benefit from further optimization using the guidance herein presented above, particularly as regards physical stability displaying unacceptable levels of solidification after storage at 54° C. In particular it is now clear from the preceding description that addition of either or both of Alkylpolyglucoside/glycoside and/or Triethylamine would improve these compositions.

| Materials | % w/w | g per 700 g |
|---|---|---|
| Pymetrozine | 26 (25.85) | 181 |
| flonicamid | 17 (17.35) | 121 (121.43) |
| Atlox ® 4914 | 5 | 35 |
| Servoxyl ® 3/100 | 2 | 14 |
| Bentone ® SD- 3 | 2 | 14 |
| Methyl soyate | To 100 | To 700 |

| Materials | % w/w | g per 700 g |
|---|---|---|
| Pymetrozine | 26 (25.85) | 181 |
| flonicamid | 17 (17.35) | 121 (121.43) |
| Atlox ® 4914 | 5 | 35 |
| Servoxyl ® 3/100 | 2 | 14 |
| Bentone ® SD- 3 | 1 | 7 |
| Methyl soyate | To 100 | To 700 |

| Materials | % w/w | g/700 g |
|---|---|---|
| Pymetrozine | 26 (25.85) | 181 |
| flonicamid | 17 (17.35) | 121 (121.43) |
| Atlox ® 4914 | 8 | 56 |
| Servoxyl ® 3/100 | 4 | 28 |
| Bentone ® SD- 3 | 2 | 14 |
| Methyl soyate | To 100 | To 700 |

Some Envisioned Compositions as Initial Basis for optimization

| Ingredients | % w/w |
|---|---|
| 98% Pymetrozine tech | 25.51 (25%) |
| Calcium alkyl benzene sulphonate in 2-ethylhexanol | 5 |
| (CALSOGEN 4814) | |
| Castor oil ethoxylate with 36 mole EO (EMULSOGEN | 5 |
| 360) | |
| alkyl phosphates or ethoxylated phosphate esters | 2 |
| Organic derivative of a hectorite clay (BENTONE 38) | 0.4 |
| Fumed silica (AEROSIL R-816) | 0.5 |
| Methyl soyate | To 100 |
| Total | 100 |

| Ingredients | % w/w |
|---|---|
| 98% Pymetrozine tech | 25.51 (25%) |
| N-C₁₂ alkyl benzene sulfonate calcium salt phosphate ester | 5 |
| (SOPROPHOR FLR) | |
| Castor oil ethoxylate with 36 mole EO (ATLOX 4853B) | 5 |
| Alkyl polyglycoside | 4%-8% |
| water | 1-4% |
| Organic derivative of a hectorite clay (BENTONE 38) | 0.4 |
| Fumed silica (AEROSIL 200) | 0.5 |
| Sunflower oil | To 100 |
| Total | 100 |

| Ingredients | % w/w |
|---|---|
| 98% Pymetrozine tech | 25.51 (25%) |
| N-C₁₂ alkyl benzene sulfonate calcium salt phosphate ester | 5 |
| (SOPROPHOR FLR) | |
| Castor oil ethoxylate with 36 mole EO (ATLOX 4853B) | 5 |
| Alkyl polyglycoside/Alkyl polyglucoside | 4%-8% |
| water | 1-4% |
| Triethylamine | 0.04-0.08% |
| Organic derivative of a hectorite clay (BENTONE 38) | 0.4 |
| Fumed silica (AEROSIL 200) | 0.5 |
| Sunflower oil | To 100 |
| Total | 100 |

| Ingredients | % w/w |
|---|---|
| 98% Pymetrozine tech | 25.51 (25%) |
| n-C₁₂ alkyl benzene sulfonate calcium salt | 5 |
| (Phenyl sulfonate Cal) | |
| Tri-sec-butylphenol polyglycol ether with 4 EO | 5 |
| (SAPOGENAT T 040) | |
| Alkyl polyglycoside/Alkyl polyglucoside | 4%-8% |
| water | 1-4% |
| Organic derivative of a hectorite clay (BENTONE 27) | 0.4 |
| Fumed silica (AEROSIL 300) | 0.5 |
| Alkylated Vegetable Oil | To 100 |
| Total | 100 |

| Ingredients | % w/w |
|---|---|
| 98% Pymetrozine tech | 25.51 (25%) |
| Isotridecyl polyoxethyl (6 EO) phosphoric acid mono/ | 4 |
| diester, acid form (HOSTAPHAT ® 1306) | |
| Castor oil ethoxylate with 36 mole EO (EMULSOGEN | 5 |
| 360) | |
| C₈/C₁₀ alkyl polyglycoside | 4%-8% |
| (AGNIQUE ® PG [8105 or 8107]) | |
| Organic derivative of a hectorite clay (BENTONE 38) | 0.4 |
| Fumed silica (AEROSIL R-816) | 0.5 |
| Methylated Vegetable Oil | To 100 |
| Total | 100 |

| Ingredients | % w/w |
|---|---|
| 98% Pymetrozine tech | 25.51 (25%) |
| Isotridecyl polyoxethyl (6 EO) phosphoric acid | 4 |
| mono/diester, acid form (HOSTAPHAT ® 1306) | |
| Castor oil ethoxylate with 36 mole EO (EMULSOGEN | 5 |
| 360) | |
| C₈/C₁₀ alkyl polyglycoside (AGNIQUE ® PG [8105 | 4%-8% |
| or 8107]) 63%-70% active | |
| Water | 1%-3% |
| Organic derivative of a hectorite clay (BENTONE 38) | 0.4 |
| Fumed silica (AEROSIL R-816) | 0.5 |
| Methylated Vegetable Oil | To 100 |
| Total | 100 |

| Ingredients | % w/w |
|---|---|
| 98% Pymetrozine tech | 25.51 (25%) |
| Isotridecyl polyoxethyl (6 EO) phosphoric acid | 4 |
| mono/diester, acid form (HOSTAPHAT ® 1306) | |
| Castor oil ethoxylate with 36 mole EO (EMULSOGEN | 5 |
| 360) | |
| C₈/C₁₀ alkyl polyglycoside | 4%-8% |
| (AGNIQUE ® PG [8105 or 8107]) 63%-70% active | |
| Triethylamine | 0.04-0.08% |
| Water | 1%-3% |
| Organic derivative of a hectorite clay (BENTONE 38) | 0.4 |
| Fumed silica (AEROSIL R-816) | 0.5 |
| Methylated Vegetable Oil | To 100 |
| Total | 100 |

### Comparing the Solo Use of Two Anionic Components in a Non-Optimized Process

As previously alluded to, when the compositions comprise anionic surface-active agents, in some embodiments there may me additional advantages achieved by combining both phosphate/phosphonate surfactants and sulphate/sulphonate surfactants. However, each should be visualized as being capable of process optimization that may not be identical.

Herein below is a non-limiting example of a combination product of Pymetrozine and Flonicamid wherein using an identical process for two compositions each with high loading of different anionic surfactants, achieves differing product characteristics.

When optimizing combination products, it is advisable to always consider all the active components.

| | | Content % w/w | |
|---|---|---|---|
| Materials | CAS/Identity | 1 | 2 |
| Pymetrozine | 123312-89-0 | 21 (20.91) | 21 (20.91) |
| flonicamid | 158062-67-0 | 10 (10.31) | 10 (10.31) |
| Atlox ® | 173717-47-0 PEG | 5 | 5 |
| 4914 | polyisobutenyl anhydride - tall | | |
| | oil fatty acid copolymer | | |
| Hostaphat ® | lsotridecyl | Absent | 6 |
| 1306 | polyoxethylphosphoric acid | | |
| | mono/diester, | | |
| | acid form | | |
| Ninate ® | Branched Alkylbenzene (C11-13) | 6 | Absent |
| 401A | sulfonate, calcium salt | | |
| Bentone ® | organic derivative of a smectite | 0.5 | 0.5 |
| SD-3 | clay (hectorite) | | |
| TEA | Triethylamine | 0.05 | 0.25 |
| Glucopon ® | D-Glucopyranose, oligomeric, | 4.5 | 4.5 |
| 650 EC | C₁₀-₁₆-alkyl glycosides 25-50% | | |
| | D-Glucopyranose, oligomeric, | | |
| | decyl octyl glycosides 20-<25%, | | |
| | NaOH 0.3-1%, water ~48%. | | |
| Methyl | 67784-80-9/68919-53-9/67762- | To 100 | To 500 |
| soyate | 38-3 | | |
| | Soybean oil acids methyl ester | | |

When using exactly the same process for each of the combination compositions 1 and 2 in the above table employing high loading (60 w/w) of anionic surface-active agents from different classes the results are different. When the anionic surfactant was added at the same point early in the preparation prior to addition of the two active ingredients, it was found that the composition comprising only sulphate/sulphonate anionic surfactant was not as optimized as the composition based on phosphate/phosphonate surfactant. Concentrate 1 is flowable and the milling process is acceptable, while Concentrate 2 is difficult to manufacture, with non-optimal solidification effects.

1) A non-aqueous pesticidal suspension composition comprising,
a) pesticide compound in solid particulate form,
b) alkylpolysaccharide surfactant,
c) non-pesticidally active formulation aid, and
d) oil-based carrier
wherein the pesticide compound is a hygroscopic, water-soluble and/or solvent absorbing compound and wherein the non-aqueous pesticidal suspension composition optionally comprises a further pesticide compound.

2) The non-aqueous pesticidal suspension composition claimed in claim 1 wherein the composition is an insecticidal oil-based dispersion composition comprising,
a) pymetrozine in solid particulate form as pesticide compound,
b) aqueous solution of alkylpolysaccharide as alkylpolysaccharide surfactant, comprising alkyl polyglycoside, alkyl polyglucoside or mixtures thereof,
c) non-insecticidal formulation aid as non-pesticidally active formulation aid,
d) oil-based carrier, and optionally
e) a further insecticide compound,
wherein the pymetrozine in solid particulate form is either non-hydrated or pre-hydrated prior to inclusion in the composition.

3) The non-aqueous pesticidal suspension composition claimed in claim 2 wherein the composition is an insecticidal oil-based dispersion concentrate composition comprising,
a) pymetrozine in solid particulate form,
b) aqueous solution of alkylpolysaccharide surfactant comprising,
alkyl polyglycoside, alkyl polyglucoside or mixtures thereof,
c) at least one non-insecticidal formulation aid,
d) end-use dispersibility stabilizer/compatibilizer compound, and
e) oil-based carrier,
wherein the amount of water comprising the aqueous solution of alkylpolysaccharide surfactant is between greater than 0% w/w, and equal or less than 5% w/w based on the weight of the insecticidal oil-based dispersion concentrate composition.

4) The non-aqueous pesticidal suspension composition claimed in either claim 2 or claim 3 wherein the pymetrozine is in non-hydrated solid particulate form, and the oil-based carrier comprises vegetable oil, vegetable oil derivative, such as alkylated vegetable oil, or combinations thereof.

5) The non-aqueous pesticidal suspension composition claimed in any one of claims 2-4 wherein the end-use dispersibility stabilizer/compatibilizer compound is one or more of tertiary amine, alkyl amine, triethylamine, tributylamine mixed alkyl amine, triethanolamine, N,N-di-isopropyl ethylamine, butylamine, especially triethylamine, and the oil-based carrier comprises one or more of, vegetable oil, vegetable oil derivative, such as alkylated vegetable oil exemplified by vegetable oil methyl ester, such as methyl soyate, palm methyl ester oil, methyl oleate, methyl linoleate, methyl linolenate, methyl stearate, methyl palmitate, rapeseed oil methyl ester.

6) The non-aqueous pesticidal suspension composition claimed in any one of claims 1-5 wherein the non-pesticidally active, and/or non-insecticidal formulation aid is one or more of dispersing agent, emulsifier, surfactant, rheology modifier, oil adjuvants and combinations thereof.

7) The non-aqueous pesticidal suspension composition claimed in any one of claims 1-6, wherein the non-pesticidally active formulation aid comprises one or more alkoxylated adjuvant, anionic surfactant, dispersant, end-use dispersibility stabilizer or compatibilizer regulator, thickener and/or rheological additive and combinations of two or more thereof.

8) The non-aqueous pesticidal suspension composition claimed in claim 7, wherein the alkoxylated adjuvant, is one or more of alkoxylated (such as ethoxylated) carboxylic acid esters, alkoxylated (such as ethoxylated) carboxylic acids, alkoxylated (such as ethoxylated) primary or secondary linear or branched alcohols, alkoxylated fatty alcohols, ethoxylated fatty alcohols, coconut fatty alcohol ethoxylates, C_{12/C14} fatty alcohol ethoxylates, cetyl/oleyl alcohol ethoxylates, C_{16/C18} fatty alcohol ethoxylates, C_{12/C18} fatty alcohol ethoxylates, C_{8/C14} fatty alcohol ethoxylates, C_{13/C15} fatty alcohol ethoxylates, C_{11/C15} fatty alcohol ethoxylates, tributyl phenol ethoxylates, alkoxylated (such as ethoxylated linear or branched) alkyl aryls such as ethoxylated alkyl phenols, nonylphenol ethoxylates and ethoxylated acetylenic diols, alkoxylated fatty alcohols/ethoxylated fatty alcohols, ethoxylated isotridecyl alcohol, a co-polymer PEG poly-iso-butenyl anhydride-tall oil fatty acid, ABA block copolymers having a hydrophilic portion of polyethylene oxide (PEG) and a hydrophobic portion of 12-hydroxystearic acid.

9) The non-aqueous pesticidal suspension composition claimed in claim 7, wherein the anionic surfactants, is one or more of phosphonate, phosphate esters sulfonates sulfate esters such as, alkyl benzene sulfonates alkyl sulfates, alkyl ether sulfates alkyl aryl ether sulfates, alkylbenzene sulfonate alkylbenzene sulfonate (branched or linear) salts of alkyl naphthalene sulphonic acids, salts of naphthalene sulphonic acid formaldehyde condensation products, salts of condensation products of naphthalene sulphonic acid, phenol sulphonic acid and formaldehyde, alkali metal salts of alkyl naphthalene sulphonic acids, salts of naphthalene sulphonic acid-formaldehyde condensation products; mono- and diesters of sulfosuccinate metal salts with branched or linear alcohols; sodium dioctyl sulfosuccinate; alkyl Succinate sulphate, alkyl benzenesulfonates, alkanesulfonates, olefin sulfonates, alkyl ether sulfonates, glycerol ether sulfonates, α-methyl ester sulfonates, sulfo fatty acids, alkyl sulfates, fatty alcohol ether sulfates, glycerol ether sulfates, fatty acid ether sulfates, hydroxy mixed ether sulfates, monoglyceride (ether) sulfates, fatty acid amide (ether) sulfates, mono- and dialkyl sulfosuccinates, mono- and dialkyl sulfo-succinamates, sulfo-triglycerides, amide soaps, ether carboxylic acids and salts thereof, fatty acid isethionate, fatty acid sarcosinate, fatty acid taurides, alkyl oligoglucoside sulfates, alkylbenzene sulfonate alkylbenzene sulfonate (branched/linear), phosphate esters such as, mixtures of mono, and di-ester, free alcohol and phosphoric acid, alkyl phosphonic acids, phosphate esters of fatty alcohols, phosphate esters of ethoxylated fatty alcohols alkoxylated/ethoxylated phosphate esters, alkyl phosphonic acids, anionic phosphate esters, ethoxylated phosphate esters, such as phosphate ester based on iso-tridecanol ethoxylate, alkyl, and olefin sulfonates comprising hydrophobic alkyl chain and an anionic sulfonic acid group, sulfate esters from sulfonation of fatty alcohols and alcohol ethoxylates, alcohol alkoxylate (such as ethoxylate) phosphates, alkyl phenol alkoxylate (such as ethoxylate) phosphate, alkyl amine phosphate and combinations thereof.

10) The non-aqueous pesticidal suspension composition claimed in claim 7 comprising pymetrozine, triethylamine, phosphate esters of ethoxylated fatty alcohols such as, isotridecyl poly-oxyalkyl (e.g., 6 EO) phosphoric acid mono/diester acid form; calcium alkyl benzene sulphonate such as branched alkylbenzene (C₁₁₋₁₃) sulfonate, calcium salt; castor oil ethoxylate, alkyl polysaccharide (alkylpolyglucoside/alkyl polyglucoside) such as an aqueous solution of alkyl polyglucosides based on fatty alcohol C₈₋₁₆; organic derivative of a hectorite clay, and/or or fumed silica, and vegetable-based oil carrier such as Methyl Soyate and optionally additional pesticidal compound.

11) The non-aqueous pesticidal suspension composition claimed in claim 7 comprising pymetrozine, flonicamid, triethylamine, isotridecyl Polyoxy-ethyl phosphoric acid mono/diester acid form; branched alkylbenzene C₁₁₋₁₃ sulfonate, calcium salt; castor oil ethoxylate, an aqueous solution of alkyl polyglucosides based on fatty C₈₋₁₆ alcohol; organic derivative of a hectorite clay, and methyl soyate.

12) The non-aqueous pesticidal suspension composition claimed in any one of claims 2-11 wherein the non-aqueous pesticidal suspension composition is packaged in a container which is sufficiently impermeable to moisture, sunlight, or both, such that the quality of the dispersion is maintained during storage and the end-use dispersibility is not affected due to storage at temperatures for more than a week above 25° C., wherein said container is characterized by being formed from materials which provide a barrier to moisture and/or to light with wavelengths between 250 to 400 nm and said container is sealed by closure system that does not impair the level of impermeability to moisture and/or light afforded by the materials from which they are formed, wherein sufficiently impermeable to moisture, sunlight, or both, is such that the percentage water content of the contained non-aqueous pesticidal suspension composition does not increase by to more than 5% w/w after a period of storage at 54° C. for two weeks and/or storage for one month at 40° C./75% RH, and characterized in that the pymetrozine content of the non-aqueous pesticidal suspension composition in the container is not degraded by more than 5% w/w when stored exposed to sunlight or artificial light with wavelengths between 250 to 400 nm over the storage period.

13) A non-aqueous pesticidal suspension concentrate composition comprising,
a) a compound of structural formula (A), in solid particulate form, 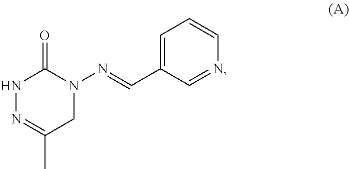 [SMILES: CC1=NNC(=O)N(/N=C/c2cccnc2)C1]
a compound of structural formula (B) 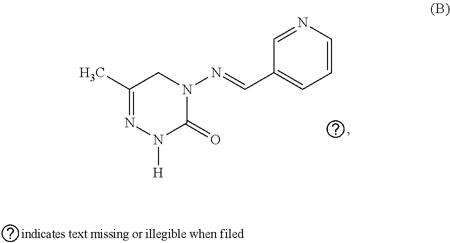 [SMILES: CC1=NNC(=O)N(/N=C/c2cccnc2)C1]
b) aqueous solution of alkylpolysaccharide surfactant comprising,
alkyl polyglycoside, alkyl polyglucoside or mixtures thereof,
c) alkoxylated adjuvant,
d) anionic surfactant selected from,
i) phosphate or phosphonate-based surfactant;
ii) sulphate or sulphonate-based surfactant; and
iii) combination of phosphate or phosphonate-based surfactant and sulphate or sulphonate-based surfactants
e) triethylamine,
f) methyl soyate, and optionally
g) additional pesticidally active compound, such as flonicamid
wherein,
r and s are each independently, between greater than 0 and 12, and
L is one or more of methanol, ethanol, propanol, isopropanol, butanol, isobutanol, t-butanol, cyclohexanol, 2-Ethyl Hexanol, alkylbenzene, tetrahydrofurfuryl alcohol, ethylene glycol, glycerol, methyl acetate, ethyl acetate, ethyl lactate, butyrolactone, ethylene carbonate, propylene carbonate, acetonitrile, dimethyl sulphoxide, dimethylformamide, dimethylacetamide, N-methyl-2-pyrrolidone, N-octyl-2-pyrrolidone, N-decyl-2-pyrrolidone, acetone, butanone, methyl isobutyl ketone, methyl propyl ketone, acetophenone, cyclohexanone, methylene chloride, trichloromethane, trichloroethane, tetrahydrofuran, diethyl ether, 1,2-dimethoxyethane, dioxane, methyl-tert-butyl ether, ethanolamine, pyridine, chlorobenzene, toluene, xylene or tetramethyl urea, and the content of L comprises equal or less than 5% w/w of the composition, wherein the amount of water comprising the aqueous solution of alkylpolysaccharide surfactant is between greater than 0% w/w, and equal or less than 5% w/w based on the weight of the non-aqueous pesticidal suspension concentrate composition and the non-aqueous pesticidal suspension concentrate composition is characterized in that propylene glycol is essentially absent.

14) The non-aqueous pesticidal suspension composition claimed in claim 13 wherein the non-aqueous pesticidal suspension composition is packaged in a container which is sufficiently impermeable to moisture, sunlight, or both, such that the quality of the dispersion is maintained during storage and the end-use dispersibility is not affected due to storage at temperatures for more than a week above 25° C., wherein said container is characterized by being formed from materials which provide a barrier to moisture and/or to light with wavelengths between 250 to 400 nm and said container is sealed by closure system that does not impair the level of impermeability to moisture and/or light afforded by the materials from which they are formed, wherein sufficiently impermeable to moisture, sunlight, or both, is such that the percentage water content of the contained non-aqueous pesticidal suspension composition does not increase by to more than 5% w/w after a period of storage at 54° C. for two weeks and/or storage for one month at 40° C./75% RH, and characterized in that the pymetrozine content of the non-aqueous pesticidal suspension composition in the container is not degraded by more than 5% w/w when stored exposed to sunlight or artificial light with wavelengths between 250 to 400 nm over the storage period.

15) A pourable, storage stable concentrated Pymetrozine oil-based dispersion composition, characterized by low viscosity, and stable water dispersibility having the following percentage content by weight of the complete dispersion composition,
(a) pesticidal ingredient comprising solid particulate Pymetrozine or solid particulate pre-hydrated Pymetrozine, between greater than 0% and equal or less than 40% w/w,
(b) non-insecticidal formulation aids between 0.2% and equal or less than 30% w/w, wherein said non-insecticidal formulation aids are selected from the group of,
i. emulsifier/surfactant between about 1% to about 10% w/w.
ii. dispersant, greater than 1%-10%.
iii. thickener and/or rheological additive, 0.1-3%.
iv. end-use dispersibility stabilizer/compatibilizer regulator 2%-20%
v. water between greater than 0% w/w, and equal or less than 5% w/w, other than any water associated with the pre-hydrated Pymetrozine if present, and
vi. any and all combinations of two or more thereof,
(c) oil-based liquid carrier added up to 100%,
wherein, the pesticidal ingredient optionally comprises an additional pesticidal compound such as flonicamid and the composition is optionally packaged in a container.

16) The Pymetrozine oil dispersion as claimed in claim 15, wherein said non-insecticidal formulation aid comprises between about 1% and 10% w/w alkyl polyglycosides and/or alkyl polyglucosides by weight of the complete dispersion composition.

17) The Pymetrozine oil dispersion as claimed in claim 15, wherein said non-insecticidal formulation aid comprises aqueous solution of alkyl polyglycosides and/or alkyl polyglucosides.

18) The Pymetrozine oil dispersion as claimed in claim 15, wherein said non-insecticidal formulation aids comprise between about 1% and 10% w/w by weight of the complete dispersion composition, anionic surfactants, such as phosphate esters (mixtures of mono, and di-ester, free alcohol and phosphoric acid), alkyl phosphonic acids, phosphate esters of fatty alcohols, phosphate esters of ethoxylated fatty alcohols alkoxylated/ethoxylated phosphate esters, alkyl phosphonic acids, branched or linear alkyl aryl sulfonates, branched or linear alkyl benzene sulfonates, alkyl and olefin sulfonates comprising hydrophobic alkyl or olefin chain and an anionic sulfonic acid group, sulfate esters from sulfonation of fatty alcohols and alcohol ethoxylates.

19) The Pymetrozine oil dispersion as claimed in claim 15, wherein said non-insecticidal formulation aids comprise between about 1% w/w and about 10% w/w of by weight of the complete dispersion composition, of alkoxylated adjuvant such as, alkoxylated/ethoxylated carboxylic acid esters, ethoxylated carboxylic acids, ethoxylated primary or secondary linear or branched alcohols, alkoxylated fatty alcohols, ethoxylated fatty alcohols, coconut fatty alcohol ethoxylates, C₁₂/C₁₄ fatty alcohol ethoxylates, cetyl/oleyl alcohol ethoxylates, C₁₆/C₁₈ fatty alcohol ethoxylates, C₁₂/C₁₈ fatty alcohol ethoxylates, C₈/C₁₄ fatty alcohol ethoxylates, C₁₃/C₁₅ fatty alcohol ethoxylates, C₁₁/C₁₅ fatty alcohol ethoxylates, tributyl phenol Ethoxylates, ethoxylated (linear or branched), alkyl aryls such as ethoxylated alkyl phenols, nonylphenol ethoxylates and ethoxylated acetylenic diols, alkoxylated fatty alcohols/ethoxylated fatty alcohols Cas 69011-36-5 (Imbentin® U/050), isotridecylalcohol, ethoxylated (CAS. 9043-30-5), a co-polymer PEG poly-iso-butenyl anhydride-tall oil fatty acid CAS. 173717-47-0 (Atlox® 4914) Block Co-Polymer EO-12-hydroxystearic acid (Atlox 4912) and all combinations of two or more thereof.

20) The Pymetrozine oil-based dispersion as claimed in claim 18, wherein said anionic surfactants are sulphates/sulphonates such as, fatty alcohol sulfate, fatty alcohol ether sulfate, alpha olefin sulphonate, alkyl benzene sulfonate (Ninate® 60, Ninate 70BE, Nansa EVM 70/2E), branched alkylbenzene C₁₁₋₁₃ sulfonate and their salts (Ninate® 401A), alkyl phosphates, or ethoxylated phosphate esters in acid or salt form, such as Isotridecyl polyoxethyl (6EO) phosphoric acid mono/diester acid form (HOSTAPHAT® 1306), tridecyl polyglycol ether phosphate (SERVOXYL® VPDZ 3/100), alkylphenoxypolyethyl ester of phosphoric acid (RHODAFAC® PA), trideceth-5 Phosphate (Crodafos® T5A) and combinations of two or more thereof.

21) The Pymetrozine oil-based dispersion as claimed in claim 15, wherein said non-insecticidal formulation aids comprise alkyl glycosides, such as alkyl polyglycosides and/or alkyl polyglucosides (alkyl polysaccharides), such as an aqueous solution of alkyl polyglucosides based on natural fatty alcohol C₈-C₁₄ (Glucopon® 650 EC), C₈₋₁₀ alkyl polyglycoside (D.P.=1.7) ca. 70% (Agnique® PG 8107-BL), alkyl polyglucoside and phosphate ester, 50% in water (TRITON™ CG-50) and combinations thereof.

22) The Pymetrozine oil dispersion as claimed in claim 15, wherein said end-use dispersibility stabilizer/compatibilizer comprises, tertiary amine, alkyl amine such as, triethylamine, triethanolamine, N,N-diisopropylethylamine, butylamine.

23) The Pymetrozine oil dispersion as claimed in any one of claims 16-22, wherein said end-use dispersibility stabilizer/compatibilizer comprises between about 0.01-about 1% tertiary amine, such as, triethylamine, triethanolamine, N,N-diisopropylethylamine, butylamine and combinations thereof.

24) The Pymetrozine oil-based dispersion concentrate as claimed in claim 15, wherein the Pymetrozine is not pre-hydrated and said oil-based liquid carrier is a vegetable oil or a derivative thereof such as alkyl esters exemplified by methyl Soyate, rapeseed oil or alkyl ester thereof, olive oil, castor oil, rape oil, corn oil, cottonseed oil, sunflower oil, palm methyl ester oil, methyl oleate, methyl linoleate, methyl linolenate, methyl stearate, methyl palmitate and mixtures thereof, wherein said oil-based liquid carrier is characterized by a content of mineral and/or paraffin-based oils based on the weight of the complete dispersion composition selected from the group of:
a) less than 5% w/w;
b) less than 4% w/w;
c) less than 3% w/w;
d) less than 2% w/w/;
e) less than 1% w/w;
f) less than 0.5% w/w; and
g) 0% w/w.

25) The Pymetrozine oil-based dispersion concentrate as in claim 15, wherein said oil-based liquid carrier is a vegetable oil or a derivative thereof, characterized by a content of less than 5% w/w mineral and/or paraffin-based oils based on the weight of the dispersion wherein the Pymetrozine is not pre-hydrated and wherein the Pymetrozine oil-based dispersion concentrate is characterised by a total content of water based on the weight of the dispersion concentrate selected from the group of:
a) less than 4% w/w;
b) less than 3% w/w;
c) less than 2% w/w/;
d) less than 1% w/w;
e) less than 0.5% w/w; and
f) greater than 0% w/w.

26) The Pymetrozine oil dispersion as claimed in claim 15, wherein said non-insecticidal formulation aids comprise a mixture of anionic surfactants,
a) phosphate/phosphonate-based anionic surfactant, such as phosphate esters (mixtures of mono, and di-ester, free alcohol and phosphoric acid), alkyl phosphonic acids, phosphate esters of fatty alcohols, phosphate esters of ethoxylated fatty alcohols, and alkoxylated/ethoxylated phosphate esters, alkyl phosphonic acids, and
b) sulphate/sulphonate-based anionic surfactant, such as alkyl and olefin sulfonates comprising hydrophobic alkyl chain and an anionic sulfonic acid group, sulfate esters from sulfonation of fatty alcohols and alcohol ethoxylates, branched alkylbenzene (C₁₁₋₁₃) sulfonate, calcium salt.

27) The Pymetrozine oil dispersion as claimed in claim 15, characterized in that emulsifier comprises one or more of oleic acid, oleic acid polyoxyethylene ether, alkylphenol polyoxyethylene ether, castor oil polyoxyethylene ether or fatty alcohol polyoxyethylene ether, a co-polymer PEG poly-iso-butenyl anhydride-tall oil fatty acid, alkoxylated fatty alcohols, ethoxylated fatty alcohols.

28) The Pymetrozine oil dispersion as claimed in claim 15 or 16, characterized in that the thickener comprises one or more of magnesium aluminium silicate, organic bentonite, organic derivative of a hectorite clay, silicon dioxide, fumed or colloidal silica.

29) The Pymetrozine oil dispersion as claimed in claim 15 or 16, characterized in that the end-use dispersibility stabilizer/compatibilizer comprises one or more of triethylamine, triethanolamine, acetic acid or phosphoric acid.

30) The Pymetrozine oil dispersion as in claim 15, characterized in that the oil-based liquid carrier comprises vegetable oil or derivative thereof, such as, corn oil, soybean oil, fatty acid alkyl esters such as, alkyl oleate methyl oleate, methyl soyate, methyl linoleate, Methyl linolenate, methyl stearate, methyl palmitate, cottonseed oil and alkyl esters of vegetable oils.

31) The Pymetrozine oil dispersion as claimed in claim 15, comprising Pymetrozine, alkyl polyglycosides, anionic surfactant, and vegetable oil or a derivative thereof characterized by a content of water based on the weight of the dispersion concentrate selected from the group of:
a) less than about 4% w/w;
b) less than about 3% w/w;
c) less than about 2% w/w/;
d) less than about 1% w/w;
e) less than about 0.5% w/w; and
f) between greater than 0% and about 0.4% w/w.

32) The pourable, storage stable concentrated Pymetrozine oil dispersion composition, as claimed in claim 15, comprising
a) Pymetrozine,
b) at least one non-insecticidal formulation aid selected from
i) alkyl polysaccharide;
ii) emulsifier;
iii) alkoxylated adjuvant;
iv) combinations of i) and ii);
v) combinations of i) and iii);
vi) combinations of ii) and iii); and
vii) combinations of i), and ii) and iii);
c) at least one non-insecticidal formulation aid selected from anionic surfactants,
d) at least one non-insecticidal formulation aid selected from tertiary amines,
e) at least one oil-based liquid carrier selected from vegetable oils or derivatives thereof.

33) The pourable, storage stable concentrated Pymetrozine oil dispersion composition as claim 15, comprising
a) solid particulate Pymetrozine,
b) at least one non-insecticidal formulation aid selected from alkyl polyglycosides and/or alkyl polyglucosides;
c) triethylamine
d) at least one non-insecticidal formulation aid selected from anionic surfactants
e) at least one oil-based liquid carrier.

34) The pourable, storage stable concentrated Pymetrozine oil dispersion composition as claimed in claim 15, comprising,
a) anionic surfactant in salt or acid form selected from,
i) linear or branched alkyl phosphate ester;
ii) ethoxylated phosphate ester;
iii) phosphate ester with aromatic base;
iv) alkyl phenoxy polyethyl ester of phosphoric acid;
v) fatty alcohol polyglycol ether phosphate;
vi) linear or branched alkyl aryl sulfonate;
vii) linear or branched alkylbenzene sulfonate;
viii) alkane sulfonate;
ix) olefin sulfonate;
x) alkyl ether sulfonate
xi) sulfo-fatty acid;
xii) alkyl sulfate;
xiii) fatty alcohol ether sulfate;
xiv) alkyl benzene sulfonate calcium salt phosphate ester, and
xv) combinations thereof,
b) alkyl polysaccharide, such as alkylpolyglycoside, and/or alkyl polyglucoside,
c) alcohol or ester or alkyl phenol alkoxylate selected from the group of
i) alkoxylated C₆-C₂₄ alcohol;
ii) alkoxylated C₆-C₂₄ alkyl phenol;
iii) alkoxylated C₆-C₂₄ carboxylic acid;
iv) alkyl-polyoxyethylene alkanoate;
d) at least 0.5% w/w water, and
e) a vegetable oil-based carrier,
wherein the composition contains less than 5% w/w in total by weight of the oil dispersion, of methanol, ethanol, propanol, isopropanol, butanol, isobutanol, t-butanol, cyclohexanol, 2-Ethyl Hexanol, alkylbenzene, tetrahydrofurfuryl alcohol, ethylene glycol, glycerol, methyl acetate, ethyl acetate, ethyl lactate, butyrolactone, gamma butyrolactone, ethylene carbonate, propylene carbonate, acetonitrile, dimethyl sulphoxide, dimethylformamide, dimethylacetamide, N-methyl-2-pyrrolidone, N-octyl-2-pyrrolidone, N-decyl-2-pyrrolidone, acetone, butanone, methyl isobutyl ketone, methyl propyl ketone, acetophenone, cyclohexanone, methylene chloride, trichloromethane, trichloroethane, tetrahydrofuran, diethylether, 1,2-dimethoxyethane, dioxane, methyl-tert.-butylether, ethanolamine, pyridine, chlorobenzene, toluene, xylene or tetramethyl urea, wherein less than 5% w/w is between essentially absent and less than 5% w/w.

35) The pourable, storage stable concentrated Pymetrozine oil dispersion composition as claimed in claim 32, comprising between about 0.01-about 1% of tertiary amine, such as, triethylamine, triethanolamine, N,N-diisopropylethylamine, butylamine or combinations thereof as end-use dispersibility stabilizer/compatibilizer.

36) The pourable, storage stable concentrated Pymetrozine oil dispersion composition as claimed in any one of claims 15-35 comprising one or more of magnesium aluminium silicate, organic bentonite, organic derivative of a hectorite clay, silica, fumed or colloidal silicon dioxide.

37) The pourable, storage stable concentrated Pymetrozine oil dispersion composition as claimed in any one of claims 15-36 comprising additional pesticidal compound.

38) The pourable, storage stable concentrated Pymetrozine oil dispersion composition as claimed in claim 37 wherein the combined percentage content of Pymetrozine and said pesticide compound is no greater than 45% w/w of the concentrated Pymetrozine oil-based dispersion composition.

39) The pourable, storage stable concentrated Pymetrozine oil-based dispersion composition as claimed in claim 15 comprising,
a) at least one alkyl polyglycoside or alkyl polyglucosides (APG)
b) at least one alkoxylated fatty, branched or linear alcohol,
c) at least on anionic surfactant selected from phosphate, phosphonate, sulphate, sulphonate, sulfosuccinate or combinations thereof,
d) at least one tertiary amine such as triethylamine,
e) greater than 0% and less than 3% w/w water.

40) The pourable, storage stable concentrated Pymetrozine oil-based dispersion composition as claimed in claim 15 comprising, between 2% and equal or less than 35% w/w pymetrozine.

41) The pourable, storage stable concentrated Pymetrozine oil-based dispersion composition as claimed in any one of claims 15-40 which is packaged in a container which is a suitable container characterized in that it is sufficiently impermeable to moisture, sunlight, or both, such that the quality of the pourable, storage stable concentrated Pymetrozine oil-based dispersion composition contained therein, is maintained during storage and the end-use dispersibility of the concentrated Pymetrozine oil-based dispersion composition is not noticeably affected due to storage of the packaged pourable, storage stable concentrated Pymetrozine oil-based dispersion composition at temperatures above 25° C., for more than a week, wherein said container is characterized by being formed from materials which provide a barrier to moisture and/or to light with wavelengths between 250 to 400 nm and said container is sealed by closure system that does not impair the level of impermeability to moisture and/or light afforded by the materials from which they are formed, wherein sufficiently impermeable to moisture, sunlight, or both, is such that the percentage water content of the contained non-aqueous pesticidal suspension composition does not increase by to more than 5% w/w over a period of storage at 54° C. for two weeks and/or over a period of storage for one month at 40° C. and 75% RH, and characterized in that the pymetrozine content of the non-aqueous pesticidal suspension composition packaged in the container is not degraded by more than 5% w/w when stored exposed to sunlight or artificial light with wavelengths between 250 to 400 nm over the storage period.

42) The non-aqueous pesticidal suspension composition claimed in claim 1 wherein the composition is a pourable, storage stable concentrated pesticidal oil-based dispersion composition, adapted for end-use dispersion in an excess of an aqueous media after storage, wherein the concentrated pesticidal oil-based dispersion composition is characterized by low viscosity, and stable water dispersibility and comprising between greater than 0% up to about 46% w/w pesticide compound by weight of the composition and characterized by the following composition content by weight of the composition, Pymetrozine, between greater than 0% and equal or less than 32%, non-insecticidal formulation aids between 0.2% and equal or less than 30%, wherein said non-insecticidal formulation aids are selected from the group of,
a) alkoxylated adjuvant, between 1% and about 10%;
b) anionic surfactant, between 1% and about 10%;
c) alkyl glycoside (saccharide), between 1% and 7%;
d) thickener and/or rheological agent, between 0.1 and about 4%;
e) end-use dispersibility stabilizer/compatibilizer between 0.01 and about 0.5%;
f) any combinations of a) b) c) d) and e); and
g) a combination of all of a) b) c) d) and e),
combined with an oil-based liquid carrier, preferably, a vegetable oil-based liquid carrier, characterized in that the total content of water in the concentrated pesticidal oil-based dispersion is compounded and packaged so as to be maintained at less than about 5% by weight of the complete concentrated dispersion, wherein the concentrated pesticidal oil-based dispersion composition is optionally packaged in a suitable container characterized in being capable to maintain the ease of end-use dispersion of the concentrated pesticidal oil-based dispersion composition over periods of storage.

43) The pourable, storage stable concentrated insecticidal oil-based dispersion composition as claimed in claim 42, wherein said alkoxylated adjuvant is selected from,
i) alkoxylated carboxylic acid esters;
ii) ethoxylated carboxylic acid esters;
iii) alkoxylated primary or secondary linear or branched alcohols;
iv) ethoxylated primary or secondary linear or branched alcohols;
v) alkoxylated fatty acids;
vi) ethoxylated fatty acids;
vii) alkoxylated fatty alcohols;
viii) ethoxylated fatty alcohols; and
ix) any and all combinations of two, or more thereof.

44) The pourable, storage stable concentrated insecticidal oil-based dispersion composition as claimed in claim 42, wherein said anionic surfactant is selected from,
a) phosphate or phosphonate-based surfactants;
b) sulphate or sulphonate-based surfactants; and
c) combination of phosphate or phosphonate-based surfactant and sulphate or sulphonate-based surfactants.

45) The pourable, storage stable concentrated insecticidal oil-based dispersion composition as claimed in claim 44, wherein said phosphate or phosphonate-based surfactant is selected from,
a) anionic phosphate esters;
b) mixtures of mono, and di-ester, free alcohol and phosphoric acid;
c) alkyl and/or aryl phosphonic acids;
d) alkylaryl phosphonic acids;
e) phosphate esters of fatty alcohols;
f) phosphate esters of ethoxylated fatty alcohols;
g) alkoxylated phosphate esters;
h) Phosphate or phosphonate-based surfactants selected from
i) ethoxylated phosphate esters; alkyl aryl phosphates;
j) alcohol ethoxylate Phosphates;
k) alkyl phenol ethoxylate Phosphate;
l) alkyl amine Phosphate; and
m) any and all combinations thereof.

46) The pourable, storage stable concentrated insecticidal oil-based dispersion composition as claimed in claim 45, wherein said phosphate or phosphonate-based surfactant is selected from,
a) lsotridecyl polyoxethyl phosphoric acid mono/diester;
b) tridecyl polyglycol ether phosphate;
c) alkyl phenoxy polyethyl ester of phosphoric acid.

47) The pourable, storage stable concentrated insecticidal oil-based dispersion composition as claimed in claim 44, wherein said sulphate or sulphonate-based surfactant is selected from,
a) branched or linear alkyl benzene sulfonates;
b) alkane sulfonates;
c) olefin sulfonates;
d) alkyl ether sulfonates;
e) glycerol ether sulfonates,
f) methyl ester sulfonates;
g) alkyl ester sulfonates;
h) sulfofatty acids;
i) alkyl sulphates;
j) fatty alcohol ether sulphates;
k) glycerol ether sulphates;
l) fatty acid ether sulphates;
m) hydroxy mixed ether sulphates;
n) monoglyceride (ether) sulphate,
o) fatty acid amide (ether) sulphate;
p) mono and dialkyl sulfosuccinate;
q) dialkyl (EO) sulfosuccinate;
r) mono and dialkyl sulfosuccinamates;
s) sulfo-triglycerides;
t) alkyl oligoglucoside sulphates;
u) alkyl ether sulphates;
v) alkyl naphthalene sulphonic acids (salts);
w) naphthalene sulphonic acid formaldehyde condensation products(salts);
x) salts of condensation products of naphthalene sulphonic acid, phenol sulphonic acid and formaldehyde,
y) alkali metal salts of alkyl naphthalene sulphonic acids;
z) sodium dodecylbenzenesulfonate (SDBS);
aa) sodium lauryl sulfate
bb) sodium lauryl ether sulfate
cc) salts of naphthalene sulphonic acid-formaldehyde condensation products;
dd) mono- and diesters of sulfosuccinate metal salts with branched or linear alcohols;
ee) sodium dioctyl sulfosuccinate;
ff) sodium cocoyl isethionate
gg) allyl/alkyl or alcohol, polyoxyalkylene sulfate;
hh) alkyl Succinate sulphate; and
ii) any and all combinations thereof.

48) The pourable, storage stable concentrated insecticidal oil-based dispersion composition as claimed in claim 47, wherein said sulphate or sulphonate-based surfactant is selected from,
a) branched or linear alkyl benzene sulphonate;
b) calcium alkyl benzene sulphonate;
c) alkyl (C₁₀₋₁₆) benzenesulfonic acid, (calcium salt);
d) dodecyl benzene sulfonate;
e) branched alkylbenzene (C₁₁₋₁₃) sulfonate, (calcium salt);
f) sodium lauryl sulfate
g) sodium lauryl ether sulfate; and
h) any and all combinations thereof.

49) The pourable, storage stable concentrated insecticidal oil-based dispersion composition as claimed in claim 42, wherein said alkyl glycoside is selected from,
a) alkyl glucoside;
b) alkyl monoglucoside;
c) alkylpolyglucoside;
d) alkyl monoglycoside;
e) alkylpolyglycoside;
f) alkyl polysaccharide and
g) any combination thereof.

50) The pourable, storage stable concentrated insecticidal oil-based dispersion composition as claimed in claim 42, wherein said thickener and/or rheological additive is selected from,
a) organic derivative of a hectorite clay;
b) vegetable oil derivatives such as blend of vegetable oil base;
c) natural oils;
d) fumed silicas;
e) colloidal silicon dioxide;
f) diamide wax;
g) polyamide wax;
h) amide modified hydrogenated vegetable oil;
i) modified hydrogenated castor oil;
j) hydrogenated castor oil;
k) urea-modified, non-polar polyamide;
l) polyhydroxy carboxylic acid amides;
m) modified urea;
n) over based calcium sulfate complex;
o) smectite clay; and
p) combinations of any thereof.

51) The pourable, storage stable concentrated insecticidal oil-based dispersion composition as claimed in claim 42, wherein said end-use dispersibility stabilizer/compatibilizer is an amine selected from,
a) tertiary alkyl amine
b) triethylamine;
c) N,N-diisopropylethylamine;
d) butylamine
e) Triethanolamine; and
f) any and all combinations of two or more thereof.

52) The pourable, storage stable concentrated insecticidal oil-based dispersion composition as claimed in claim 42, wherein said vegetable oil-based liquid carrier is selected from,
a) vegetable oil;
b) alkylated vegetable oil
c) methyl soyate;
d) palm methyl ester oil;
e) methyl oleate;
f) methyl linoleate;
g) methyl linolenate;
h) methyl stearate;
i) methyl palmitate; and
j) combinations thereof.

53) The pourable, storage stable concentrated insecticidal oil-based dispersion composition as claimed in claim 42, comprising
a) solid particulate Pymetrozine, between greater than 0% and equal or less than 32% w/w,
b) alkoxylated adjuvant, between about 1% and 10% w/w,
c) anionic phosphate or phosphonate-based surfactant between about 1% and 7%,
d) anionic sulphate or sulphonate-based surfactant between about 0.5% and about 4% w/w,
e) alkyl glycoside (alkyl saccharide), between about 1% and about 10% w/w,
f) thickener and/or rheological agent, between 0.1 and about 3% w/w,
g) end-use dispersibility stabilizer/compatibilizer between 0.01 and about 1% w/w, and
h) vegetable oil-based liquid carrier.

54) The pourable, storage stable concentrated pesticidal oil-based dispersion composition as claimed in claim 42, adapted for end-use dispersion in an excess of an aqueous media after storage, characterized by low viscosity, and stable water dispersibility comprising,
a) solid particulate non-pre-hydrated Pymetrozine,
b) PEG poly isobutenyl anhydride—tall oil fatty acid copolymer (Atlox 4914),
c) isotridecyl polyoxethyl phosphoric acid mono/diester, acid form (Hostaphat® 1306),
d) organic derivative of a hectorite clay (Bentone SD-3)
e) triethylamine;
f) mixture of D-Glucopyranose, oligomeric, C₁₀₋₁₆-alkyl glycosides and
D-Glucopyranose, oligomeric, decyl octyl glycosides (Glucopon® 650 EC),
g) methyl soyate
wherein the content of water in the concentrated Pymetrozine oil-based dispersion is between greater than 0 and less than 5% by weight of the complete concentrated pesticidal oil-based dispersion.

55) The pourable, storage stable concentrated pesticidal oil-based dispersion composition as claimed in claim 42, adapted for end-use dispersion in an excess of an aqueous media after storage, characterized by low viscosity, and stable water dispersibility comprising,
a) solid particulate Pymetrozine,
b) flonicamid
c) PEG poly iso-butenyl anhydride—tall oil fatty acid copolymer (Atlox 4914),
d) lsotridecyl polyoxethyl phosphoric acid mono/diester, acid form (Hostaphat® 1306),
e) organic derivative of a hectorite clay (Bentone SD-3)
f) triethylamine;
g) mixture of D-Glucopyranose, oligomeric, C₁₀₋₁₆-alkyl glycosides and
D-Glucopyranose, oligomeric, decyl octyl glycosides (Glucopon® 650 EC),
h) methyl soyate
wherein the content of water in the concentrated oil-based dispersion is less than 5% by weight of the complete dispersion.

56) The pourable, storage stable concentrated pesticidal oil-based dispersion composition as claimed in claim 42, adapted for end-use dispersion in an excess of an aqueous media after storage, characterized by low viscosity, and stable water dispersibility comprising,
a) Pymetrozine,
b) copolymer, polyethylene glycol and 12-hydroxystearic acid (Atlox™ 4912),
c) lsotridecyl polyoxethyl phosphoric acid mono/diester, acid form (Hostaphat® 1306),
d) organic derivative of a hectorite clay (Bentone SD-3)
e) triethylamine;
f) mixture of D-Glucopyranose, oligomeric, C₁₀₋₁₆-alkyl glycosides and
D-Glucopyranose, oligomeric, decyl octyl glycosides (Glucopon® 650 EC),
g) oil-based carrier.

57) The pourable, storage stable concentrated pesticidal oil-based dispersion composition as claimed in claim 42, adapted for end-use dispersion in an excess of an aqueous media after storage, characterized by low viscosity, and stable water dispersibility comprising,
a) Pymetrozine,
b) Flonicamid,
c) copolymer, polyethylene glycol and 12-hydroxystearic acid (Atlox™ 4912),
d) lsotridecyl polyoxethyl phosphoric acid mono/diester, acid form (Hostaphat® 1306),
e) organic derivative of a hectorite clay (Bentone SD-3)
f) triethylamine;
g) mixture of D-Glucopyranose, oligomeric, C₁₀₋₁₆-alkyl glycosides and
D-Glucopyranose, oligomeric, decyl octyl glycosides (Glucopon® 650 EC),
h) Oil-based carrier.

58) The pourable, storage stable concentrated pesticidal oil-based dispersion composition as claimed in claim 42, adapted for end-use dispersion in an excess of an aqueous media after storage, characterized by low viscosity, and stable water dispersibility comprising,
a) Pymetrozine,
b) copolymer, polyethylene glycol and 12-hydroxystearic acid as alkoxylated adjuvant,
c) lsotridecyl polyoxethyl phosphoric acid mono/diester, acid form as anionic phosphate/phosphonate-based surfactant,
d) branched or linear alkyl benzene sulphonate as anionic sulphate or sulphonate-based surfactant,
e) organic derivative of a hectorite clay as rheology modifying agent,
f) triethylamine as end-use dispersibility stabilizer/compatibilizer,
g) mixture of D-Glucopyranose, oligomeric, C₁₀₋₁₆-alkyl glycosides and
D-Glucopyranose, oligomeric, decyl octyl glycosides as alkyl glycoside,
h) oil-based carrier.

59) The pourable, storage stable concentrated pesticidal oil-based dispersion composition as claimed in claim 42, adapted for end-use dispersion in an excess of an aqueous media after storage, characterized by low viscosity, and stable water dispersibility comprising,
a) Pymetrozine,
b) Flonicamid,
c) copolymer, polyethylene glycol and 12-hydroxystearic acid as alkoxylated adjuvant,
d) isotridecyl polyoxethyl phosphoric acid mono/diester, acid form as anionic phosphate/phosphonate-based surfactant,
e) branched or linear alkyl benzene sulphonate as anionic sulphate or sulphonate-based surfactant,
f) organic derivative of a hectorite clay as rheology modifying agent,
g) triethylamine as end-use dispersibility stabilizer/compatibilizer,
h) mixture of D-Glucopyranose, oligomeric, C₁₀₋₁₆-alkyl glycosides and
D-Glucopyranose, oligomeric, decyl octyl glycosides as alkyl glycoside,
i) Oil-based carrier.

60) The non-aqueous pesticidal suspension composition claimed in claim 1 wherein the composition is a concentrated pesticidal oil-based dispersion composition, comprising,
a) Pymetrozine,
b) copolymer, polyethylene glycol and 12-hydroxystearic acid as alkoxylated adjuvant,
c) tridecyl polyglycol ether phosphate as anionic phosphate/phosphonate-based surfactant,
d) alkyl (C₁₀₋₁₆) benzenesulfonic acid, salt as anionic sulphate or sulphonate-based surfactant,
e) alkoxylated branched C₈₋₁₈, alcohols as alkoxylated adjuvant,
f) rheology modifying agent,
g) oil-based carrier.

61) The non-aqueous pesticidal suspension composition claimed in claim 1 wherein the composition is a concentrated pesticidal oil-based dispersion composition, comprising,
a) Pymetrozine,
b) Flonicamid,
c) copolymer, polyethylene glycol and 12-hydroxystearic acid as alkoxylated adjuvant,
d) tridecyl polyglycol ether phosphate as anionic phosphate/phosphonate-based surfactant,
e) branched or linear alkyl benzene sulphonate as anionic sulphate or sulphonate-based surfactant,
f) alkoxylated branched C₈₋₁₈, alcohols as alkoxylated adjuvant,
g) rheology modifying agent,
h) oil-based carrier.

62) The non-aqueous pesticidal suspension composition claimed in claim 1 wherein the composition is a concentrated pesticidal oil-based dispersion composition, comprising,
A. Pymetrozine,
B. Flonicamid,
C. copolymer, polyethylene glycol and 12-hydroxystearic acid as alkoxylated adjuvant,
D. tridecyl polyglycol ether phosphate as anionic phosphate/phosphonate-based surfactant,
E. alkyl (C₁₀₋₁₆) benzenesulfonic acid, salt as anionic sulphate or sulphonate-based surfactant,
F. alkoxylated branched C₈₋₁₈, alcohols as alkoxylated adjuvant,
G. rheology modifying agent
H. oil-based carrier.

63) The concentrated pesticidal oil-based dispersion composition as claimed in claim 60, comprising,
a) Pymetrozine,
b) copolymer, polyethylene glycol and 12-hydroxystearic acid as alkoxylated adjuvant,
c) tridecyl polyglycol ether phosphate as anionic phosphate/phosphonate-based surfactant,
d) alkyl (C₁₀₋₁₆) benzenesulfonic acid, salt (anionic sulphate or sulphonate-based surfactant)
e) alkoxylated branched C₈₋₁₈, alcohols as alkoxylated adjuvant,
f) rheology modifying agent,
g) triethylamine as end-use dispersibility stabilizer/compatibilizer,
h) alkyl polyglycosides as alkyl glycoside,
i) oil-based carrier.

64) The non-aqueous pesticidal suspension composition claimed in claim 1 wherein the composition is a concentrated pesticidal oil-based dispersion composition, comprising,
a) Pymetrozine,
b) Flonicamid,
c) copolymer, polyethylene glycol and 12-hydroxystearic acid as alkoxylated adjuvant,
d) tridecyl polyglycol ether phosphate as anionic phosphate/phosphonate-based surfactant,
e) alkyl (C₁₀₋₁₆) benzenesulfonic acid, salt as anionic sulphate or sulphonate-based surfactant,
f) alkoxylated branched C₈₋₁₈, alcohols as alkoxylated adjuvant,
g) rheology modifying agent
h) triethylamine as end-use dispersibility stabilizer/compatibilizer,
i) alkyl polyglycosides as alkyl glycoside,
j) oil-based carrier.

65) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine,
b) PEG poly iso butenyl anhydride—tall oil fatty acid copolymer (Atlox 4914),
c) polyethylene glycol tridecyl ether phosphate (Rhodafac® RS 610),
d) organic derivative of a hectorite clay (Bentone SD-3),
e) triethylamine,
f) mixture of D-Glucopyranose, oligomeric, C₁₀₋₁₆-alkyl glycosides and
D-Glucopyranose, oligomeric, decyl octyl glycosides (Glucopon® 650 EC),
g) methyl soyate
wherein the content of water in the concentrated oil-based dispersion is less than 5% by weight of the complete dispersion.

66) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine,
b) flonicamid
c) PEG polyisobutenyl anhydride—tall oil fatty acid copolymer (Atlox 4914),
d) polyethylene glycol tridecyl ether phosphate (Rhodafac® RS 610)
e) organic derivative of a hectorite clay (Bentone SD-3)
f) triethylamine;
g) mixture of D-Glucopyranose, oligomeric, C₁₀₋₁₆-alkyl glycosides and
D-Glucopyranose, oligomeric, decyl octyl glycosides (Glucopon® 650 EC),
h) methyl soyate
wherein the content of water in the concentrated oil-based dispersion composition is less than 5% by weight of the complete dispersion.

67) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine,
b) PEG poly iso butenyl anhydride—tall oil fatty acid copolymer (Atlox 4914),
c) tridecyl polyglycol ether phosphate (SERVOXYL VPDZ),
d) organic derivative of a hectorite clay (Bentone SD-3)
e) triethylamine;
f) C₈/C₁₀ alkyl polyglycoside (Agnique® PG 8107),
g) methyl soyate
wherein the content of water in the concentrated oil-based dispersion composition is less than 5% by weight of the complete dispersion.

68) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine,
b) flonicamid
c) PEG polyisobutenyl anhydride—tall oil fatty acid copolymer (Atlox 4914),
d) tridecyl polyglycol ether phosphate (SERVOXYL VPDZ)
e) organic derivative of a hectorite clay (Bentone SD-3)
f) triethylamine;
g) C₈/C₁₀ alkyl polyglycoside (Agnique PG 8107),
h) methyl soyate
wherein the content of water in the concentrated oil-based dispersion is less than 5% by weight of the complete dispersion.

69) The non-aqueous pesticidal suspension composition claimed in claim 1 wherein the composition is a concentrated pesticidal oil-based dispersion composition, comprising,
a) Pymetrozine,
b) sorbitan laurate, sorbitan monolaurate (SPAN 20),
c) poly(oxy-1,2-ethanediyl), α-isotridecyl-ω-hydroxy-, phosphate,
d) alkoxylated branched C₈₋₁₈, alcohols (Imbentin) e) silicon dioxide f) oil-based carrier.

70) The composition as claimed in any one of claims 61-69, comprising at least one branched or linear alkyl benzene sulphonate anionic surfactant.

71) The non-aqueous pesticidal suspension composition claimed in claim 1 wherein the composition is a concentrated pesticidal oil-based dispersion composition, comprising,
a) solid particulate Pymetrozine,
b) Sorbitan laurate, Sorbitan monolaurate (SPAN 20),
c) tristyrylphenol ether sulfate, salt,
d) alkoxylated branched C₈₋₁₈, alcohols (Imbentin)
e) silicon dioxide
f) oil-based carrier.

72) The non-aqueous pesticidal suspension composition claimed in claim 1 wherein the composition is a concentrated pesticidal oil-based dispersion composition, comprising,
a) Pymetrozine,
b) Flonicamid,
c) Sorbitan laurate, Sorbitan monolaurate (SPAN 20),
d) tristyrylphenol ether sulfate, salt,
e) alkoxylated branched C₈₋₁₈, alcohols (Imbentin)
f) silicon dioxide
g) oil-based carrier.

73) The composition as claimed in any one of claims 71-72, comprising, at least one phosphate and/or phosphonate-based anionic surfactant.

74) The non-aqueous pesticidal suspension composition claimed in claim 1 wherein the composition is a concentrated pesticidal oil-based dispersion composition, comprising,
a) Pymetrozine,
b) Sorbitan laurate, Sorbitan monolaurate (SPAN 20),
c) poly(oxy-1,2-ethanediyl), α-isotridecyl-ω-hydroxy-, phosphate,
d) alkoxylated branched C₈₋₁₈, alcohols (Imbentin)
e) triethylamine;
f) alkyl polyglycosides,
g) silicon dioxide
h) oil-based carrier.

75) The non-aqueous pesticidal suspension composition claimed in claim 1 wherein the composition is a concentrated pesticidal oil-based dispersion composition, comprising,
a) solid particulate Pymetrozine,
b) Sorbitan laurate, Sorbitan monolaurate (SPAN 20),
c) poly(oxy-1,2-ethanediyl), α-isotridecyl-ω-hydroxy-, phosphate,
d) alkoxylated branched C₈₋₁₈, alcohols (Imbentin)
e) triethylamine;
f) alkyl polyglycosides,
g) silicon dioxide,
h) oil-based carrier.

76) The composition as claimed in any one of claims 74-75, comprising at least one branched or linear alkyl benzene sulphonate anionic surfactant.

77) The non-aqueous pesticidal suspension composition claimed in claim 1 wherein the composition is a concentrated pesticidal oil-based dispersion composition, comprising,
a) solid particulate Pymetrozine,
b) Sorbitan laurate, Sorbitan monolaurate (SPAN 20),
c) tristyrylphenol ether sulfate, salt,
d) alkoxylated branched C₈₋₁₈, alcohols (Imbentin) triethylamine;
e) alkyl polyglycosides,
f) triethylamine;
g) silicon dioxide
h) oil-based carrier.

78) The composition as claimed in claim 77, comprising, at least one phosphate and/or phosphonate-based anionic surfactant.

79) The non-aqueous pesticidal suspension composition claimed in claim 1 wherein the composition is a pourable, storage stable concentrated pesticidal oil-based dispersion composition, adapted for end-use dispersion in an excess of an aqueous media after a period of storage, characterized by low viscosity, and stable water dispersibility comprising,
a) Pymetrozine about 20% w/w,
b) PEG polyisobutenyl anhydride—tall oil fatty acid copolymer about 5% w/w as alkoxylated adjuvant,
c) isotridecyl polyoxethyl phosphoric acid mono/diester, acid form about 4% w/w as anionic phosphate/phosphonate-based surfactant,
d) organic derivative of a hectorite clay 0.5% as rheology modifying agent,
e) triethylamine about 0.05% w/w as end-use dispersibility stabilizer/compatibilizer,
f) C₈₋₁₀ alkyl polyglycoside 4.5% w/w as alkyl glycoside,
g) methyl soyate as vegetable oil-based liquid carrier,
wherein the content of water in the concentrated oil-based dispersion is between greater than 0.5% and less than 5% by weight of the complete dispersion.

80) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine about 20% w/w,
b) flonicamid about 10% w/w as additional pesticide compound,
c) PEG poly iso butenyl anhydride—tall oil fatty acid copolymer about 5% w/w as alkoxylated adjuvant,
d) isotridecyl polyoxethyl phosphoric acid mono/diester, acid form about 4% w/w as anionic phosphate/phosphonate-based surfactant,
e) organic derivative of a hectorite clay about 0.5% w/w as rheology modifying agent),
f) triethylamine about 0.05% w/w as end-use dispersibility stabilizer/compatibilizer,
g) C₈₋₁₀ alkyl polyglycoside 4.5% (alkyl glycoside),
h) methyl soyate (vegetable oil-based liquid carrier),
wherein the content of water in the concentrated Pymetrozine oil-based dispersion is between greater than 0.5% and less than 5% by weight of the complete dispersion.

81) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine about 20% w/w,
b) PEG polyisobutenyl anhydride—tall oil fatty acid copolymer about 5% w/w as alkoxylated adjuvant,
c) lsotridecyl polyoxethyl phosphoric acid mono/diester, acid form about 4% w/w as anionic phosphate/phosphonate-based surfactant,
d) organic derivative of a hectorite clay about 0.5% as rheology modifying agent,
e) triethylamine about 0.05% w/w as end-use dispersibility stabilizer/compatibilizer,
f) mixture of D-Glucopyranose, oligomeric, C₁₀₋₁₆-alkyl glycosides and
D-Glucopyranose, oligomeric, decyl octyl glycosides about 4.5% as alkyl glycoside,
g) methyl soyate as vegetable oil-based liquid carrier,
wherein the content of water in the concentrated oil-based dispersion is between greater than 0.5% and less than 5% by weight of the complete dispersion.

82) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine 20%,
b) flonicamid 10% w/w (pesticide compound other than Pymetrozine),
c) PEG polyisobutenyl anhydride—tall oil fatty acid copolymer 5% w/w (alkoxylated adjuvant),
d) lsotridecyl polyoxethyl phosphoric acid mono/diester, acid form 4% w/w (anionic phosphate/phosphonate-based surfactant),
e) organic derivative of a hectorite clay 0.5% (rheology modifying agent),
f) triethylamine 0.05% w/w (end-use dispersibility stabilizer/compatibilizer),
g) mixture of D-Glucopyranose, oligomeric, C₁₀₋₁₆-alkyl glycosides and
D-Glucopyranose, oligomeric, decyl octyl glycosides 4.5%,
h) methyl soyate (vegetable oil-based liquid carrier),
wherein the content of water in the concentrated Pymetrozine oil-based dispersion is between greater than 0.5% and less than 5% by weight of the complete dispersion.

83) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine about 20% w/w,
b) PEG polyisobutenyl anhydride—tall oil fatty acid copolymer about 5% w/w as alkoxylated adjuvant,
c) isotridecyl polyoxethyl phosphoric acid mono/diester, acid form about 4% w/w as anionic phosphate/phosphonate-based surfactant,
d) organic derivative of a hectorite clay about 0.5% as rheology modifying agent,
e) triethylamine about 0.05% w/w as end-use dispersibility stabilizer/compatibilizer,
f) C₈₋₁₀ alkyl polyglycoside about 4.5% w/w as alkyl glycoside,
g) methyl soyate as vegetable oil-based liquid carrier,
h) branched or linear alkyl benzene sulphonate anionic surfactant such as branched alkylbenzene (C₁₁₋₁₃) sulfonate, salt as anionic sulphate or sulphonate-based surfactant,
wherein the content of water in the concentrated Pymetrozine oil-based dispersion is between greater than 0.5% and less than 5% by weight of the complete dispersion.

84) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine about 20% w/w,
b) flonicamid about 10% w/w,
c) PEG polyisobutenyl anhydride—tall oil fatty acid copolymer about 5% w/w as alkoxylated adjuvant,
d) isotridecyl polyoxethyl phosphoric acid mono/diester, acid form about 4% w/w as anionic phosphate/phosphonate-based surfactant,
e) organic derivative of a hectorite clay 0.5% (rheology modifying agent),
f) triethylamine about 0.05% w/w as end-use dispersibility stabilizer/compatibilizer,
g) C₈₋₁₀ alkyl polyglycoside about 4.5% as alkyl glycoside,
h) methyl soyate as vegetable oil-based liquid carrier,
i) branched or linear alkyl benzene sulphonate anionic surfactant such as branched alkylbenzene (C₁₁₋₁₃) sulfonate, salt as anionic sulphate or sulphonate-based surfactant,
wherein the content of water in the concentrated oil-based dispersion is between greater than 0.5% and less than 5% by weight of the complete dispersion.

85) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine about 20% w/w,
b) PEG poly iso butenyl anhydride—tall oil fatty acid copolymer about 5% w/w as alkoxylated adjuvant,
c) isotridecyl polyoxethyl phosphoric acid mono/diester, acid form about 4% w/w as anionic phosphate/phosphonate-based surfactant,
d) organic derivative of a hectorite clay about 0.5% as rheology modifying agent,
e) triethylamine 0.05% w/w (end-use dispersibility stabilizer/compatibilizer),
f) mixture of D-Glucopyranose, oligomeric, C₁₀₋₁₆-alkyl glycosides and
D-Glucopyranose, oligomeric, decyl octyl glycosides about 4.5% as alkyl glycoside,
g) methyl soyate as vegetable oil-based liquid carrier,
h) branched or linear alkyl benzene sulphonate anionic surfactant such as, branched alkylbenzene (C₁₁₋₁₃) sulfonate, salt as anionic sulphate or sulphonate-based surfactant,
i) wherein the content of water in the concentrated oil-based dispersion is between greater than 0.5% and less than 5% by weight of the complete dispersion.

86) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine about 20% w/w,
b) flonicamid about 10% w/w,
c) PEG poly iso butenyl anhydride—tall oil fatty acid copolymer about 5% w/w as alkoxylated adjuvant,
d) isotridecyl polyoxethyl phosphoric acid mono/diester, acid form about 4% w/w as anionic phosphate/phosphonate-based surfactant,
e) organic derivative of a hectorite clay about 0.5% as rheology modifying agent,
f) triethylamine about 0.05% w/w as end-use dispersibility stabilizer/compatibilizer,
g) mixture of D-Glucopyranose, oligomeric, C₁₀₋₁₆-alkyl glycosides and
D-Glucopyranose, oligomeric, decyl octyl glycosides about 4.5% as alkyl glycoside,
h) methyl soyate as vegetable oil-based liquid carrier,
i) branched or linear alkyl benzene sulphonate anionic surfactant such as branched alkylbenzene (C₁₁₋₁₃) sulfonate, salt as anionic sulphate or sulphonate-based surfactant,
wherein the content of water in the concentrated oil-based dispersion is between greater than 0.5% and less than 5% by weight of the complete dispersion.

87) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine,
b) flonicamid (pesticide compound other than Pymetrozine), c) PEG polyisobutenyl anhydride—tall oil fatty acid copolymer as alkoxylated adjuvant,
d) isotridecyl polyoxethyl phosphoric acid mono/diester, acid form as anionic phosphate/phosphonate-based surfactant,
e) branched or linear alkyl benzene sulphonate anionic surfactant anionic sulphate or sulphonate-based surfactant,
f) organic derivative of a hectorite clay as rheology modifying agent,
g) triethylamine as end-use dispersibility stabilizer/compatibilizer,
h) mixture of D-Glucopyranose, oligomeric, C₁₀₋₁₆-alkyl glycosides and
D-Glucopyranose, oligomeric, decyl octyl glycosides (Glucopon® 650 EC),
i) methyl soyate as vegetable oil-based liquid carrier,
wherein the content of water in the concentrated oil-based dispersion is less than 5% by weight of the complete dispersion.

88) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine,
b) PEG poly iso butenyl anhydride—tall oil fatty acid copolymer as alkoxylated adjuvant,
c) isotridecyl polyoxethyl phosphoric acid mono/diester, acid form as anionic phosphate/phosphonate-based surfactant,
d) branched or linear alkyl benzene sulphonate anionic surfactant as anionic sulphate or sulphonate-based surfactant,
e) organic derivative of a hectorite clay as rheology modifying agent,
f) triethylamine as end-use dispersibility stabilizer/compatibilizer,
g) mixture of D-Glucopyranose, oligomeric, C₁₀₋₁₆-alkyl glycosides and
D-Glucopyranose, oligomeric, decyl octyl glycosides as alkyl glycoside,
h) methyl soyate as vegetable oil-based liquid carrier,
wherein the content of water in the concentrated oil-based dispersion is less than 5% by weight of the complete dispersion.

89) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine,
b) flonicamid,
c) PEG polyisobutenyl anhydride—tall oil fatty acid copolymer as alkoxylated adjuvant),
d) lsotridecyl polyoxethyl phosphoric acid mono/diester, acid form as anionic phosphate/phosphonate-based surfactant,
e) branched or linear alkyl benzene sulphonate anionic surfactant as anionic sulphate or sulphonate-based surfactant,
f) organic derivative of a hectorite clay as rheology modifying agent,
g) triethylamine as end-use dispersibility stabilizer/compatibilizer,
h) mixture of D-Glucopyranose, oligomeric, C₁₀₋₁₆-alkyl glycosides and
D-Glucopyranose, oligomeric, decyl octyl glycosides as alkyl glycoside,
i) methyl soyate as vegetable oil-based liquid carrier,
wherein the content of water in the concentrated oil-based dispersion is less than 5% by weight of the complete dispersion.

90) The non-aqueous pesticidal suspension composition claimed in claim 1 wherein the composition is a pourable, storage stable concentrated pesticidal oil-based dispersion composition, adapted for end-use dispersion in an excess of an aqueous media after storage, characterized by low viscosity, and stable water dispersibility comprising,
a) Pymetrozine,
b) PEG polyisobutenyl anhydride—tall oil fatty acid copolymer (alkoxylated adjuvant),
c) lsotridecyl polyoxethyl phosphoric acid mono/diester, acid form (anionic phosphate/phosphonate-based surfactant),
d) branched or linear alkyl benzene sulphonate anionic surfactant (anionic sulphate or sulphonate-based surfactant),
e) organic derivative of a hectorite clay (rheology modifying agent),
f) triethylamine as end-use dispersibility stabilizer/compatibilizer),
g) mixture of D-Glucopyranose, oligomeric, C₁₀₋₁₆-alkyl glycosides and
D-Glucopyranose, oligomeric, decyl octyl glycosides (alkyl glycoside),
h) methyl soyate (vegetable oil-based liquid carrier),
wherein the content of water in the concentrated Pymetrozine oil-based dispersion is less than 5% by weight of the complete dispersion.

91) The pourable, storage stable concentrated pesticidal oil-based dispersion composition, adapted for end-use dispersion in an excess of an aqueous media after storage as claimed in any one of claims 42-90, adapted for end-use dispersion in an excess of an aqueous media after storage, wherein said adaptation comprises packaging an amount of said concentrated composition required for providing between 50 and 500 litres of diluted end-use dispersion in aqueous media, in a container together with instructive means for dispersing and diluting the concentrated pesticidal oil-based dispersion composition in in an excess of aqueous media, wherein said container is impermeable to both moisture and light such that the % water content of the contained concentrated pesticidal oil-based dispersion composition does not increase by more than 5% w/w after a period of storage in the container at 40° C./75% RH for a month and the Pymetrozine content is not degraded by more than 5% w/w when the packaged concentrated pesticidal oil-based dispersion composition is stored exposed to sunlight and/or artificial light with wavelengths between 250 nm to 400 nm.

92) The non-aqueous pesticidal suspension composition claimed in claim 12 wherein the composition is a packaged, storage stable concentrated pesticidal oil-based dispersion composition adapted for end-use dispersion in an excess of an aqueous media after storage comprising,
a) Pymetrozine,
b) alkoxylated adjuvant,
c) anionic surfactant selected from the group consisting of,
i) anionic sulphate or sulphonate-based surfactant;
ii) anionic phosphate/phosphonate-based surfactant; and
iii) a combination thereof,
d) rheology modifying agent
e) end-use dispersibility stabilizer/compatibilizer,
f) alkyl polyglucoside
g) methyl soyate
wherein said adaptation comprises packaging an amount of said concentrated composition required for providing between 50 and 500 litres of diluted end-use dispersion in aqueous media, packaged in a container together with instructive means for dispersing and diluting the concentrated pesticidal oil-based dispersion composition in in an excess of aqueous media, wherein said container is impermeable to both moisture and light such that the % water content of the contained OBPD does not increase by more than 5% w/w after a period of storage in the container at 40° C./75% RH and the Pymetrozine content is not degraded by more than 5% w/w when stored exposed to sunlight and/or artificial light with wavelengths between 250 nm to 400 nm.

93) A method for preparing the composition as claimed in any one of 1-92, comprising the steps of,
a) introduce oil-based liquid carrier to a vessel,
b) add non-insecticidal formulation aids other than the thickener and/or rheological additive, if present,
c) mix until homogeneous
d) add the Pymetrozine and optionally an additional pesticide compound if present, while agitating at high shear,
e) add thickener and/or rheological additive if present, and apply high shear to obtain a dispersion,
f) mill the dispersion,
g) package the obtained milled dispersion in container,
wherein said container is selected from one or more of,
i) container impermeable to moisture, such that the % water content of the contained OBPD does not increase by more than 5% w/w after a period of storage in the container at 40° C./75% RH;
ii) container impermeable to light such that the Pymetrozine content is not photodegraded by more than 5% w/w when stored exposed to sunlight and/or artificial light with wavelengths between 250 to 400 nm;
iii) container impermeable to both moisture and light such that the % water content of the contained OBPD does not increase by more than 5% w/w after a period of storage in the container at 40° C./75% RH and the Pymetrozine content is not degraded by more than 5% w/w when stored exposed to sunlight and/or artificial light with wavelengths between 250 nm to 400 nm,
wherein the water content other than any water associated with pre-hydrated Pymetrozine if present, is maintained by said container at less than 5% by weight of the complete dispersion during storage at elevated temperature and/or elevated relative humidity such as storage for at least two weeks at 54° C. and/or at least one month at 40° C./75% RH.

94) The method as claimed in claim 93, comprising the steps of,
a) introduce vegetable oil-based liquid carrier to a vessel,
b) add non-insecticidal formulation aids other than the thickener and/or rheological additive, if present,
c) mix until homogeneous
d) add Pymetrozine, and a pesticide compound other than Pymetrozine if present, while agitating at high shear,
e) add thickener and/or rheological additive if present, and apply high shear to obtain a dispersion,
f) mill the dispersion,
g) package the obtained milled dispersion in container,
wherein said container is selected from one or more of,
i) container impermeable to moisture, such that the % water content of the contained OBPD does not increase by more than 5% w/w after a period of storage in the container at 40° C./75% RH;
ii) container impermeable to light such that the Pymetrozine content is not photodegraded by more than 5% w/w when stored exposed to sunlight and/or artificial light with wavelengths between 250 to 400 nm;
iii) container impermeable to both moisture and light such that the % water content of the contained OBPD does not increase by more than 5% w/w after a period of storage in the container at 40° C./75% RH and the Pymetrozine content is not degraded by more than 5% w/w when stored exposed to sunlight and/or artificial light with wavelengths between 250 nm to 400 nm,
wherein the total water content is maintained by said container at less than 5% by weight of the complete dispersion during storage at elevated temperature and/or elevated relative humidity such as at least two weeks at 54° C. and/or at least one month at 40° C./75% RH.

95) The method as claimed in claim 93, comprising the steps of,
a) introduce vegetable oil-based liquid carrier to a vessel,
b) add non-insecticidal formulation aids other than the thickener and/or rheological additive and anionic sulphate or sulphonate-based surfactant,
c) mix until homogeneous,
d) add the Pymetrozine, and additional pesticide compound if present, while agitating at high shear,
e) add thickener and/or rheological additive if present, and apply high shear to obtain a dispersion,
f) mill the dispersion,
g) add anionic sulphate or sulphonate-based surfactant and mix to obtain final homogenous dispersion,
h) package the obtained final homogenous dispersion in container,
wherein said container is selected from one or more of,
i) container impermeable to moisture, such that the % water content of the contained OBPD does not increase by more than 5% w/w after a period of storage in the container at 40° C./75% RH;
ii) container impermeable to light such that the Pymetrozine content is not photodegraded by more than 5% w/w when stored exposed to sunlight and/or artificial light with wavelengths between 250 to 400 nm;
iii) container impermeable to both moisture and light such that the % water content of the contained OBPD does not increase by more than 5% w/w after a period of storage in the container at 40° C./75% RH and the Pymetrozine content is not degraded by more than 5% w/w when stored exposed to sunlight and/or artificial light with wavelengths between 250 nm to 400 nm, wherein the total water content is maintained by said container at less than 5% by weight of the complete dispersion during storage at elevated temperature and/or elevated relative humidity such as at least two weeks at 54° C. and/or at least one month at 40° C./75% RH.

96) The method as claimed in claim 93, comprising the steps of,
a) introduce oil-based liquid carrier to a vessel,
b) add,
i) alkoxylated adjuvant,
ii) anionic phosphate/phosphonate-based surfactant,
iii) end-use dispersibility stabilizer/compatibilizer if present
iv) alkyl glycoside
c) mix until homogeneous,
d) add the Pymetrozine, and additional pesticide compound if present, while agitating at high shear,
e) add rheology modifying agent, and apply high shear to obtain a dispersion,
f) mill the dispersion,
g) add anionic sulphate or sulphonate-based surfactant and mix to obtain final homogenous dispersion,
h) package the obtained final homogenous dispersion in container, wherein said container is selected from one or more of,
i) container impermeable to moisture, such that the % water content of the contained OBPD does not increase by more than 5% w/w after a period of storage in the container at 40° C./75% RH;
ii) container impermeable to light such that the Pymetrozine content is not photodegraded by more than 5% w/w when stored exposed to sunlight and/or artificial light with wavelengths between 250 to 400 nm;
iii) container impermeable to both moisture and light such that the % water content of the contained OBPD does not increase by more than 5% w/w after a period of storage in the container at 40° C./75% RH and the Pymetrozine content is not degraded by more than 5% w/w when stored exposed to sunlight and/or artificial light with wavelengths between 250 nm to 400 nm,
wherein the total water content is maintained by said container at less than 5% by weight of the complete dispersion during storage at elevated temperature and/or elevated relative humidity such as at least two weeks at 54° C. and/or at least one month at 40° C./75% RH.

97) The method as claimed in claim 93, comprising the steps of,
a) introduce oil-based liquid carrier to a vessel,
b) add,
i) alkoxylated adjuvant,
ii) anionic phosphate/phosphonate-based surfactant,
iii) end-use dispersibility stabilizer/compatibilizer if present
iv) alkyl glycoside
c) mix until homogeneous,
d) add the Pymetrozine, and additional pesticide compound if present, while agitating at high shear,
e) add rheology modifying agent, and apply high shear to obtain a dispersion,
f) mill the dispersion,
g) add anionic sulphate or sulphonate-based surfactant if present, and mix to obtain final homogenous dispersion,
h) package the obtained final homogenous dispersion in container,
wherein said container is selected from one or more of,
i) container impermeable to moisture, such that the % water content of the contained OBPD does not increase by more than 5% w/w after a period of storage in the container at 40° C./75% RH;
ii) container impermeable to light such that the Pymetrozine content is not photodegraded by more than 5% w/w when stored exposed to sunlight and/or artificial light with wavelengths between 250 to 400 nm;
iii) container impermeable to both moisture and light such that the % water content of the contained OBPD does not increase by more than 5% w/w after a period of storage in the container at 40° C./75% RH and the Pymetrozine content is not degraded by more than 5% w/w when stored exposed to sunlight and/or artificial light with wavelengths between 250 nm to 400 nm,
wherein the total water content is maintained by said container at less than 5% by weight of the complete dispersion during storage at elevated temperature and/or elevated relative humidity such as at least two weeks at 54° C. and/or at least one month at 40° C./75% RH.

98) The method as claimed in claim 93, comprising the steps of,
a) introduce oil-based liquid carrier to a vessel,
b) add,
i) alkoxylated adjuvant,
ii) anionic phosphate/phosphonate-based surfactant,
iii) anionic sulphate or sulphonate-based surfactant if present
iv) end-use dispersibility stabilizer/compatibilizer if present
v) alkyl glycoside
c) mix until homogeneous,
d) add the Pymetrozine, and additional pesticide compound if present, while agitating at high shear,
e) add rheology modifying agent, and apply high shear to obtain a dispersion,
f) mill the dispersion,
g) package the obtained milled dispersion in container, wherein said container is selected from one or more of,
i) container impermeable to moisture, such that the % water content of the contained OBPD does not increase by more than 5% w/w after a period of storage in the container at 40° C./75% RH;
ii) container impermeable to light such that the Pymetrozine content is not photodegraded by more than 5% w/w when stored exposed to sunlight and/or artificial light with wavelengths between 250 to 400 nm;
iii) container impermeable to both moisture and light such that the % water content of the contained OBPD does not increase by more than 5% w/w after a period of storage in the container at 40° C./75% RH and the Pymetrozine content is not degraded by more than 5% w/w when stored exposed to sunlight and/or artificial light with wavelengths between 250 nm to 400 nm,
wherein the total water content is maintained by said container at less than 5% by weight of the complete dispersion during storage at elevated temperature and/or elevated relative humidity such as at least two weeks at 54° C. and/or at least one month at 40° C./75% RH.
